(19) United States
(12) Patent Application Publication
(10) Pub. No.: US 2016/0269740 A1
(43) Pub. Date: Sep. 15, 2016

(54) METHOD AND APPARATUS FOR ENCODING MULTILAYER VIDEO, AND METHOD AND APPARATUS FOR DECODING MULTILAYER VIDEO

(71) Applicant: SAMSUNG ELECTRONICS CO., LTD., Suwon-si Gyeonggi-do (KR)

(72) Inventors: Byeong-doo CHOI, Suwon-si (KR); Min-woo PARK, Yongin-si (KR); Jin-young LEE, Hwaseong-si (KR); Yong-jin CHO, Seoul (KR); Chan-yul KIM, Bucheon-si (KR); Ho-cheon WEY, Seongnam-si (KR)

(73) Assignee: SAMSUNG ELECTRONICS CO., LTD., Suwon-si , Gyeonggi-do (KR)

(21) Appl. No.: 15/028,770

(22) PCT Filed: Oct. 13, 2014
(86) PCT No.: PCT/KR2014/009592

§ 371 Date: Apr. 12, 2016

Related U.S. Application Data
(60) Provisional application No. 61/890,213, filed on Oct. 12, 2013.

(51) Int. Cl. H04N 19/52; H04N 19/187

(52) U.S. Cl. CPC H04N 19/52; H04N 19/187

(57) ABSTRACT

Provided is a multilayer video decoding method including acquiring reset information indicating whether to reset a picture order count (POC) of a current picture, resetting a higher bit of the POC of the current picture based on the reset information, and decoding the current picture by using the reset POC.

### TECHNICAL FIELD

The present invention relates to video encoding and decoding using a multilayer prediction structure based on inter-prediction, intra-prediction, and interlayer prediction.

### BACKGROUND ART

As hardware for reproducing and storing high resolution or high quality video content is being developed and supplied, a need for a video codec for effectively encoding or decoding the high resolution or high quality video content is increasing. According to a conventional video codec, a video is encoded according to a limited encoding method based on a macroblock having a predetermined size.

Image data of the spatial domain is transformed into coefficients of the frequency domain by using frequency conversion. For rapid frequency conversion, a video codec splits an image into blocks of a predetermined size, performs discrete cosine transformation (DCT) on each block, and encodes frequency coefficients in block units. Compared to the image data of the spatial domain, the coefficients of the frequency domain are easily compressed. Particularly, since image pixel values of the spatial domain are expressed as prediction errors due to inter-prediction or intra-prediction performed by the video codec, if frequency conversion is performed on the prediction errors, a lot of data may be transformed to the value 0. The video codec reduces the amount of data by replacing sequentially repeated data with small-sized data.

A multilayer video codec encodes/decodes a base layer video and one or more enhancement layer videos. The amount of data of the base layer video and the enhancement layer videos may be reduced by removing temporal/spatial redundancy of the base layer video and the enhancement layer videos and redundancy between layers.

### DETAILED DESCRIPTION OF THE INVENTION

### Technical Problem

The present invention provides video encoding and decoding methods using a multilayer prediction structure based on inter-prediction, intra-prediction, and interlayer prediction.

### Technical Solution

According to an aspect of the present invention, a multilayer video decoding method includes acquiring reset information indicating whether to reset a picture order count (POC) of a current picture, resetting a higher bit of the POC of the current picture when the reset information indicates to reset the POC of the current picture, and decoding the current picture by using the reset POC.

### Advantageous Effects of the Invention

The present invention may provide multilayer video encoding and decoding methods using reset information.

### DESCRIPTION OF THE DRAWINGS

FIG. 1A is a block diagram of a multilayer video encoding apparatus according to an embodiment of the present invention.

FIG. 1B is a flowchart of a multilayer video encoding method of the multilayer video encoding apparatus of FIG. 1A.

FIG. 2A is a block diagram of a multilayer video decoding apparatus according to an embodiment of the present invention.

FIG. 2B is a flowchart of a multilayer video decoding method of the multilayer video decoding apparatus of FIG. 2A.

FIG. 3 shows an interlayer prediction structure according to an embodiment.

FIG. 4A shows a multilayer prediction structure of multilayer pictures.

FIG. 4B shows a multilayer prediction structure based on a temporal hierarchical encoding/decoding scheme.

FIG. 4C illustrates network abstraction layer (NAL) units including encoded data of a multilayer video, according to an embodiment.

FIGS. 5A and 5B show a reproduction order and a reconstruction order of an instantaneous decoding refresh (IDR) picture, according to two embodiments.

FIGS. 5C and 5D show a reproduction order and a reconstruction order of a clean random access (CRA) picture, according to two embodiments.

FIGS. 5E and 5F show a reproduction order and a reconstruction order of a broken link access (BLA) picture, according to two embodiments.

FIGS. 6A to 6F show an interlayer and multilayer prediction structure for describing a method of determining picture order count (POC) values of pictures.

FIGS. 7A to 7E show various examples of syntax for describing a method of determining POC values of pictures, according to embodiments.

FIG. 8 is a block diagram of a video encoding apparatus based on coding units according to a tree structure, according to an embodiment.

FIG. 9 is a block diagram of a video decoding apparatus based on coding units according to a tree structure, according to an embodiment.

FIG. 10 is a diagram for describing a concept of coding units according to an embodiment.

FIG. 11 is a block diagram of an image encoder based on coding units, according to an embodiment.

FIG. 12 is a block diagram of an image decoder based on coding units, according to an embodiment.

FIG. 13 is a diagram illustrating deeper coding units according to depths, and partitions, according to an embodiment.

FIG. 14 is a diagram illustrating a relationship between a coding unit and transformation units, according to an embodiment.

FIG. 15 is a diagram illustrating a plurality of pieces of encoding information according to depths, according to an embodiment.

FIG. 16 is a diagram of deeper coding units, according to an embodiment.

FIGS. 17, 18, and 19 are diagrams illustrating a relationship between coding units, prediction units, and transformation units, according to an embodiment.

FIG. 20 is a diagram illustrating a relationship between a coding unit, a prediction unit, and a transformation unit, according to encoding mode information of Table 1.

FIG. 21 is a diagram of a physical structure of a disc in which a program is stored, according to an embodiment.

FIG. 22 is a diagram of a disc drive for recording and reading a program by using a disc.

FIG. 23 is a diagram of an overall structure of a content supply system for providing a content distribution service.

FIGS. 24 and 25 are diagrams respectively of an external structure and an internal structure of a mobile phone to which a video encoding method and a video decoding method are applied, according to an embodiment.

FIG. 26 is a diagram of a digital broadcast system to which a communication system is applied, according to an embodiment.

FIG. 27 is a diagram of a network structure of a cloud computing system using a video encoding apparatus and a video decoding apparatus, according to an embodiment.

### BEST MODE

According to an aspect of the present invention, a multilayer video decoding method includes acquiring reset information indicating whether to reset a picture order count (POC) of a current picture, resetting a higher bit of the POC of the current picture when the reset information indicates to reset the POC of the current picture, and decoding the current picture by using the reset POC.

The multilayer video decoding method may further include resetting a lower bit of the POC of the current picture when the reset information indicates to reset the POC of the current picture.

The reset information may be determined based on a type of a picture included in a base layer among interlayer reference pictures of the current picture.

The current picture may be included in an enhancement layer, and the reset information may indicate to reset the POC of the current picture when the picture included in the base layer among the interlayer reference pictures of the current picture is a random access point (RAP) picture.

The RAP picture may include at least one of an instantaneous decoding refresh (IDR) picture and a broken link access (BLA) picture.

The resetting of the higher bit may include determining a value of the higher bit to be 0, and the resetting of the lower bit may include determining a value of the lower bit to be 0.

The multilayer video decoding method may further include determining a POC offset by using the POC of the current picture, and updating a POC of at least one picture to be reconstructed temporally after the current picture, by using the determined POC offset.

The multilayer video decoding method may further include acquiring a lower bit of the POC of the current picture when the current picture is included in an enhancement layer or when the current picture is not an IDR picture.

The multilayer video decoding method may further include determining a reference picture used to decode the current picture among one or more pictures included in a decoded picture buffer (DPB), by using a lower bit of the POC.

The multilayer video decoding method may further include acquiring a lower bit of the POC of the current picture, and identifying pictures included in the same access unit as the current picture among a plurality of pictures acquired from a bitstream, by using the acquired lower bit.

According to another aspect of the present invention, a multilayer video encoding method includes checking a type of a picture included in a base layer among interlayer reference pictures of a current picture, determining reset information indicating whether to reset a picture order count (POC) of the current picture, based on the checked type, and generating a bitstream including the determined reset information.

The current picture may be included in an enhancement layer, and the reset information may indicate to reset a higher bit of the POC of the current picture when the picture included in the base layer among the interlayer reference pictures of the current picture is a random access point (RAP) picture.

The current picture may be included in an enhancement layer, and the reset information may indicate to reset a higher bit and a lower bit of the POC of the current picture when the picture included in the base layer among the interlayer reference pictures of the current picture is a RAP picture.

### MODE OF THE INVENTION

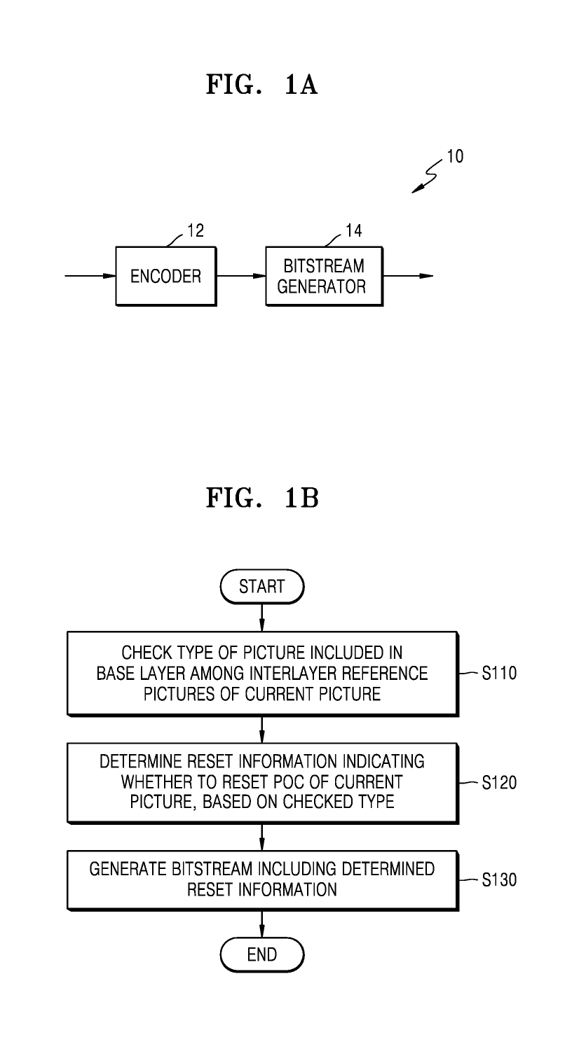

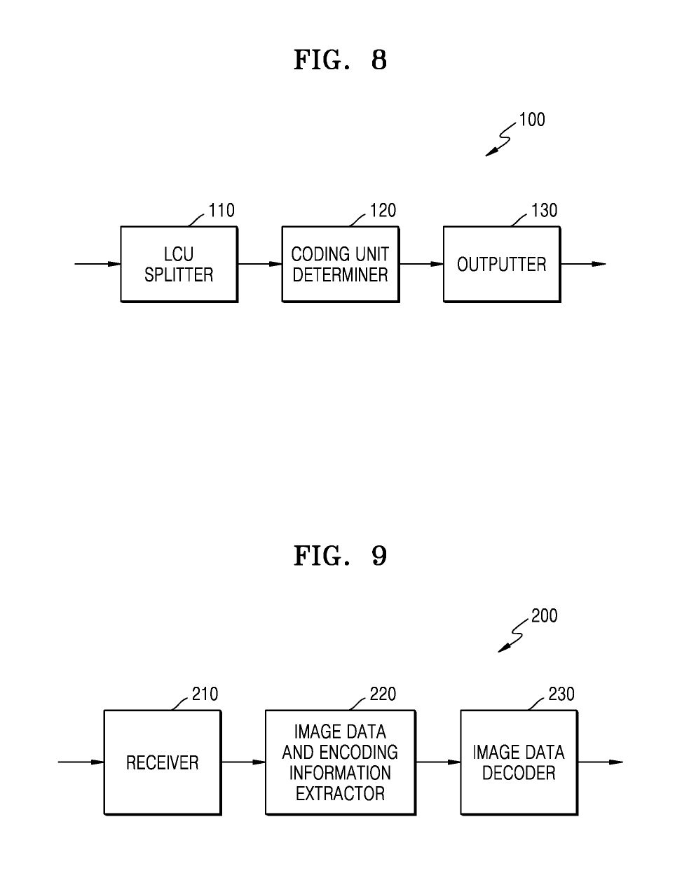

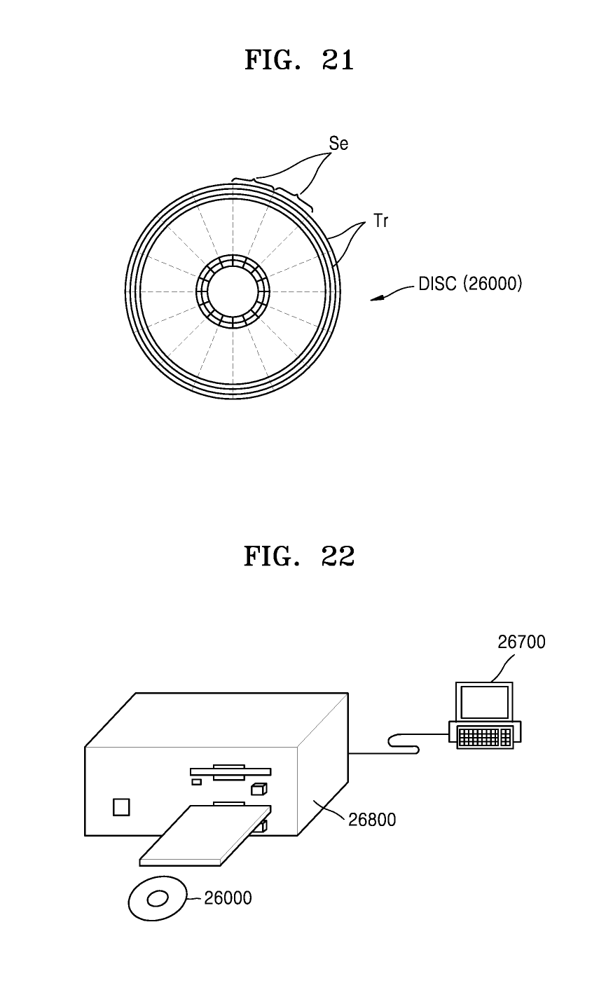

Hereinafter, a multilayer video encoding apparatus, a multilayer video decoding apparatus, a multilayer video encoding method, and a multilayer video decoding method according to embodiments will be described with reference to FIGS. 1A to 7E. In addition, a multilayer video encoding apparatus, a multilayer video decoding apparatus, a multilayer video encoding method, and a multilayer video decoding method based on coding units having a tree structure according to embodiments will be described with reference to FIGS. 8 to 20. Furthermore, a variety of examples to which a multilayer video encoding method, a multilayer video decoding method, a video encoding method, and a video decoding method are applicable according to embodiments will be described with reference to FIGS. 21 to 27.

In the following description, the term ‘image’ may refer to a still image of a video, or a moving image, i.e., the video itself.

A multilayer video encoding apparatus and a multilayer video encoding method, and a multilayer video decoding apparatus and a multilayer video decoding method according to embodiments are now described with reference to FIGS. 1A to 7E.

FIG. 1A is a block diagram of a multilayer video encoding apparatus 10 according to an embodiment of the present invention. FIG. 1B is a flowchart of a multilayer video encoding method of the multilayer video encoding apparatus 10 of FIG. 1A.

The multilayer video encoding apparatus 10 according to an embodiment includes an encoder 12 and a bitstream generator 14.

The multilayer video encoding apparatus 10 according to an embodiment may classify a plurality of video streams by using layers based on a scalable video coding scheme and may encode each stream. The multilayer video encoding apparatus 10 according to an embodiment encodes base layer pictures and enhancement layer pictures.

For example, a multi-view video may be encoded based on a scalable video coding scheme. Center-view pictures, left-view pictures, and right-view pictures may be individually encoded. In this case, the center-view pictures may be encoded as base layer pictures, the left-view pictures may be encoded as first enhancement layer pictures, and the right-view pictures may be encoded as second enhancement layer pictures. The result of encoding the base layer pictures may be output as a base layer stream, and the results of encoding the first enhancement layer pictures and the second enhancement layer pictures may be output as a first enhancement layer stream and a second enhancement layer stream, respectively, by the bitstream generator 14.

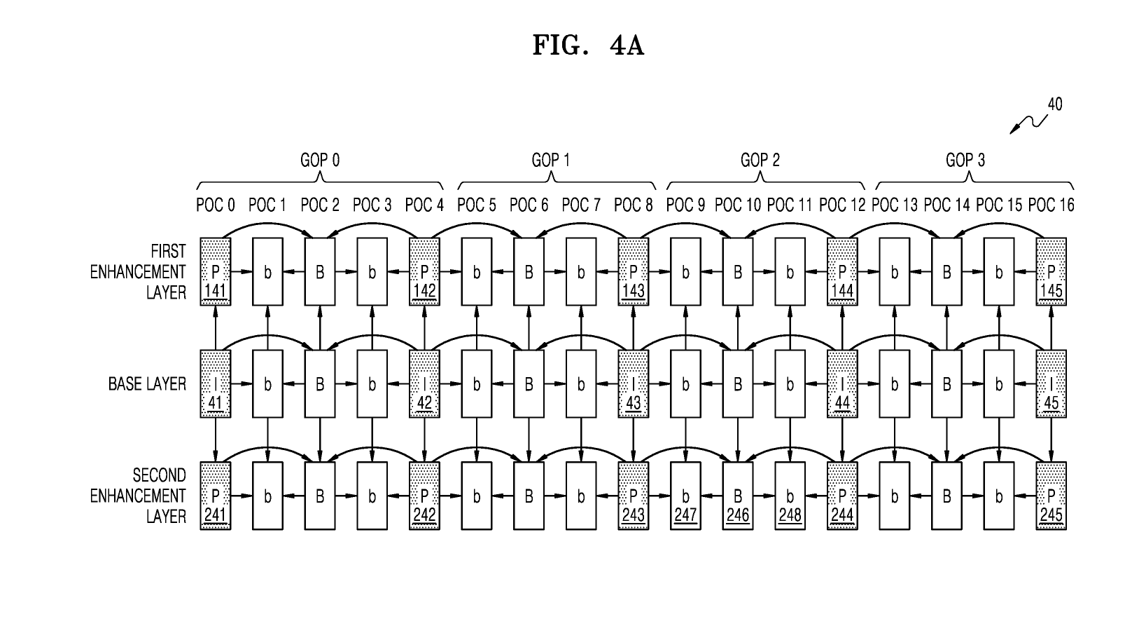

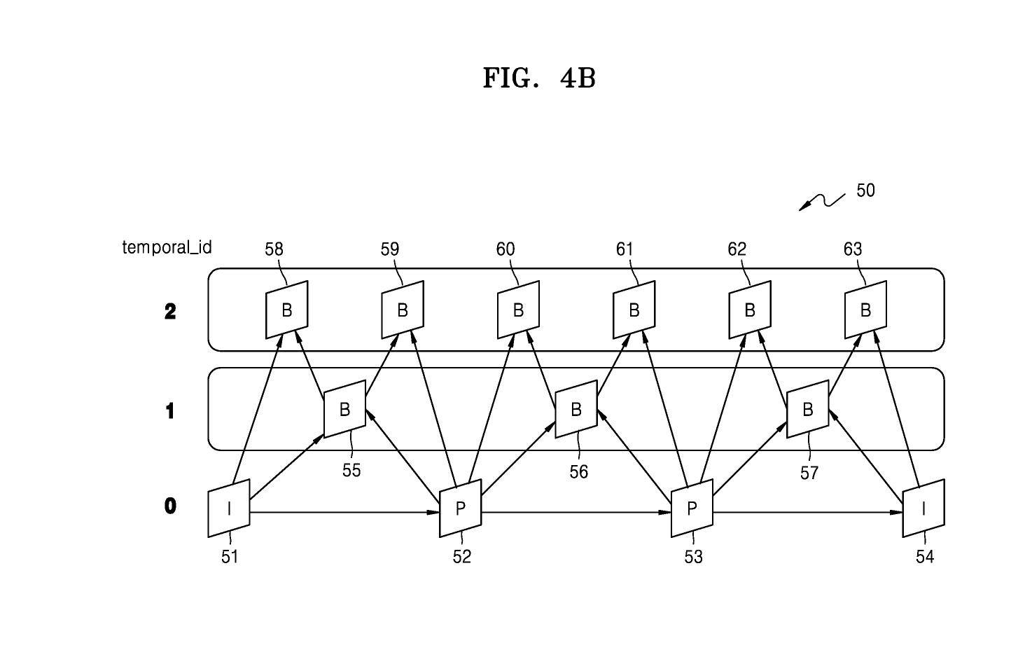

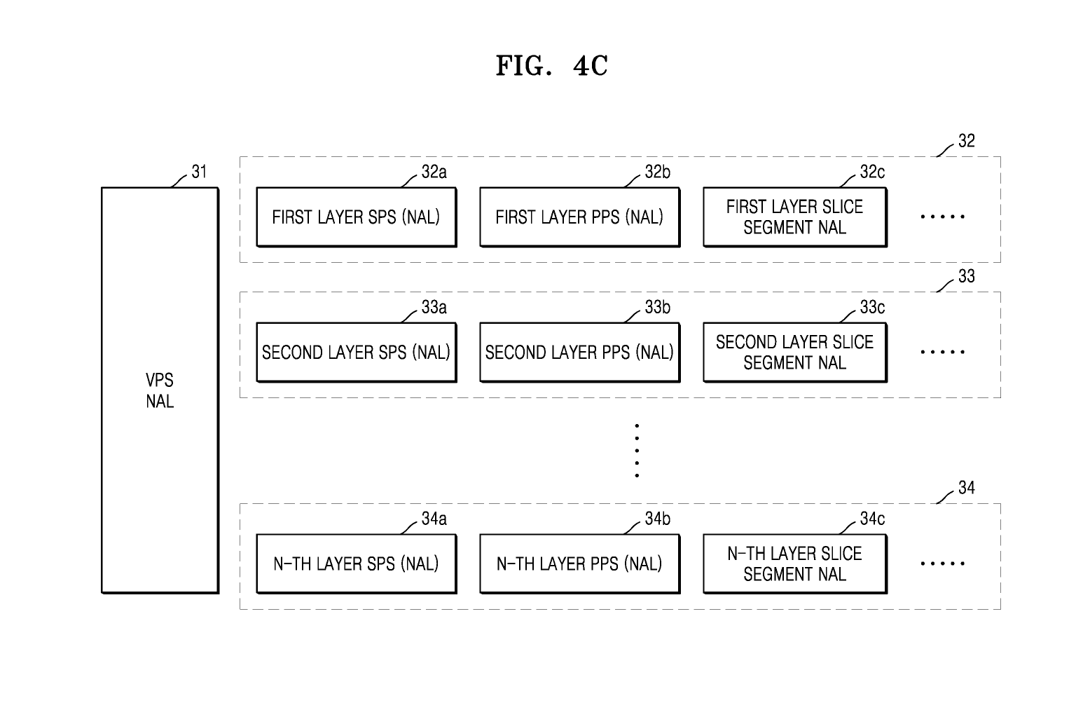

As another example, a scalable video coding scheme may be performed based on temporal hierarchical prediction. A base layer stream including encoding information generated by encoding pictures of a basic frame rate may be output. An enhancement layer stream including encoding information of a high frame rate may be output by further encoding pictures of the high frame rate with reference to the pictures of the basic frame rate. A description of the scalable video coding scheme based on temporal hierarchical prediction will be given below with reference to FIG. 4B.

Alternatively, scalable video coding may be performed by using a base layer and a plurality of enhancement layers. When the number of enhancement layers is three or more, base layer pictures, first enhancement layer pictures, second enhancement layer pictures, . . . , and K^{th} enhancement layer pictures may be encoded. As such, the result of encoding the base layer pictures may be output as a base layer stream, and the results of encoding the first, second, . . . , and K^{th} enhancement layer pictures may be output as first, second, . . . , and K^{th} enhancement layer streams, respectively.

The multilayer video encoding apparatus 10 according to an embodiment encodes each picture of the video per block, in each layer. A type of a block may be a square or a rectangular, or may be an arbitrary geometrical shape. The block is not limited to a data unit having a certain size. A block according to an embodiment may be, from among coding units according to a tree structure, a largest coding unit, a coding unit, a prediction unit, or a transformation unit. Video encoding and decoding methods based on coding units according to a tree structure will be described below with reference to FIGS. 8 through 20.

The multilayer video encoding apparatus 10 according to an embodiment may perform inter-prediction with mutual reference to pictures of the same layer. Due to inter-prediction, a motion vector indicating motion information between a current picture and a reference picture, and a residual component between the current picture and the reference picture may be generated.

In addition, the multilayer video encoding apparatus 10 according to an embodiment may perform interlayer prediction with reference to base layer pictures to predict enhancement layer pictures. The multilayer video encoding apparatus 10 according to an embodiment may also perform interlayer prediction with reference to first enhancement layer pictures to predict second enhancement layer pictures. Due to interlayer prediction, a location difference component between a current picture and a reference picture of another layer and a residual component between the current picture and the reference picture of the other layer may be generated.

When the multilayer video encoding apparatus 10 according to an embodiment allows two or more enhancement layers, interlayer prediction may be performed between pictures of one base layer and pictures of the two or more enhancement layers based on a multilayer prediction structure thereof.

Inter-prediction and interlayer prediction may also be performed based on a data unit such as a coding unit, a prediction unit, or a transformation unit.

The encoder 12 according to an embodiment generates a base layer stream by encoding the base layer pictures. The encoder 12 may perform inter-prediction among the base layer pictures. The encoder 12 according to an embodiment may encode random access point (RAP) pictures, which are randomly accessible, among the base layer pictures without reference to other pictures.

The I-type RAP pictures may be instantaneous decoding refresh (IDR) pictures, clean random access (CRA) pictures, broken link access (BLA) pictures, temporal sublayer access (TSA) pictures, or stepwise temporal sublayer access (STSA) pictures.

A picture order count (POC) is a value related to each coded picture, and indicates the corresponding picture in a coded video sequence (CVS). The POC values of pictures included in the same CVS are expressed as relative temporal distances among the pictures. The POC value of a certain picture at a timing when the picture is output refers to a relative output order of the picture compared to the other pictures included in the same CVS.

The CRA picture is an encoded picture including only I slices each having a nal_unit_type of the value 4. All encoded pictures following the CRA picture both in decoding order and output order may not be inter-predicted from any picture preceding the CRA picture either in decoding order or output order. In addition, one or more pictures preceding the CRA picture in decoding order also precede the CRA picture in output order.

The IDR picture is an encoded picture having an IdrPicFlag of the value 1, and a decoding apparatus marks all reference pictures as “unused for reference” in a decoding processing of the IDR picture. All encoded pictures following the IDR picture in decoding order may be decoded without performing inter-prediction from any one picture preceding the IDR picture in decoding order. The first picture of each coded video sequence in decoding order is the IDR picture.

A broken link means that some sequential pictures in decoding order may include severe visual defects due to unspecified operations performed to generate a bitstream, and indicates a location thereof within the bitstream.

A BLA unit is an access unit in which encoded pictures are the BLA pictures. The BLA picture is a RAP picture including slices each having a nal_unit_type of the value 6 or 7. The BLA picture is a CRA picture having a broken link.

The TSA picture is used to switch from decoding a lower temporal sublayer to decoding any higher temporal sublayer, and is an encoded picture in which each video coding layer (VCL) network abstraction layer (NAL) unit has a nal_unit_type of TSA_R or TSA_N. The STSA picture is used to switch from decoding a lower temporal sublayer to decoding only one higher temporal sublayer, and is an encoded picture in which each VCL NAL unit has a nal_unit_type of STSA_R or STSA_N.

In addition, the RAP pictures may be referred by leading pictures and trailing pictures. The leading picture and the trailing picture follow the RAP picture in reconstruction order, but the leading picture precedes the RAP picture in reproduction order and the trailing picture follows the RAP picture in reconstruction order. The trailing picture may also be called a normal picture.

The leading picture may be classified into a random access decodable leading (RADL) picture and a random access skipped leading (RASL) picture. When random access occurs in a RAP picture following the leading picture in reproduction order, the RADL picture may be reconstructed but the RASL picture may not be reconstructed.

A NoRaslOutputFlag may be a flag required to indicate whether the RASL picture is output. For example, the NoRaslOutputFlag may be determined to have the value 1 when the RASL picture is not output. As another example, the NoRaslOutputFlag may be determined to have the value 1 when random access occurs in the CRA picture or the BLA picture. As another example, the NoRaslOutputFlag may be determined to have the value 1 when splicing occurs. As another example, the NoRaslOutputFlag may be determined to have the value 1 when layer switching occurs. As another example, the NoRaslOutputFlag may be determined to have the value 1 when the CRA picture or the BLA picture is present at a location where video decoding starts.

The CRA picture may be changed to the BLA picture when random access occurs in the CRA picture. The NoRaslOutputFlag of the BLA picture may have the value 1.

However, the CRA picture may not be changed to the BLA picture in some cases even when random access occurs in the CRA picture. For example, in a read only memory (ROM), the CRA picture may not be changed to the BLA picture even when random access occurs. When random access occurs, the NoRaslOutputFlag of the CRA picture which is not changed to the BLA picture may have the value 1. Accordingly, when the NoRaslOutputFlag has the value 1, the RASL picture may not be output for the CRA picture.

CVS stands for a coded video sequence, and a sequence parameter set (SPS) may be activated when a start location of the CVS is decoded. However, the SPS may be activated in some cases even at a non-start location of the CVS, and a detailed description thereof will be given below. A RAP access unit may be the start location of the CVS.

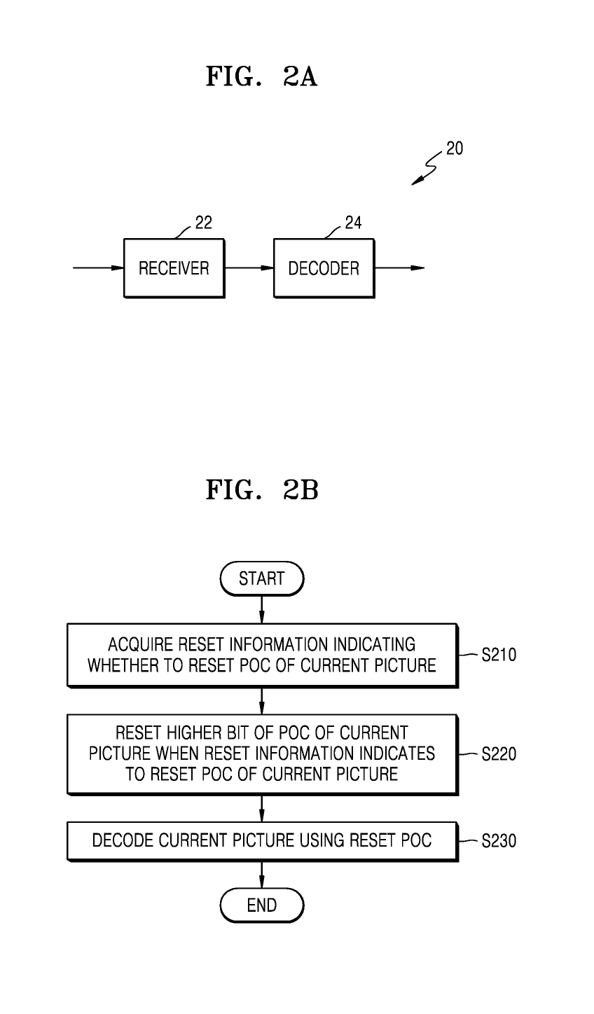

Activation of a specific SPS may mean that a decoder 24 (see FIG. 2A) parses the specific SPS. When the specific SPS is parsed, the decoder 24 may decode a video sequence corresponding to the specific SPS by using the parsed SPS.

The encoder 12 according to an embodiment may perform inter-prediction on non-RAP pictures other than the base layer RAP pictures among the base layer pictures. Intra-prediction may be performed on the base layer RAP pictures with reference to neighboring pixels within a picture. The encoder 12 according to an embodiment may generate encoded data by encoding resultant data generated as a result of performing inter-prediction or intra-prediction. For example, transformation, quantization, entropy encoding, etc. may be performed on an image block including the resultant data generated as a result of performing inter-prediction or intra-prediction.

The encoder 12 according to an embodiment may generate a base layer stream including encoded data of the base layer RAP pictures and encoded data of the other base layer pictures. The encoder 12 may output motion vectors generated by performing inter-prediction among the base layer pictures, together with the base layer stream through the bitstream generator 14.

In addition, the encoder 12 according to an embodiment generates an enhancement layer stream by encoding enhancement layer pictures. When pictures of a plurality of enhancement layers are encoded, the encoder 12 according to an embodiment generates an enhancement layer stream per layer by encoding pictures of each enhancement layer. In the following description, for convenience of explanation, the enhancement layer encoding operation of the encoder 12 according to an embodiment is assumed as an operation for encoding pictures of one enhancement layer. However, the operation of the encoder 12 is not limited to pictures of one enhancement layer and may be equally applied to pictures of each of the other enhancement layers.

To encode the enhancement layer pictures, the encoder 12 according to an embodiment may perform interlayer prediction with reference to the base layer pictures and perform inter-prediction with reference to pictures of the same layer.

Inter-prediction or interlayer prediction may be performed only after a reference picture is reconstructed. Thus, when a first picture of a current layer is initially decoded, if another picture of the same layer should be referred to, the first picture may not be decoded. Accordingly, a randomly accessible RAP picture should be encoded without reference to another picture of the same layer. According to an embodiment, when random access occurs in the RAP picture, although no picture of the same layer has been reconstructed, the RAP picture may be directly decoded and output.

Based on the multilayer prediction structure of the multilayer video encoding apparatus 10 according to an embodiment, during first layer pictures are decoded, layer switching may be performed to decode second layer pictures. For example, when view switching occurs in a multi-view video structure or when temporal layer switching occurs in a temporal hierarchical prediction structure, layer switching may be performed in the multilayer prediction structure. Even in this case, since no picture of the same layer has been reconstructed, inter-prediction may not be performed.

The encoder 12 according to an embodiment may include encoded data per picture in each NAL unit. NAL unit type information may indicate whether a current picture is a trailing picture, a TSA picture, an STSA picture, an RADL picture, an RASL picture, a BLA picture, an IDR picture, a CRA picture, or a VLA picture.

The encoder 12 according to various embodiments may encode a multilayer video to independently perform random access per layer. A description is now given of a method of encoding a multilayer video by the encoder 12 according to an embodiment of the present invention.

The encoder 12 may independently encode RAP pictures of a plurality of layers including a base layer and enhancement layers. The RAP pictures include IDR pictures, CRA pictures, and BLA pictures. The encoder 12 may encode the RAP pictures in such a manner that the IDR pictures are aligned in all layers.

In the following description, alignment may mean that pictures of the same type are shown in all layers at a specific timing. For example, if an IDR picture of any one of the plurality of layers at a specific POC should be encoded, the encoder 12 may encode pictures of all layers at the POC as IDR pictures.

A set of pictures having the same POC value and belonging to different layers may be encoded as an access unit. Accordingly, pictures belonging to the same access unit may have the same POC value.

To this end, the encoder 12 may encode the IDR pictures with respect to the enhancement layer pictures. For example, the IDR pictures having layer identifiers nuh_layer_id greater than the value 0 may be generated. Even when inter-prediction is not allowed, the encoder 12 may generate the IDR pictures by performing interlayer prediction.

The encoder 12 may generate the IDR pictures in an access unit of pictures belonging to no layer or an access unit belonging to all layers. For example, a NAL unit of an IDR type may be an IDR access unit at which decoding of all layers may start.

The encoder 12 may encode the CRA pictures without aligning the same in all layers. For example, the CRA pictures may not be encoded to be shown in all layers at a specific POC. The encoder 12 may generate a CRA NAL unit in the enhancement layers. For example, the encoder 12 may use a CRA NAL unit type when the nuh_layer_id value is greater than 0. Even when inter-prediction is not allowed, the encoder 12 may generate the CRA pictures by performing interlayer prediction. For example, the encoder 12 may not use inter-prediction to encode the CRA pictures but may use interlayer prediction for the CRA NAL units having nuh_layer_id values greater than 0.

When the encoder 12 generates the CRA NAL units, pictures may not be aligned in such a manner that the CRA NAL units are shown in all layers at the same timing. One CRA NAL unit type may be used for all VCL NAL units having a specific nuh_layer_id value. For example, one BLA NAL unit type may be used only for NAL units corresponding to a specific layer identifier, and a NAL unit type other than the BLA NAL unit type may be used for all VCL NAL units having another specific nuh_layer_id value of the same access unit. Since the BLA NAL unit type does not require alignment, even when the BLA NAL unit type is located in a specific layer within in one access unit, a NAL unit type other than the BLA NAL unit type may be located in another layer of the same access unit.

Meanwhile, if the bitstream is spliced, all CRA pictures within the access unit may be changed to BLA pictures.

One or more pictures included in the same access unit may have the same POC value. For example, a first picture and a second picture included in a first access unit may have the same POC value.

The POC value may be signaled. For example, a lower bit of the POC may be signaled. In this case, a higher bit of the POC may not be signaled but may be inferred by the decoder 24. Herein, signaling may mean transmission or reception of a signal. For example, signaling in a case when image data is encoded may mean that an encoded signal is transmitted. As another example, signaling in a case when image data is decoded may mean that an encoded signal is received.

However, the POC value of a picture may be determined based on the type of the picture irrespective of the signaled POC value. For example, the POC value of a RAP picture included in a base layer may be reset to 0. In this case, the POC value of a picture included in the same access unit as the RAP picture and included in an enhancement layer may also be reset to 0. At this time, the POC values signaled and actually used for the picture may differ. For example, the POC value used to decode the RAP picture included in the base layer may be 0 but the signaled POC value may not be 0.

The multilayer video encoding apparatus 10 may signal reset information of each picture. For example, the multilayer video encoding apparatus 10 may signal reset information of a predetermined picture together with a lower bit of a POC of the predetermined picture. In this specification, a higher bit may refer to the most significant bit (MSB), and a lower bit may refer to the least significant bit (LSB).

The encoder 12 according to an embodiment may generate the reset information of each picture indicating whether to reset the POC value thereof.

The reset information according to an embodiment may include information indicating whether to reset at least one of a higher bit and a lower bit included in a POC value of a picture. For example, the reset information of a current picture may indicate to reset the higher bit of the POC of the current picture. As another example, the reset information of the current picture may indicate to reset the lower bit of the POC of the current picture. As another example, the reset information of the current picture may indicate to reset the higher bit and the lower bit of the POC of the current picture. As another example, the reset information of the current picture may indicate not to reset both the higher bit and the lower bit of the POC of the current picture.

The reset information according to an embodiment may have a value within a predetermined range. For example, the reset information may be provided in the form of a flag. In this case, the reset information may be named as poc_reset_flag, full_poc_reset_flag, or poc_msb_reset_flag and may have one of the values 0 and 1. However, the names given throughout the specification are examples and may be replaced by other names indicating the same operations. According to an embodiment, with regard to the reset information of the current picture, when the value of the reset information is 0, the reset information may indicate not to reset both the higher bit and the lower bit of the POC of the current picture. As another example, when the value of the reset information is 1, the reset information may indicate to reset the higher bit of the POC of the current picture and not to reset the lower bit thereof. According to another embodiment, with regard to the reset information of the current picture, when the value of the reset information is 0, the reset information may indicate to reset the lower bit of the POC of the current picture and not to reset the higher bit thereof. As another example, when the value of the reset information is 1, the reset information may indicate to reset both the higher bit and the lower bit of the POC of the current picture.

The reset information according to another embodiment may have three or more values. For example, the reset information may be named as poc_reset_idc and may have one of the values 0, 1, 2, and 3. According to an embodiment, with regard to operation of the reset information of the current picture, when the value of the reset information is 0, the reset information may indicate not to reset both the higher bit and the lower bit of the POC of the current picture. As another example, when the value of the reset information is 1, the reset information may indicate to reset the higher bit of the POC of the current picture and not to reset the lower bit thereof. As another example, when the value of the reset information is 2, the reset information may indicate to reset the higher bit and the lower bit of the POC of the current picture. As another example, when the value of the reset information is 3, the reset information may indicate to reset the higher bit of the POC of the current picture and not to reset the lower bit thereof, or may indicate to reset the higher bit and the lower bit of the POC of the current picture.

When the NoRaslOutputFlag has the value 1, the POC value of a RAP picture may be reset to the value of a lower bit of a signaled or inferred POC. In this case, pictures included in the same access unit may have different POC values. The multilayer video encoding apparatus 10 may allow all pictures included in the same access unit to correspond to the same POC value by using the reset information. For example, even when an IDR picture and a non-RAP picture are included in the same access unit, the multilayer video encoding apparatus 10 may use the reset information to maintain the same POC value among the pictures included in the same access unit. The reset information may be used to maintain the same POC value among the pictures included in the same access unit.

The reset information may be stored in a preset part of the bitstream. For example, the reset information may be included in a slice segment header. As another example, the reset information may be included in a picture parameter set (PPS), a video parameter set (VPS), or a sequence parameter set (SPS).

The multilayer video encoding apparatus 10 according to an embodiment may signal the reset information when alignment is not achieved. The multilayer video encoding apparatus 10 according to an embodiment may signal the reset information of misaligned pictures. According to an embodiment, alignment/misalignment may indicate whether pictures included in the same access unit have the same POC value.

For example, when a first picture and a second picture included in the same access unit have the same POC value, the multilayer video encoding apparatus 10 may not signal the reset information. As another example, when the first picture and the second picture included in the same access unit have different POC values, the multilayer video encoding apparatus 10 may signal the reset information of the first picture and the second picture.

The multilayer video encoding apparatus 10 according to another embodiment may signal the reset information irrespective of whether alignment is achieved. For example, the value of the reset information signaled in a case when alignment is achieved may differ from that in a case when alignment is not achieved.

The multilayer video encoding apparatus 10 according to an embodiment may determine the reset information based on the type of a picture included in the base layer among interlayer reference pictures of the current picture.

For example, when the picture included in the base layer among the interlayer reference pictures of the current picture included in the enhancement layer is a RAP picture, the reset information of the current picture may indicate to reset at least one of the higher bit and the lower bit of the POC of the current picture. Resetting of at least one of the higher bit and the lower bit of the POC of the current picture includes a case when only the higher bit is reset, a case when only the lower bit is reset, and a case when both the higher bit and the lower bit are reset.

As another example, when the picture included in the base layer among the interlayer reference pictures of the current picture included in the enhancement layer is an IDR picture, the reset information of the current picture may indicate to reset at least one of the higher bit and the lower bit of the POC of the current picture.

As another example, when the picture included in the base layer among the interlayer reference pictures of the current picture included in the enhancement layer is a BLA picture, the reset information of the current picture may indicate to reset the POC value of the current picture or to reset the higher bit of the POC of the current picture. If the bitstream is spliced, a CRA picture type may be changed to a BLA picture type. In this case, pictures included in the same access unit may not have the same POC value but the POC values of the pictures included in the same access unit may be reset to the same value due to the reset information.

As another example, when the picture included in the base layer among the interlayer reference pictures of the current picture included in the enhancement layer is a CRA picture and a HandleCraAsBlaFlag has the value 1, the reset information of the current picture may indicate to reset the POC value of the current picture or to reset the higher bit of the POC of the current picture.

The HandleCraAsBlaFlag according to an embodiment may be a flag indicating to handle a CRA picture as a BLA picture. For example, a CRA picture corresponding to the HandleCraAsBlaFlag having the value 1 may be handled as a BLA picture by the decoder 24.

In addition, the reset information corresponding to the current picture may not be changed by a system or a splicer after the reset information is encoded. Accordingly, the POC values of pictures to be decoded temporally after the current picture may be correctly inferred.

The reset information may have a plurality of types.

For example, there may be reset information operating to reset or not to reset both the higher bit and the lower bit of the POC. In this case, the name of the reset information according to an embodiment may be poc_reset_flag or full_poc_reset_flag. Herein, the reset information may be applied in a case when a picture included in the base layer among pictures included in the access unit is an IDR picture. For example, when the picture included in the base layer among the pictures included in the access unit is an IDR picture, the encoder 12 may generate reset information indicating to reset the POC values of the pictures included in the access unit. In this case, the decoder 24 may allow the pictures included in the access unit to have the same POC value by using the reset information.

As another example, there may be reset information for determining whether to individually reset the higher bit and the lower bit of the POC. In this case, the name of the reset information according to an embodiment may be poc_msb_reset_flag or poc_reset_idc.

For example, there may be reset information operating to reset or not to reset only the higher bit of the POC. In this case, the reset information according to an embodiment may be a flag having one of the values 0 and 1, and may have the value 1 when the picture included in the base layer among the pictures included in the access unit is a CRA picture. The reset information according to another embodiment may be a flag having one of the values 0 and 1, and may have the value 1 when the picture included in the base layer among the pictures included in the access unit is a BLA picture. The reset information according to another embodiment may be a flag having one of the values 0 and 1, and may have the value 1 when the picture included in the base layer among the pictures included in the access unit is a RAP picture. The reset information according to another embodiment may be a flag having one of the values 0 and 1, and may have the value 1 when the picture included in the base layer among the pictures included in the access unit is an IDR picture. In addition, the reset information according to an embodiment may be determined by a splicer or a system.

As another example, there may be reset information indicating whether to reset at least one of the higher bit and the lower bit of the POC.

According to an embodiment, when the reset information of the current picture indicates to reset the POC value of the current picture, the reset information of the other pictures included in the access unit including the current picture may also indicate to reset the POC values thereof. For example, when the reset information of the current picture indicates to reset the higher bit of the POC of the current picture, the reset information of the other pictures included in the access unit including the current picture may also indicate to reset the higher bits of the POC values thereof.

According to an embodiment, when the current picture is an IDR picture, the reset information of each picture included in the access unit including the current picture may indicate to reset the POC value thereof. For example, when the current picture is an IDR picture included in the base layer, the reset information of each picture included in the access unit including the current picture may indicate to reset the POC value thereof.

According to an embodiment, when the current picture is a BLA picture or a CRA picture having a HandleCraAsBlaFlag of the value 1, the reset information of each picture included in the access unit including the current picture may indicate to reset the POC value thereof. For example, when the current picture is a BLA picture included in the base layer, the reset information of each picture included in the access unit including the current picture may indicate to reset the POC value thereof.

According to an embodiment, when the current picture is an IDR picture, the other pictures included in the access unit including the current picture may not be BLA pictures.

When the POC value of the current picture is reset due to the reset information, the POC values of one or more pictures included in the same layer as the current picture may be updated. For example, when the POC value of the current picture is reset due to the reset information, the POC values of pictures to be decoded temporally after the current picture may be updated. As another example, when the reset information indicates to reset the POC value of the current picture, the POC values of the pictures to be decoded temporally after the current picture may be updated based on the POC value of the current picture before being reset.

According to an embodiment, a POC offset used to update the POC values may be determined. For example, when the reset information indicates to reset the POC value of the current picture, the POC value of the current picture before being reset may be determined as the POC offset. According to an embodiment, the POC values of pictures included in a decoded picture buffer (DPB) among the pictures included in the same layer as the current picture may be reduced by the determined POC offset. For example, when the POC value of the current picture is 7 and the POC value of a picture included in the same layer as the current picture and to be decoded later than the current picture is 8, if the reset information indicates to reset the POC value of the current picture, the POC value of the current picture may be 0, the POC offset may be 7, and the POC value of the picture included in the same layer as the current picture may be updated to 1 by subtracting 7 from 8.

The POC value of an IDR picture may be 0. The reset information of the IDR picture according to an embodiment may indicate to reset the POC value thereof.

Since the value of the lower bit of the POC of the IDR picture is determined to be 0 and the POC value of a picture preceding the IDR picture is also determined to be 0, the POC value of the IDR picture may be 0. For example, when the current picture is an IDR picture included in the base layer, since the value of the lower bit of the POC of the IDR picture is determined to be 0 and the POC value of the picture preceding the IDR picture is also determined to be 0, the POC value of the current picture may be 0.

According to an embodiment, the lower bit of the POC of an IDR picture included in the enhancement layer may be signaled. According to an embodiment, the lower bit of the POC of the current picture may be signaled when the current picture is included in the enhancement layer or when the current picture is not an IDR picture. For example, the lower bit of the POC of the current picture may not be signaled when the current picture is included in the base layer and is an IDR picture. As another example, the POC value of the IDR picture included in the enhancement layer may be or may not be 0.

According to another embodiment, the lower bit of the POC of the current picture may not be signaled not only when the current picture serving as an IDR picture is included in the base layer but also when the current picture is included in the enhancement layer.

According to an embodiment, the POC offset used to update the POC value may be determined for each of the higher bit and the lower bit of the POC.

According to an embodiment, when the higher bit of the POC of the current picture is reset, a variable named pocMsbDelta may be used to update the POC values of the pictures included in the same layer as the current picture. For example, when the higher bit of the POC of the current picture is reset, the higher bit of the POC of the current picture before being reset may be stored in the name of pocMsbDelta. The higher bits of the POC values of the pictures to be decoded temporally after the current picture may be updated based on pocMsbDelta. For example, the higher bit of the POC of the picture to be decoded later than the current picture may be determined to have a value reduced by pocMsbDelta.

According to another embodiment, when the lower bit of the POC of the current picture is reset, a variable named pocLsbDelta may be used to update the POC values of the pictures included in the same layer as the current picture. For example, when the lower bit of the POC of the current picture is reset, the lower bit of the POC of the current picture before being reset may be stored in the name of pocLsbDelta. The lower bits of the POC values of the pictures to be decoded temporally after the current picture may be updated based on pocLsbDelta. For example, the lower bit of the POC of the picture to be decoded later than the current picture may be determined to have a value reduced by pocLsbDelta.

According to another embodiment, when the POC value of the current picture is reset, a variable named DeltaPocVal may be used to update the POC values of the pictures included in the same layer as the current picture. For example, the value of DeltaPocVal may be a sum of the values of pocMsbDelta and pocLsbDelta. The POC values of the pictures to be decoded temporally after the current picture may be updated based on DeltaPocVal. For example, the POC value of the picture to be decoded later than the current picture may be determined to have a value reduced by DeltaPocVal.

According to an embodiment, the POC value may be used to identify pictures included in the same access unit among a plurality of pictures. For example, the encoder 12 may identify the pictures included in the same access unit among a plurality of pictures to be encoded, by using the lower bit of the POC.

According to an embodiment, the POC value may be used to identify a reference picture used to encode the current picture among one or more pictures included in a DPB. For example, the encoder 12 may identify the reference picture used to encode the current picture among one or more pictures included in the DPB, by using the lower bit of the POC.

The same POC value of the pictures included in the access unit may be used to check whether the bitstream conforms with specifications. For example, whether the lower bits of the POC values of the pictures included in the access unit are the same may be used to check whether the bitstream conforms with specifications. In this case, even when the higher bits of the POC values of the pictures included in the same access unit are different, if the lower bits of the POC values are the same, it is determined that bitstream conformance is achieved.

FIG. 1B is a flowchart of a multilayer video encoding method of the multilayer video encoding apparatus 10 of FIG. 1A.

In S110, the encoder 12 may check the type of a picture included in a base layer among interlayer reference pictures of a current picture.

For example, when the current picture is included in an enhancement layer and refers to an IDR picture included in the base layer, the encoder 12 may determine that the picture included in the base layer among the interlayer reference pictures of the current picture is an IDR picture.

In S120, the encoder 12 may determine reset information indicating whether to reset a POC value of the current picture, based on the type checked in S110.

For example, when the picture included in the base layer among the interlayer reference pictures of the current picture is a RAP picture, the encoder 12 may determine the reset information to indicate to reset a higher bit of the POC of the current picture.

As another example, when the picture included in the base layer among the interlayer reference pictures of the current picture is a RAP picture, the encoder 12 may determine the reset information to indicate to reset the higher bit and a lower bit of the POC of the current picture.

As another example, when the picture included in the base layer among the interlayer reference pictures of the current picture is a RAP picture, the encoder 12 may determine the reset information to indicate to reset at least one of the higher bit and the lower bit of the POC of the current picture.

As another example, when the picture included in the base layer among the interlayer reference pictures of the current picture is an IDR picture, the encoder 12 may determine the reset information to indicate to reset the higher bit of the POC of the current picture.

As another example, when the picture included in the base layer among the interlayer reference pictures of the current picture is an IDR picture, the encoder 12 may determine the reset information to indicate to reset the higher bit and the lower bit of the POC of the current picture.

As another example, when the picture included in the base layer among the interlayer reference pictures of the current picture is an IDR picture, the encoder 12 may determine the reset information to indicate to reset at least one of the higher bit and the lower bit of the POC of the current picture.

As another example, when the picture included in the base layer among the interlayer reference pictures of the current picture is a BLA picture, the encoder 12 may determine the reset information to indicate to reset the higher bit of the POC of the current picture.

As another example, when the picture included in the base layer among the interlayer reference pictures of the current picture is a BLA picture, the encoder 12 may determine the reset information to indicate to reset the higher bit and the lower bit of the POC of the current picture.

As another example, when the picture included in the base layer among the interlayer reference pictures of the current picture is a BLA picture, the encoder 12 may determine the reset information to indicate to reset at least one of the higher bit and the lower bit of the POC of the current picture.

The reset information may be determined based on the type of the picture included in the base layer among the interlayer reference pictures of the current picture. For example, when the picture included in the base layer among the interlayer reference pictures of the current picture is a RAP picture, the reset information may indicate to reset the POC value of the current picture. Herein, the RAP picture may include at least one of an IDR picture and a BLA picture. Herein, the current picture according to an embodiment may be included in the enhancement layer.

In S130, the encoder 12 may generate a bitstream including the reset information determined in S120.

For example, the reset information may be included in a slice header of the bitstream. As another example, the reset information may be included in a PPS, a VPS, or an SPS.

According to an embodiment, the POC value may be used to identify pictures included in the same access unit among a plurality of pictures. For example, the encoder 12 may identify the pictures included in the same access unit among a plurality of pictures to be encoded, by using the lower bit of the POC.

According to an embodiment, the POC value may be used to identify a reference picture used to encode the current picture among one or more pictures included in a DPB. For example, the encoder 12 may identify the reference picture used to encode the current picture among one or more pictures included in the DPB, by using the lower bit of the POC.

The encoder 12 may determine a POC offset by using the POC value of the current picture. The encoder 12 may update POC values of pictures included in the same layer as the current picture, by using the determined POC offset. For example, the encoder 12 may update a POC value of at least one picture to be reconstructed temporally after the current picture, by using the determined POC offset.

The encoder 12 may signal the POC value of the current picture. For example, the encoder 12 may signal the lower bit of the POC of the current picture. As another example, the encoder 12 may signal the lower bit of the POC of the current picture when the current picture is included in the enhancement layer or when the current picture is not an IDR picture.

The encoder 12 may determine a reference picture of the current picture among one or more pictures by using the lower bit of the POC of the current picture.

The encoder 12 may determine a picture included in the same access unit as the current picture among a plurality of pictures by using the lower bit of the POC of the current picture.

FIG. 2A is a block diagram of a multilayer video decoding apparatus 20 according to an embodiment of the present invention. The multilayer video decoding apparatus 20 according to an embodiment includes a receiver 22 and the decoder 24.

The multilayer video decoding apparatus 20 according to an embodiment receives a base layer stream and an enhancement layer stream. Based on a scalable video coding scheme, the multilayer video decoding apparatus 20 may receive the base layer stream including encoded data of base layer pictures and the enhancement layer stream including encoded data of enhancement layer pictures.

The multilayer video decoding apparatus 20 according to an embodiment may decode the layer streams based on the scalable video coding scheme. The multilayer video decoding apparatus 20 according to an embodiment may reconstruct the base layer pictures by decoding the base layer stream and reconstruct the enhancement layer pictures by decoding the enhancement layer stream.

For example, a multi-view video may be reconstructed based on a scalable video coding scheme. For example, center-view pictures may be reconstructed by decoding a base layer stream. Left-view pictures may be reconstructed by further decoding a first enhancement layer stream in addition to the base layer stream. Right-view pictures may be reconstructed by further decoding a second enhancement layer stream in addition to the base layer stream.

As another example, a scalable video coding scheme may be performed based on temporal hierarchical prediction. Pictures of a basic frame rate may be reconstructed by decoding a base layer stream. Pictures of a high frame rate may be reconstructed by decoding an enhancement layer stream in addition to the base layer stream.

In addition, when the number of enhancement layers is three or more, first enhancement layer pictures of a first enhancement layer may be reconstructed from a first enhancement layer stream, and second enhancement layer pictures may be further reconstructed by further decoding a second enhancement layer stream. K^{th} enhancement layer pictures may be further reconstructed by further decoding a K^{th} enhancement layer stream in addition to the first enhancement layer stream.

The multilayer video decoding apparatus 20 according to an embodiment decodes each picture of the video per block. A block according to an embodiment may be the largest coding unit, a coding unit, a prediction unit, or a transformation unit among coding units based on a tree structure.

The multilayer video decoding apparatus 20 according to an embodiment may acquire the encoded data of the base layer pictures and the enhancement layer pictures from the base layer stream and the enhancement layer stream, and may further acquire a motion vector generated due to inter-prediction and variation information generated due to interlayer prediction.

For example, the multilayer video decoding apparatus 20 according to an embodiment may decode inter-predicted data per layer and decode interlayer predicted data among a plurality of layers. Reconstruction may be implemented by performing motion compensation and interlayer decoding based on a coding unit or a prediction unit according to an embodiment.

Pictures of each layer stream may be reconstructed by performing motion compensation with mutual reference to pictures predicted by performing inter-prediction within the same layer. Motion compensation refers to an operation for reconfiguring a reconstructed picture of a current picture by combining a reference picture determined by using a motion vector of the current picture, and a residual component of the current picture.

In addition, the multilayer video decoding apparatus 20 according to an embodiment may perform interlayer decoding with reference to the base layer pictures to reconstruct the enhancement layer pictures predicted by performing interlayer prediction. Interlayer decoding refers to an operation for reconfiguring a reconstructed picture of a current picture by combining a reference picture of another layer determined by using variation information of the current picture, and a residual component of the current picture.

The multilayer video decoding apparatus 20 according to an embodiment may perform interlayer decoding to reconstruct the second enhancement layer pictures predicted with reference to the first enhancement layer pictures.

According to an embodiment, the base layer pictures and the enhancement layer pictures may include randomly accessible RAP pictures.

The decoder 24 reconstructs the base layer pictures by decoding the received base layer stream. Specifically, a residual component of the base layer pictures may be reconstructed by performing entropy decoding, inverse quantization, and inverse transformation on symbols extracted by parsing the base layer stream.

The decoder 24 may receive a bitstream of quantized transformation coefficients of the base layer pictures through the receiver 22. As a result of performing inverse quantization and inverse transformation on the quantized transformation coefficients, the residual component of the base layer pictures may be reconstructed. The decoder 24 may reconstruct the base layer pictures by performing motion compensation with mutual reference to the base layer pictures.

The decoder 24 may reconstruct an I-type base layer RAP picture of the base layer stream by decoding a quantized transformation coefficient of the base layer RAP picture. The decoder 24 according to an embodiment may reconstruct the I-type base layer RAP picture of the base layer stream without reference to another base layer picture. The decoder 24 according to an embodiment may reconstruct pixels of blocks of the I-type base layer RAP picture by performing intra-prediction by using neighboring pixels of a current block within the same picture.

In addition, the decoder 24 may reconstruct the base layer pictures other than the base layer RAP picture by performing motion compensation with reference to other base layer pictures. The decoder 24 may reconstruct the base layer pictures other than the base layer RAP picture by reconstructing a residual component of the base layer pictures, determining a reference picture among the base layer pictures, and compensating the reference picture by the residual component.

The decoder 24 according to an embodiment reconstructs the enhancement layer pictures by decoding the enhancement layer stream. Specifically, a residual component per block may be reconstructed by performing entropy decoding, inverse quantization, and inverse transformation on symbols extracted by parsing the enhancement layer stream. The decoder 24 may also reconstruct the residual component by directly receiving a bitstream of quantized transformation coefficients of the residual component, and performing inverse quantization and inverse transformation on the bitstream.

To decode the enhancement layer stream, the decoder 24 according to an embodiment may reconstruct the enhancement layer pictures by performing motion compensation with reference to the base layer pictures reconstructed from the base layer stream, and performing interlayer decoding with reference to pictures of the same layer.

The decoder 24 according to an embodiment may reconstruct the enhancement layer pictures by performing interlayer decoding with reference to the base layer pictures reconstructed by the decoder 24. In a predetermined enhancement layer, pictures of the current enhancement layer may be reconstructed by performing interlayer decoding with reference to not only base layer pictures but also pictures of an enhancement layer other than the current enhancement layer.

Motion compensation or interlayer decoding may be performed only after a reference picture is reconstructed. However, a randomly accessible RAP picture does not refer to another picture of the same layer. Thus, according to an embodiment, when random access occurs in the RAP picture, although no picture of the same layer has been reconstructed, the RAP picture may be directly decoded. In a multilayer prediction structure according to an embodiment, when the RAP picture is present among the base layer pictures, an enhancement layer RAP picture corresponding to the base layer RAP picture among the enhancement layer pictures may be reconstructed.

In addition, the decoder 24 may reconstruct the enhancement layer pictures by performing motion compensation with reference to pictures of the same enhancement layer. Particularly, the decoder 24 according to an embodiment may reconstruct the enhancement layer pictures by performing motion compensation with reference to the RAP picture of the same enhancement layer.

The decoder 24 may reconstruct the enhancement layer pictures other than the RAP picture by performing interlayer decoding with reference to pictures of another layer and performing motion compensation with reference to pictures of the same layer.

Specifically, the decoder 24 may acquire a motion vector and a residual component of the enhancement layer pictures other than the enhancement layer RAP picture by decoding the enhancement layer stream. The decoder 24 may reconstruct the enhancement layer pictures by determining a reference picture among pictures of the same layer by using the motion vector, and compensating the reference picture by the residual component. A reference block within the reference picture may be determined by using the motion vector of a current block of the current picture.

Specifically, the decoder 24 may acquire variation information and a residual component of the enhancement layer pictures other than the enhancement layer RAP picture by decoding the enhancement layer stream. The decoder 24 may reconstruct the enhancement layer pictures by determining a reference picture among pictures of another layer by using the variation information, and compensating the reference picture by the residual component.

When a plurality of enhancement layer streams are decoded, the decoder 24 according to an embodiment may reconstruct enhancement layer pictures per layer by decoding an enhancement layer stream of each layer. In the following description, for convenience of explanation, the enhancement layer stream decoding operation of the decoder 24 according to an embodiment is assumed as an operation for decoding an enhancement layer stream of one layer. However, the operation of the decoder 24 is not limited to an enhancement layer stream of one layer and may be equally applied to each of enhancement layer streams of the other layers.

To reconstruct the enhancement layer pictures, the decoder 24 according to an embodiment may perform interlayer decoding with reference to the base layer pictures and perform motion compensation with reference to reconstructed pictures of the same layer.

Based on the multilayer prediction structure of the multilayer video decoding apparatus 20 according to an embodiment, during a first layer stream is decoded, layer switching may be performed to decode a second layer stream. For example, when view switching occurs in a multi-view video structure or when temporal layer switching occurs in a temporal hierarchical prediction structure, layer switching may be performed in the multilayer prediction structure. Even in this case, since no picture of the same layer has been reconstructed, inter-prediction may not be performed.

The decoder 24 may acquire encoded data per picture in each NAL unit. NAL unit type information may be parsed to determine whether a current picture is a trailing picture, a TSA picture, an STSA picture, an RADL picture, an RASL picture, a BLA picture, an IDR picture, a CRA picture, or a VLA picture.

The decoder 24 according to various embodiments may independently perform random access per layer. RAP pictures include IDR pictures, CRA pictures, and BLA pictures. Among encoded multilayer pictures, the IDR pictures may or may not be aligned.

The decoder 24 may receive and decode the encoded multilayer pictures in which the IDR pictures are aligned in all layers. Pictures included in the same access unit and having a NAL unit type of IDR may have the same POC value.

For example, if an IDR picture is located in any one of a plurality of layers at a specific POC, the decoder 24 may determine that pictures of all layers at the POC value are IDR pictures and decode the IDR pictures. Even when inter-prediction is not allowed, the decoder 24 may decode the IDR pictures by performing interlayer prediction.

Alignment may mean that pictures shown in all layers at a specific POC have the same type. For example, if all pictures belonging to the same access unit are IDR pictures, the pictures may be in an aligned state. However, if one of the pictures belonging to the same access unit is a RAP picture and another is a non-RAP picture, the pictures may be in a non-aligned state.

A set of pictures having the same POC value and belonging to different layers may be an access unit. Accordingly, pictures belonging to the same access unit may have the same POC value.

One or more pictures included in the same access unit may have the same POC value. For example, a first picture and a second picture included in a first access unit may have the same POC value.

The POC value may be signaled. For example, a lower bit of the POC may be signaled. Herein, signaling may mean transmission or reception of a signal. For example, signaling in a case when image data is encoded may mean that an encoded signal is transmitted. As another example, signaling in a case when image data is decoded may mean that an encoded signal is received.

However, the POC value of a picture may be determined based on the type of the picture irrespective of the signaled POC value. For example, the POC value of a RAP picture included in a base layer may be reset to 0. In this case, the POC value of a picture included in the same access unit as the RAP picture and included in an enhancement layer may also be reset to 0. At this time, the POC values signaled and actually used for the picture may differ. For example, the POC value used to decode the RAP picture included in the base layer may be 0 but the signaled POC value may not be 0.

The multilayer video decoding apparatus 20 may signal reset information of each picture. For example, the multilayer video decoding apparatus 20 may signal reset information of a predetermined picture together with a lower bit of a POC of the predetermined picture.

The receiver 22 according to an embodiment may acquire the reset information of each picture indicating whether to reset the POC value thereof.

The reset information according to an embodiment may include information indicating whether to reset at least one of a higher bit and a lower bit included in a POC value of a picture. For example, the reset information of a current picture may indicate to reset the higher bit of the POC of the current picture. As another example, the reset information of the current picture may indicate to reset the lower bit of the POC of the current picture. As another example, the reset information of the current picture may indicate to reset the higher bit and the lower bit of the POC of the current picture. As another example, the reset information of the current picture may indicate not to reset both the higher bit and the lower bit of the POC of the current picture.

The reset information according to an embodiment may have a value within a predetermined range. For example, the reset information may be provided in the form of a flag. In this case, the reset information may be named as poc_reset_flag, full_poc_reset_flag, or poc_msb_reset_flag and may have one of the values 0 and 1. However, the names given throughout the specification are examples and may be replaced by other names indicating the same operations. According to an embodiment, with regard to the reset information of the current picture, when the value of the reset information is 0, the decoder 24 may not reset both the higher bit and the lower bit of the POC of the current picture. As another example, when the value of the reset information is 1, the decoder 24 may reset the higher bit of the POC of the current picture and may not reset the lower bit thereof. According to another embodiment, with regard to the reset information of the current picture, when the value of the reset information is 0, the decoder 24 may not reset both the higher bit and the lower bit of the POC of the current picture. As another example, when the value of the reset information is 1, the decoder 24 may reset both the higher bit and the lower bit of the POC of the current picture.

The reset information according to another embodiment may have three or more values. For example, the reset information may be named as poc_reset_idc and may have one of the values 0, 1, 2, and 3. According to an embodiment, with regard to operation of the reset information of the current picture, when the value of the reset information is 0, the decoder 24 may reset both the higher bit and the lower bit of the POC of the current picture. As another example, when the value of the reset information is 1, the decoder 24 may reset the higher bit of the POC of the current picture and may not reset the lower bit thereof. As another example, when the value of the reset information is 2, the decoder 24 may reset the higher bit and the lower bit of the POC of the current picture. As another example, when the value of the reset information is 3, the decoder 24 may reset the higher bit of the POC of the current picture and may not reset the lower bit thereof. As another example, when the value of the reset information is 3, the decoder 24 may reset the higher bit and the lower bit of the POC of the current picture.

When a NoRaslOutputFlag has the value 1, the POC value of a RAP picture may be reset to the value of a lower bit of a signaled or inferred POC. In this case, pictures included in the same access unit may have different POC values. The multilayer video decoding apparatus 20 may allow all pictures included in the same access unit to correspond to the same POC value by using the reset information. For example, even when an IDR picture and a non-RAP picture are included in the same access unit, the multilayer video decoding apparatus 20 may use the reset information to maintain the same POC value among the pictures included in the same access unit. The reset information may be used to maintain the same POC value among the pictures included in the same access unit.

The reset information may be acquired from a preset part of the bitstream. For example, the reset information may be acquired from a slice segment header. As another example, the reset information may be acquired from a picture parameter set (PPS), a video parameter set (VPS), or a sequence parameter set (SPS).

The multilayer video decoding apparatus 20 according to an embodiment may signal the reset information when alignment is not achieved. The multilayer video decoding apparatus 20 according to an embodiment may signal the reset information of misaligned pictures. According to an embodiment, alignment/misalignment may indicate whether pictures included in the same access unit have the same POC value.

For example, when a first picture and a second picture included in the same access unit have the same POC value, the multilayer video decoding apparatus 20 may not signal the reset information. As another example, when the first picture and the second picture included in the same access unit have different POC values, the multilayer video decoding apparatus 20 may signal the reset information of the first picture and the second picture.

The multilayer video decoding apparatus 20 according to another embodiment may signal the reset information irrespective of whether alignment is achieved. For example, the value of the reset information signaled in a case when alignment is achieved may differ from that in a case when alignment is not achieved.

The multilayer video decoding apparatus 20 according to an embodiment may acquire the reset information based on the type of a picture included in the base layer among interlayer reference pictures of the current picture.

For example, when the picture included in the base layer among the interlayer reference pictures of the current picture included in the enhancement layer is a RAP picture, the reset information of the current picture may indicate to reset at least one of the higher bit and the lower bit of the POC of the current picture. Resetting of at least one of the higher bit and the lower bit of the POC of the current picture includes a case when only the higher bit is reset, a case when only the lower bit is reset, and a case when both the higher bit and the lower bit are reset.

As another example, when the picture included in the base layer among the interlayer reference pictures of the current picture included in the enhancement layer is an IDR picture, the reset information of the current picture may indicate to reset at least one of the higher bit and the lower bit of the POC of the current picture.

As another example, when the picture included in the base layer among the interlayer reference pictures of the current picture included in the enhancement layer is a BLA picture, the reset information of the current picture may indicate to reset the POC value of the current picture or to reset the higher bit of the POC of the current picture. If the bitstream is spliced, a CRA picture type may be changed to a BLA picture type. In this case, pictures included in the same access unit may not have the same POC value but the POC values of the pictures included in the same access unit may be reset to the same value due to the reset information.

As another example, when the current picture included in the base layer is a RAP picture, the POC value of the current picture may be reset. For example, when the current picture included in the base layer is an IDR picture, the POC value of the current picture may be determined to be 0. In this case, the POC value of an enhancement layer picture included in the same access unit as the current picture may also be determined to be 0. Herein, the decoder 24 may use the reset information to reset the POC value of the picture.

As another example, when the picture included in the base layer among the interlayer reference pictures of the current picture included in the enhancement layer is a CRA picture and a HandleCraAsBlaFlag has the value 1, the reset information of the current picture may indicate to reset the POC value of the current picture or to reset the higher bit of the POC of the current picture.

The HandleCraAsBlaFlag according to an embodiment may be a flag indicating to handle a CRA picture as a BLA picture. For example, a CRA picture corresponding to the HandleCraAsBlaFlag of the value 1 may be handled as a BLA picture by the decoder 24.

In addition, the reset information corresponding to the current picture may not be changed by a system or a splicer after the reset information is encoded. Accordingly, the POC values of pictures to be decoded temporally after the current picture may be correctly inferred.

The reset information may have a plurality of types.

For example, there may be reset information operating to reset or not to reset both the higher bit and the lower bit of the POC. In this case, the name of the reset information according to an embodiment may be poc_reset_flag or full_poc_reset_flag. Herein, the reset information may be applied in a case when a picture included in the base layer among pictures included in the access unit is an IDR picture. For example, when the picture included in the base layer among the pictures included in the access unit is an IDR picture, the decoder 24 may acquire reset information indicating to reset the POC values of the pictures included in the access unit. In this case, the decoder 24 may allow the pictures included in the access unit to have the same POC value by using the reset information.

As another example, there may be reset information for determining whether to individually reset the higher bit and the lower bit of the POC. In this case, the name of the reset information according to an embodiment may be poc_msb_reset_flag or poc_reset_idc.

For example, there may be reset information operating to reset or not to reset only the higher bit of the POC. In this case, the reset information according to an embodiment may be a flag having one of the values 0 and 1, and may have the value 1 when the picture included in the base layer among the pictures included in the access unit is a CRA picture. The reset information according to another embodiment may be a flag having one of the values 0 and 1, and may have the value 1 when the picture included in the base layer among the pictures included in the access unit is a BLA picture. The reset information according to another embodiment may be a flag having one of the values 0 and 1, and may have the value 1 when the picture included in the base layer among the pictures included in the access unit is a RAP picture. The reset information according to another embodiment may be a flag having one of the values 0 and 1, and may have the value 1 when the picture included in the base layer among the pictures included in the access unit is an IDR picture. In addition, the reset information according to an embodiment may be determined by a splicer or a system.

As another example, there may be reset information indicating whether to reset at least one of the higher bit and the lower bit of the POC.

According to an embodiment, when the reset information of the current picture indicates to reset the POC value of the current picture, the reset information of the other pictures included in the access unit including the current picture may also indicate to reset the POC values thereof. For example, when the reset information of the current picture indicates to reset the higher bit of the POC of the current picture, the reset information of the other pictures included in the access unit including the current picture may also indicate to reset the higher bits of the POC values thereof.

According to an embodiment, when the current picture is an IDR picture, the reset information of each picture included in the access unit including the current picture may indicate to reset the POC value thereof. For example, when the current picture is an IDR picture included in the base layer, the reset information of each picture included in the access unit including the current picture may indicate to reset the POC value thereof. In this case, the decoder 24 may receive the reset information and reset the POC values of the pictures included in the access unit including the current picture.

According to an embodiment, when the current picture is a BLA picture or a CRA picture having a HandleCraAsBlaFlag of the value 1, the reset information of each picture included in the access unit including the current picture may indicate to reset the POC value thereof. For example, when the current picture is a BLA picture included in the base layer, the reset information of each picture included in the access unit including the current picture may indicate to reset the POC value thereof.

According to an embodiment, when the current picture is an IDR picture, the other pictures included in the access unit including the current picture may not be BLA pictures.

When the POC value of the current picture is reset due to the reset information, the POC values of one or more pictures included in the same layer as the current picture may be updated. For example, when the POC value of the current picture is reset due to the reset information, the POC values of pictures to be decoded temporally after the current picture may be updated. As another example, when the reset information indicates to reset the POC value of the current picture, the POC values of the pictures to be decoded temporally after the current picture may be updated based on the POC value of the current picture before being reset.

According to an embodiment, a POC offset used to update the POC values may be determined. For example, when the reset information indicates to reset the POC value of the current picture, the POC value of the current picture before being reset may be determined as the POC offset. According to an embodiment, the POC values of pictures included in a decoded picture buffer (DPB) among the pictures included in the same layer as the current picture may be reduced by the determined POC offset. For example, when the POC value of the current picture is 7 and the POC value of a picture included in the same layer as the current picture and to be decoded later than the current picture is 8, if the reset information indicates to reset the POC value of the current picture, the POC value of the current picture may be 0, the POC offset may be 7, and the POC value of the picture included in the same layer as the current picture may be updated to 1 by subtracting 7 from 8.

The reset information of an IDR picture according to an embodiment may indicate to reset the POC value thereof. In this case, the POC value of the IDR picture may be 0 irrespective of the signaled POC value of the IDR picture. For example, when the value of the lower bit of the signaled POC of the current picture included in the base layer and serving as an IDR picture is 7, the decoder 24 may reset the POC value of the current picture to 0 based on the reset information.

Since the value of the lower bit of the POC of the IDR picture is determined to be 0 and the POC value of a picture preceding the IDR picture is also determined to be 0, the POC value of the IDR picture may be 0. For example, when the current picture is an IDR picture included in the base layer, since the value of the lower bit of the POC of the IDR picture is determined to be 0 and the POC value of the picture preceding the IDR picture is also determined to be 0, the POC value of the current picture may be 0.

According to an embodiment, the value of the lower bit of the POC may be determined to be 0 when the lower bit of the POC is not signaled. When the current picture is an IDR picture included in the base layer, the lower bit of the POC of the current picture may not be signaled and thus the POC value of the current picture may be determined to be 0.

According to an embodiment, the lower bit of the POC of an IDR picture included in the enhancement layer may be signaled. According to an embodiment, the lower bit of the POC of the current picture may be signaled when the current picture is included in the enhancement layer or when the current picture is not an IDR picture. For example, the lower bit of the POC of the current picture may not be signaled when the current picture is included in the base layer and is an IDR picture. As another example, the POC value of the IDR picture included in the enhancement layer may be or may not be 0.

According to another embodiment, the lower bit of the POC of the current picture may not be signaled not only when the current picture serving as an IDR picture is included in the base layer but also when the current picture is included in the enhancement layer.

According to an embodiment, the POC offset used to update the POC value may be determined for each of the higher bit and the lower bit of the POC.

According to an embodiment, when the higher bit of the POC of the current picture is reset, a variable named pocMsbDelta may be used to update the POC values of the pictures included in the same layer as the current picture. For example, when the higher bit of the POC of the current picture is reset, the higher bit of the POC of the current picture before being reset may be stored in the name of pocMsbDelta. The higher bits of the POC values of the pictures to be decoded temporally after the current picture may be updated based on pocMsbDelta. For example, the higher bit of the POC of the picture to be decoded later than the current picture may be determined to have a value reduced by pocMsbDelta.

According to another embodiment, when the lower bit of the POC of the current picture is reset, a variable named pocLsbDelta may be used to update the POC values of the pictures included in the same layer as the current picture. For example, when the lower bit of the POC of the current picture is reset, the lower bit of the POC of the current picture before being reset may be stored in the name of pocLsbDelta. The lower bits of the POC values of the pictures to be decoded temporally after the current picture may be updated based on pocLsbDelta. For example, the lower bit of the POC of the picture to be decoded later than the current picture may be determined to have a value reduced by pocLsbDelta.

According to another embodiment, when the POC value of the current picture is reset, a variable named DeltaPocVal may be used to update the POC values of the pictures included in the same layer as the current picture. For example, the value of DeltaPocVal may be a sum of the values of pocMsbDelta and pocLsbDelta. The POC values of the pictures to be decoded temporally after the current picture may be updated based on DeltaPocVal. For example, the POC value of the picture to be decoded later than the current picture may be determined to have a value reduced by DeltaPocVal.

According to an embodiment, the POC value may be used to identify pictures included in the same access unit among a plurality of pictures. For example, the encoder 12 may identify the pictures included in the same access unit among a plurality of pictures to be encoded, by using the lower bit of the POC.

According to an embodiment, the POC value may be used to identify pictures included in the same access unit among a plurality of pictures. For example, the decoder 24 may identify the pictures included in the same access unit among a plurality of pictures to be decoded, by using the lower bit of the POC. According to an embodiment, the POC value may be used to identify a reference picture used to decode the current picture among one or more pictures included in a DPB. For example, the decoder 24 may identify the reference picture used to decode the current picture among one or more pictures included in the DPB, by using the lower bit of the POC.

The same POC value of the pictures included in the access unit may be used to check whether the bitstream conforms with specifications. For example, whether the lower bits of the POC values of the pictures included in the access unit are the same may be used to check whether the bitstream conforms with specifications. In this case, even when the higher bits of the POC values of the pictures included in the same access unit are different, if the lower bits of the POC values are the same, it is determined that bitstream conformance is achieved.

FIG. 2B is a flowchart of a multilayer video decoding method of the multilayer video decoding apparatus 20 of FIG. 2A.

The multilayer video decoding apparatus 20 may receive a data stream. The data stream received by the multilayer video decoding apparatus 20 may consist of network abstraction layer (NAL) units.

The NAL unit may be a basic unit of a bitstream. In addition, one or more NAL units may configure a data stream. The multilayer video decoding apparatus 20 may receive the data stream consisting of one or more NAL units from outside the multilayer video decoding apparatus 20.

The multilayer video decoding apparatus 20 may split the received data stream into the NAL units and then decode each of the split NAL units.

Each NAL unit may include two-byte header information. The multilayer video decoding apparatus 20 may check general information about data of each NAL unit by decoding the two-byte header information included in the NAL unit.

In S210, the receiver 22 may acquire reset information indicating whether to reset a picture order count (POC) of a current picture.

The reset information may be determined based on the type of a picture included in a base layer among interlayer reference pictures of the current picture. For example, when the picture included in the base layer among the interlayer reference pictures of the current picture is a RAP picture, the reset information may indicate to reset the POC value of the current picture. Herein, the RAP picture may include at least one of an IDR picture and a BLA picture. Herein, the current picture according to an embodiment may be included in an enhancement layer.

In S220, when the reset information acquired in S210 indicates to reset the POC value of the current picture, the decoder 24 may reset a higher bit of the POC of the current picture.

For example, when the reset information acquired in S210 indicates to reset the POC value of the current picture, the decoder 24 may determine the value of the higher bit of the POC of the current picture to be 0.

Alternatively, in S220, when the reset information acquired in S210 indicates to reset the POC value of the current picture, the decoder 24 may reset a lower bit of the POC of the current picture. For example, when the reset information acquired in S210 indicates to reset the POC value of the current picture, the decoder 24 may determine the value of the lower bit of the POC of the current picture to be 0.

Otherwise, in S220, when the reset information acquired in S210 indicates to reset the POC value of the current picture, the decoder 24 may reset at least one of the higher bit and the lower bit of the POC of the current picture.

In S230, the decoder 24 may decode the current picture by using the reset POC value.

According to an embodiment, the POC value may be used to identify pictures included in the same access unit among a plurality of pictures. For example, the decoder 24 may identify the pictures included in the same access unit among a plurality of pictures to be decoded, by using the lower bit of the POC.

According to an embodiment, the POC value may be used to identify a reference picture used to decode the current picture among one or more pictures included in a DPB. For example, the decoder 24 may identify the reference picture used to decode the current picture among one or more pictures included in the DPB, by using the lower bit of the POC.

The decoder 24 may determine a POC offset by using the POC value of the current picture. The decoder 24 may update POC values of pictures included in the same layer as the current picture, by using the determined POC offset. For example, the decoder 24 may update a POC value of at least one picture to be reconstructed temporally after the current picture, by using the determined POC offset.

The decoder 24 may signal the POC value of the current picture. For example, the decoder 24 may signal the lower bit of the POC of the current picture and may not signal the higher bit thereof. In this case, the higher bit of the POC of the current picture may be inferred based on the lower bit thereof. As another example, the decoder 24 may signal the lower bit of the POC of the current picture when the current picture is included in the enhancement layer or when the current picture is not an IDR picture. The decoder 24 may not signal the lower bit of the POC of the current picture when the current picture is included in the base layer and the current picture is an IDR picture.

The decoder 24 may acquire the lower bit of the POC of the current picture. The decoder 24 may determine a reference picture used to decode the current picture among one or more pictures included in the DPB, by using the acquired lower bit.

The decoder 24 may acquire the lower bit of the POC of the current picture. The decoder 24 may identify a picture included in the same access unit as the current picture among a plurality of pictures, by using the acquired lower bit.

Although various decoding operations of the multilayer video decoding apparatus 20 are described above in relation to FIGS. 2A and 2B, it will be understood by one of ordinary skill in the art that the method described above in relation to FIGS. 2A and 2B may also be performed by the multilayer video encoding apparatus 10.

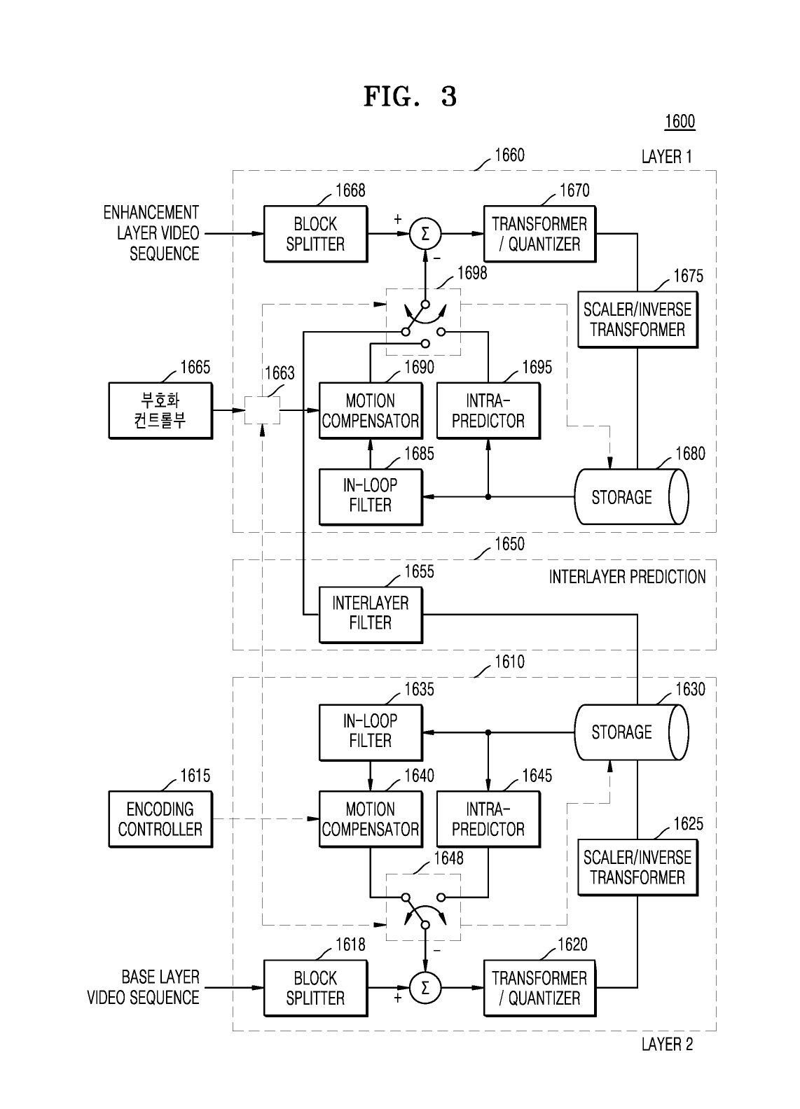

FIG. 3 shows an interlayer prediction structure according to an embodiment.

An interlayer encoding system 1600 consists of a base layer encoding module 1610, an enhancement layer encoding module 1660, and an interlayer prediction module 1650 provided between the base layer encoding module 1610 and the enhancement layer encoding module 1660. The base layer encoding module 1610 and the enhancement layer encoding module 1660 may show specific configurations of a base layer encoder and an enhancement layer encoder, respectively.

The base layer encoding module 1610 receives an input base layer video sequence and encodes the same per picture. The enhancement layer encoding module 1660 receives an input enhancement layer video sequence and encodes the same per picture. Operations commonly performed by the base layer encoding module 1610 and the enhancement layer encoding module 1660 will be described below.

A picture input to a block splitter 1618 or 1668 (a low-resolution or high-resolution picture) is split into the largest coding units, coding units, prediction units, transformation units, etc. To encode each coding unit output from the block splitter 1618 or 1668, intra-prediction or inter-prediction may be performed per prediction unit of the coding unit. A prediction switch 1648 or 1698 determines whether a prediction mode of the prediction unit is an intra-prediction mode or an inter-prediction mode, to perform inter-prediction with reference to a previously reconstructed picture output from a motion compensator 1640 or 1690, or to perform intra-prediction by using a neighboring prediction unit of the current prediction unit within the current input picture, which is output from an intra-predictor 1645 or 1695. Due to inter-prediction, residual information may be generated per prediction unit.

Per prediction unit of the coding unit, the residual information between the prediction unit and the neighboring prediction unit is input to a transformer/quantizer 1620 or 1670. Based on the transformation unit of the coding unit, the transformer/quantizer 1620 or 1670 may output a quantized transformation coefficient by performing transformation and quantization per transformation unit.

A scaler/inverse transformer 1625 or 1675 may generate residual information of a spatial domain by performing scaling and inverse transformation on the quantized transformation coefficient per transformation unit of the coding unit. When the prediction switch 1648 or 1698 determines the inter mode, the residual information may be combined with the previously reconstructed picture or the neighboring prediction unit, thereby generating a reconstructed picture including the current prediction unit. The currently reconstructed picture may be stored in a storage 1630 or 1680. The currently reconstructed picture may be transmitted to the intra-predictor 1645 or 1695/the motion compensator 1640 or 1690 depending on the prediction mode of a following prediction unit to be encoded.

Particularly, in the case of the inter mode, an in-loop filter 1635 or 1685 may perform at least one of deblocking filtering and sample adaptive offset (SAO) filtering per coding unit on the reconstructed picture stored in the storage 1630 or 1680. At least one of deblocking filtering and SAO filtering may be performed on at least one of the coding unit, and the prediction unit and the transformation unit included in the coding unit.

Deblocking filtering is used to mitigate a blocking phenomenon of a data unit, and SAO filtering is used to compensate for pixel values changed due to data encoding and decoding. The data filtered by the in-loop filter 1635 or 1685 may be transmitted to the motion compensator 1640 or 1690 per prediction unit. To encode a following coding unit output from the block splitter 1618 or 1668, residual information between the following coding unit and the currently reconstructed picture output from the motion compensator 1640 or 1690 and the block splitter 1618 or 1668 may be generated.

In this manner, the above-described encoding operation may be performed on each coding unit of the input picture.

For interlayer prediction, the enhancement layer encoding module 1660 may refer to the reconstructed picture stored in the storage 1630 of the base layer encoding module 1610. An encoding controller 1615 of the base layer encoding module 1610 may control the storage 1630 of the base layer encoding module 1610 to transmit the reconstructed picture of the base layer encoding module 1610 to the enhancement layer encoding module 1660. An interlayer filter 1655 of the interlayer prediction module 1650 may perform at least one of deblocking filtering, SAO filtering, and adaptive loop filter (ALF) filtering on the reconstructed base layer picture output from the storage 1630 of the base layer encoding module 1610. When the base layer picture and the enhancement layer picture have different resolutions, the interlayer prediction module 1650 may upsample the reconstructed base layer picture and transmit the upsampled picture to the enhancement layer encoding module 1660. When interlayer prediction is performed based on the determination of the switch 1698 of the enhancement layer encoding module 1660, interlayer prediction may be performed on the enhancement layer picture with reference to the reconstructed base layer picture transmitted from the interlayer prediction module 1650.

To encode a picture, various encoding modes may be set for the coding unit, the prediction unit, and the transformation unit. For example, as encoding modes for the coding unit, a depth, split information (a split flag), etc. may be set. As encoding modes for the prediction unit, a prediction mode, a partition type, intra direction information, reference list information, etc. may be set. As encoding modes for the transformation unit, a transformation depth, split information, etc. may be set.

The base layer encoding module 1610 may determine an encoding depth, a prediction mode, a partition type, an intra direction/reference list, a transformation depth, etc. corresponding to the highest encoding efficiency by comparing results of encoding performed by applying various depths for the coding unit, various prediction modes, various partition types, various intra directions, and various reference lists for the prediction unit, and various transformation depths for the transformation unit. The encoding modes determined by the base layer encoding module 1610 are not limited to the above-listed encoding modes.

The encoding controller 1615 of the base layer encoding module 1610 may control various encoding modes to be appropriately applied to operations of the other elements. In addition, for interlayer encoding of the enhancement layer encoding module 1660, the encoding controller 1615 may control the enhancement layer encoding module 1660 to determine encoding modes or residual information with reference to the encoding result of the base layer encoding module 1610.

For example, the enhancement layer encoding module 1660 may equally use the encoding modes of the base layer encoding module 1610 as encoding modes for the enhancement layer picture, or may determine encoding modes for the enhancement layer picture with reference to the encoding modes of the base layer encoding module 1610. The encoding controller 1615 of the base layer encoding module 1610 may use a current encoding mode among the encoding modes of the base layer encoding module 1610 to allow the enhancement layer encoding module 1660 to determine a current encoding mode thereof by controlling a control signal of an encoding controller 1665 of the enhancement layer encoding module 1660.

Similarly to the interlayer encoding system 1600 using interlayer prediction in FIG. 3, an interlayer decoding system using interlayer prediction may also be implemented. That is, the interlayer decoding system for decoding a multilayer video may receive a base layer bitstream and an enhancement layer bitstream. A base layer decoding module of the interlayer decoding system may reconstruct base layer pictures by decoding the base layer bitstream. An enhancement layer decoding module of the interlayer decoding system may reconstruct enhancement layer pictures by decoding the enhancement layer bitstream by using the reconstructed base layer pictures and parsed encoding information.

FIG. 4A shows a multilayer prediction structure 40 of multilayer pictures.

In the multilayer prediction structure 40 illustrated in FIG. 4A, the pictures are arranged according to reproduction order POC values. According to the reproduction order and the reconstruction order of the multilayer prediction structure 40, pictures of the same layer are arranged in a horizontal direction.

Pictures having the same POC value are arranged in a vertical direction. The POC values of the pictures indicate the reproduction order of the pictures included in a video. ‘POC X’ marked in the multilayer prediction structure 40 indicates a relative reproduction order of the pictures located in each row. A small value of X indicates an early reproduction order, and a large value thereof indicates a late reproduction order.

Accordingly, according to the reproduction order of the multilayer prediction structure 40, the pictures of each layer are arranged in the horizontal direction according to the POC values thereof (reproduction order). Each base layer picture and first and second enhancement layer pictures located in the same column as the base layer picture have the same POC value (reproduction order).

Per layer, four sequential pictures configure one group of pictures (GOP). Each GOP includes pictures located between two sequential anchor pictures, and one anchor picture.

An anchor picture is a random access point (RAP) picture. When a video is reproduced, at a certain reproduction order, that is, if a reproduction location is arbitrarily selected among the pictures arranged according to the POC values, an anchor picture, the POC order of which is the closest to the reproduction location, is reproduced. The base layer pictures include base layer anchor pictures 41, 42, 43, 44, and 45, the first enhancement layer pictures include first enhancement layer anchor pictures 141, 142, 143, 144, and 145, and the second enhancement layer pictures include second enhancement layer anchor pictures 241, 242, 243, 244, and 245.

The multilayer pictures may be reproduced and predicted (reconstructed) in the order of the GOPs. Initially, according to the reproduction order and the reconstruction order of the multilayer prediction structure 40 of FIG. 4A, per layer, the pictures included in GOP 0 may be reconstructed and reproduced, and then the pictures included in GOP 1 may be reconstructed and reproduced. That is, the pictures included in every GOP may be reconstructed and reproduced in the order of GOP 0, GOP 1, GOP 2, and GOP 3.

According to the reproduction order and the reconstruction order of the multilayer prediction structure 40, interlayer prediction and inter-prediction are performed on the pictures. In the multilayer prediction structure 40, a picture from which an arrow starts is a reference picture, and a picture at which the arrow is directed is a picture to be predicted by using the reference picture.

Particularly, in reconstruction order of the multilayer prediction structure 40, the pictures are arranged in the horizontal direction according to the prediction (reconstruction) order thereof. That is, the pictures relatively located at a left side are predicted (reconstructed) first and the pictures relatively located at a right side are predicted (reconstructed) thereafter. Since the pictures are predicted (reconstructed) with reference to previously reconstructed pictures, all arrows indicating prediction directions among the pictures of the same layer are directed from the pictures relatively located at a left side to the pictures relatively located at a right side in reconstruction order of the multilayer prediction structure 40.

The result of predicting the base layer pictures may be encoded and then output in the form of a base layer stream. The result of predicting the first enhancement layer pictures may be output as a first enhancement layer stream, and the result of predicting the second enhancement layer pictures may be output as a second enhancement layer stream.

Only inter-prediction is performed on the base layer pictures. That is, although the I-type anchor pictures 41, 42, 43, 44, and 45 do not refer to other pictures, the other B-type and b-type pictures are predicted with reference to other base layer pictures. The B-type pictures are predicted with reference to I-type anchor pictures having POC values less than those of the B-type pictures, and I-type anchor pictures having POC values greater than those of the B-type pictures. The b-type pictures are predicted with reference to I-type anchor pictures having POC values less than those of the b-type pictures, and B-type pictures having POC values greater than those of the b-type pictures, or with reference to B-type pictures having POC values less than those of the b-type pictures, and I-type anchor pictures having POC values greater than those of the b-type pictures.

On the first enhancement layer pictures and the second enhancement layer pictures, interlayer prediction is performed with reference to the base layer pictures and inter-prediction is performed with reference to pictures of the same layer.

Like the base layer pictures, inter-prediction is performed on the first enhancement layer pictures and is also performed on the second enhancement layer pictures. Among the first enhancement layer pictures and the second enhancement layer pictures, the anchor pictures 141, 142, 143, 144, 145, 241, 242, 243, 244, and 245 may not refer to pictures of the same layer, but the other non-anchor pictures may be predicted with reference to pictures of the same layer.

However, the anchor pictures 141, 142, 143, 144, 145, 241, 242, 243, 244, and 245 among the first enhancement layer pictures and the second enhancement layer pictures are P-type pictures following the POC values of the base layer anchor picture 41, 42, 43, 44, and 45.

The pictures other than the anchor pictures 141, 142, 143, 144, 145, 241, 242, 243, 244, and 245 among the first enhancement layer pictures and the second enhancement layer pictures are B-type and b-type pictures because not only inter-prediction but also interlayer prediction to be performed with reference to the base layer pictures having the same POC values may be performed thereon.

A reconstruction procedure for reproducing the pictures is similar to the prediction procedure. However, only after a reference picture of each picture is reconstructed, the picture may be reconstructed by using the reconstructed reference picture.

Each of the base layer pictures may be reconstructed by performing motion compensation. After the I-type base layer anchor pictures 41, 42, 43, 44, and 45 are reconstructed, B-type base layer pictures may be reconstructed by performing motion compensation with reference to the base layer anchor pictures 41, 42, 43, 44, and 45. In addition, b-type base layer pictures may be reconstructed by performing motion compensation with reference to the reconstructed I-type or B-type base layer pictures.

The first enhancement layer pictures and the second enhancement layer pictures may be reconstructed by performing interlayer prediction with reference to the base layer pictures and performing inter-prediction with reference to pictures of the same layer.

That is, to reconstruct the first enhancement layer pictures, after the base layer pictures to be used as reference pictures are reconstructed, some first enhancement layer pictures may be reconstructed by performing interlayer variation compensation with reference to the reconstructed base layer pictures. In addition, after the first enhancement layer pictures to be used as reference pictures are reconstructed, the other first enhancement layer pictures may be reconstructed by performing motion compensation with reference to the reconstructed first enhancement layer pictures.

In addition, after the base layer pictures to be used as reference pictures are reconstructed, some second enhancement layer pictures may be reconstructed by performing interlayer variation compensation with reference to the reconstructed base layer pictures. In addition, after the second enhancement layer pictures to be used as reference pictures are reconstructed, the other second enhancement layer pictures may be reconstructed by performing motion compensation with reference to the reconstructed second enhancement layer pictures.

FIG. 4B shows a multilayer prediction structure based on a temporal hierarchical encoding/decoding scheme.

A scalable video coding scheme may be performed based on a temporal hierarchical prediction structure 50. The temporal hierarchical prediction structure 50 includes a prediction structure of hierarchical B-type pictures 55, 56, 57, 58, 59, 60, 61, 62, and 63. In the prediction structure at level 0, inter-prediction is performed on I-type pictures 51 and 54 and performed on P-type pictures 52 and 53. In the prediction structure at level 1, inter-prediction is performed on the B-type pictures 55, 56, and 57 with reference to the I-type and P-type pictures 51, 52, 53, and 54. In the prediction structure at level 2, inter-prediction is performed with reference to the I-type and P-type pictures 51, 52, 53, and 54 and the B-type pictures 55, 56, and 57 of level 1.

Herein, a ‘temporal_id’ is a value for identifying a prediction level. If the pictures of each level are output, a frame rate may be increased. For example, the level-0 pictures 51, 52, 53, and 54 may be decoded and output at a frame rate of 15 Hz. If the level-1 pictures 55, 56, and 57 are decoded and output, the frame rate may be increased to 30 Hz. Then, if the level-2 pictures 58, 59, 60, 61, 62, are 63 are decoded and output, the frame rate may be increased to 60 Hz.

According to an embodiment, if the temporal hierarchical prediction structure 50 is implemented by using a scalable video coding scheme, the level-0 pictures may be encoded as base layer pictures, the level-1 pictures may be encoded as first enhancement layer pictures, and the level-2 pictures may be encoded as second enhancement layer pictures.

In the decoding procedure of the multilayer prediction structure of FIGS. 4A and 4B, to reconstruct pictures through motion compensation or interlayer decoding, previously reconstructed base layer pictures may be used or previously reconstructed enhancement layer pictures may be used. However, when layer switching or a random access request occurs, a picture having a reconstruction order earlier than that of a current RAP picture may not be previously reconstructed. In this case, pictures predicted with reference to the picture having a reconstruction order earlier than that of the current RAP picture may not be reconstructed.

FIG. 4C illustrates NAL units including encoded data of a multilayer video, according to an embodiment.

As described above, the multilayer video encoding apparatus 10 outputs NAL units including encoded multilayer video data and additional information.

A video parameter set (VPS) includes information applied to multilayer video sequences 32, 33, and 34 included in the multilayer video. A NAL unit including information about the VPS is called a VPS NAL unit 31.

The VPS NAL unit 31 includes common syntax elements shared by the multilayer video sequences 32, 33, and 34, operation point information for preventing unnecessary data transmission, and essential operation point information required for session negotiation, e.g., a profile or a level. Particularly, the VPS NAL unit 31 according to an embodiment includes scalability information about scalability identifiers for implementing scalability in the multilayer video. The scalability information is information for determining scalability applied to the multilayer video sequences 32, 33, and 34 included in the multilayer video.

As to be described below, the scalability information includes information about scalability types and scalability dimensions applied to the multilayer video sequences 32, 33, and 34 included in the multilayer video. In an encoding/decoding method according to a first embodiment of the present invention, the scalability information may be directly acquired from the value of a layer identifier included in a NAL unit header. The layer identifier is an identifier for distinguishing a plurality of layers included in the VPS. The VPS may signal the layer identifier of each layer through VPS extension. The layer identifier of each layer of the VPS may be signaled by using the VPS NAL unit. For example, the layer identifier of NAL units belonging to a specific layer of the VPS may be included in the VPS NAL unit. For example, the layer identifiers of the NAL units belonging to the VPS may be signaled through VPS extension. Thus, in the encoding/decoding method according to an embodiment of the present invention, the scalability information of a layer of NAL units belonging to the VPS may be acquired by using a layer identifier of the NAL units.

In an encoding/decoding method according to a second embodiment of the present invention, the scalability information may be acquired with reference to a scalability dimension table by using a value acquired from a layer identifier. For example, the scalability information of a NAL unit may be acquired with reference to the scalability dimension table by using the order of a specific partial identifier corresponding to a binary expression of the layer identifier value in the layer identifier, and the value of the partial identifier as indices. In an encoding/decoding method according to a third embodiment of the present invention, the scalability information of a specific NAL unit may be acquired with reference to a scalability dimension table determined based on a layer identifier and a scalability type order.

Instead of being included in the VPS NAL unit 31, the layer identifier information may be included in SPS NAL units 32a, 33a, and 34a including sequence parameter set (SPS) information of each layer, or in PPS NAL units 32b, 33b, and 34b including picture parameter set (PPS) information of each layer.

An SPS includes information commonly applied to a video sequence of one layer. Each of the SPS NAL units 32a, 33a, and 34a including the SPS includes information commonly applied to each of the video sequences 32, 33, and 34.

A PPS includes information commonly applied to pictures of one layer. Each of the PPS NAL units 32b, 33b, and 34b including the PPS includes information commonly applied to pictures of the same layer. The PPS may include information about a coding mode of all pictures, e.g., an entropy coding mode and an initial quantization parameter value of a picture unit. The PPS does not need to be generated for every picture. That is, when no PPS is present, a previous PPS is used. When the information included in the PPS needs to be updated, the PPS may be newly set and a PPS NAL unit including information about the set PPS may be generated.

Slice segments include encoded data of at least one largest coding unit, and may be included and transmitted in slice segment NAL units 32c, 33c, and 34c.

As illustrated in FIG. 4C, one video includes the multilayer video sequences 32, 33, and 34. To identify a sequence, the SPS of each layer includes an SPS identifier sequence_parameter_set_id, and a sequence including a PPS may be identified by designating the SPS identifier for the PPS. In addition, the PPS includes a PPS identifier picture_parameter_set_id, and a PPS used by a slice segment may be identified by including the PPS identifier in the slice segment. Furthermore, an SPS and a layer used by the slice segment may be identified by using the SPS identifier included in the PPS indicated by the PPS identifier of the slice segment. For example, it is assumed that the SPS identifier sequence_parameter_set_id of the first layer SPS NAL unit 32a has the value 0. In this case, the first layer PPS NAL unit 32b included in the first layer video sequence 32 includes the SPS identifier sequence_parameter_set_id having the value 0. It is also assumed that the PPS identifier picture_parameter_set_id of the first layer PPS NAL unit 32b has the value 0. In this case, the first layer slice segment NAL unit 32c referring to the first layer PPS NAL unit 32b includes the PPS identifier picture_parameter_set_id having the value 0.

Although an example of configuring one VPS is illustrated in FIG. 4C, the multilayer video illustrated in FIG. 4C may be configured in a plural number. In this case, a VPS identifier video_parameter_set_id may be included in an SPS NAL unit to identify a multilayer video including NAL units among the plurality of multilayer videos. For example, when the VPS identifier video_parameter_set_id of the VPS NAL unit 31 has the value 0, the SPS NAL units 32a, 33a, and 34a included in one multilayer video may include the VPS identifier video_parameter_set_id having the value 0.

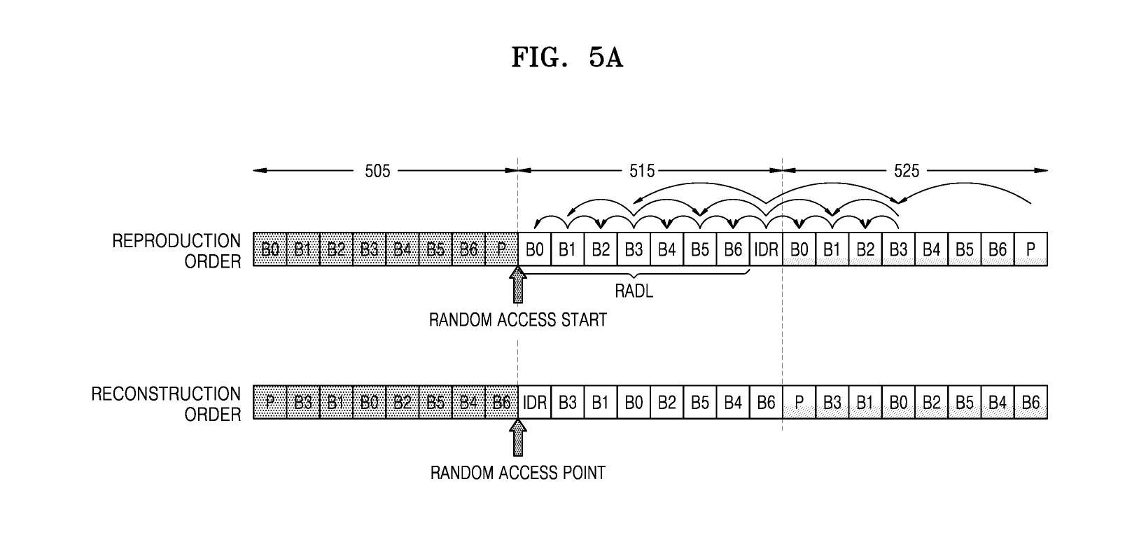

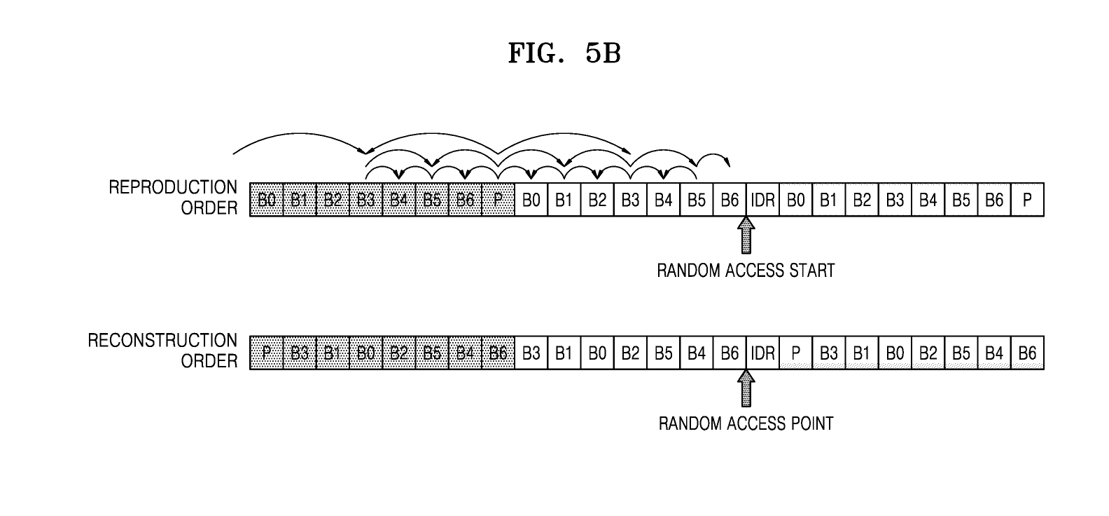

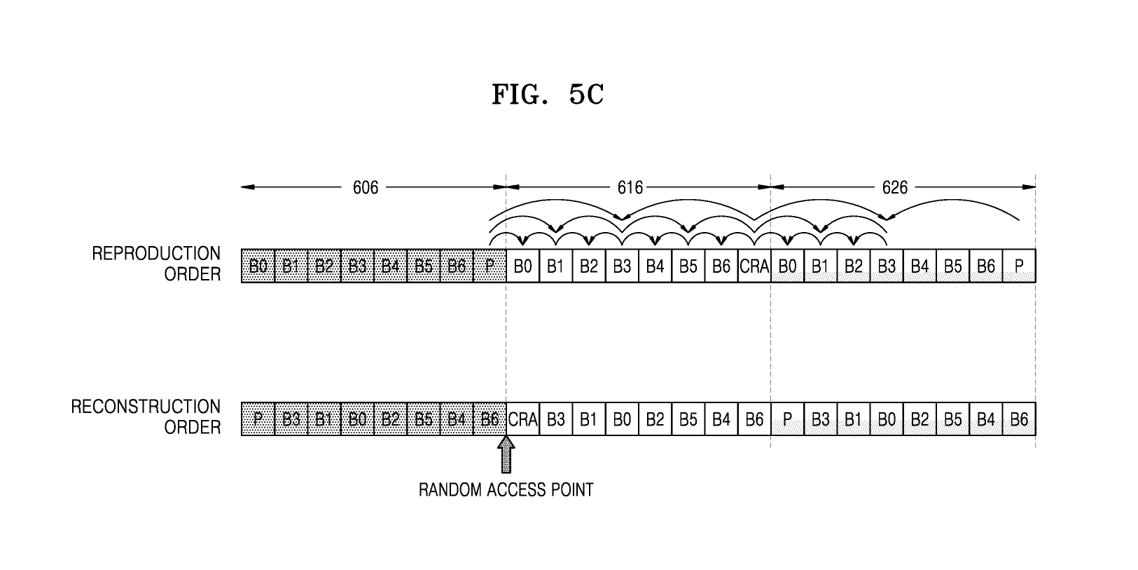

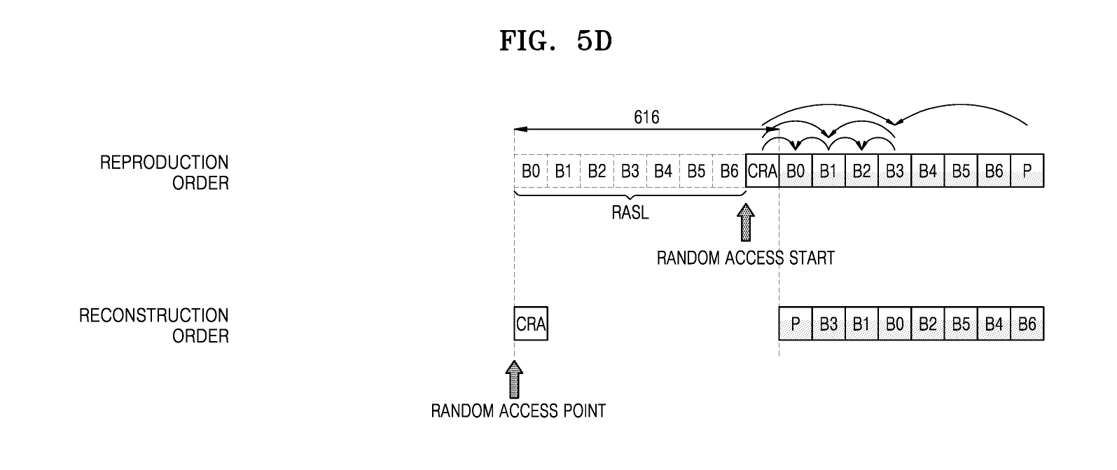

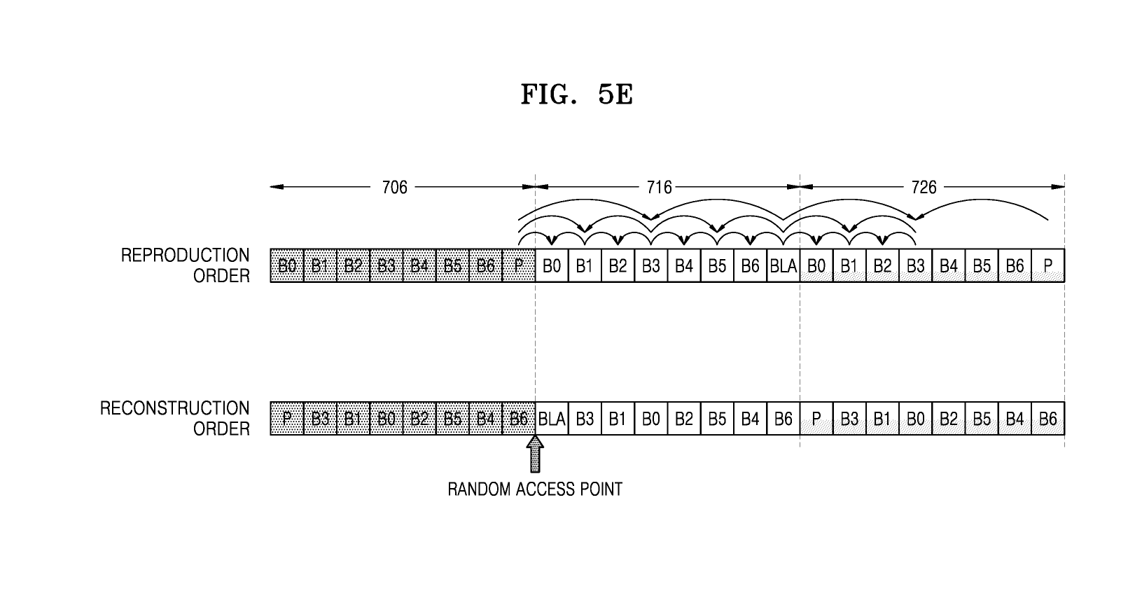

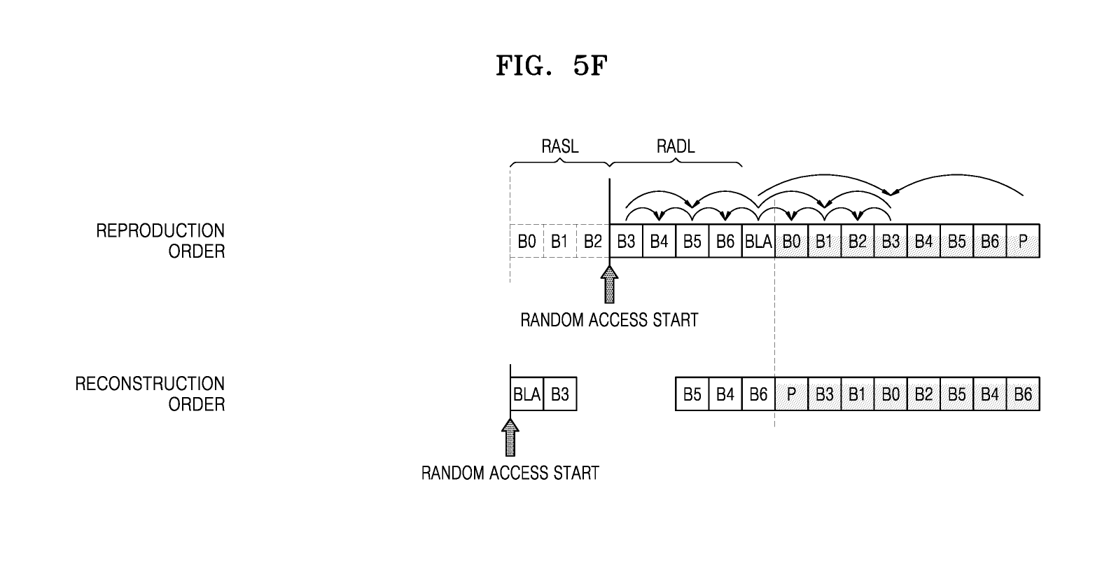

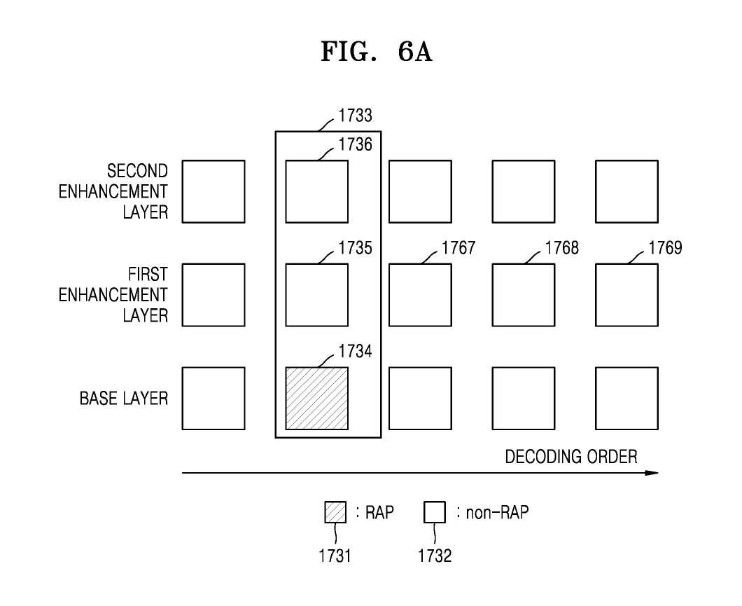

Decoding operations performed based on the types of RAP pictures when a random access request occurs are now described in detail with reference to FIGS. 5A to 5F.

FIGS. 5A and 5B show a reproduction order and a reconstruction order of an instantaneous decoding refresh (IDR) picture, according to two embodiments.

In FIG. 5A, the size of each group of pictures (GOP) 505, 515, or 525 is 8. B0, B1, B2, B3, B4, B5, and B6 are identifiers of B-type pictures belonging to the same GOP and arranged according to the reproduction order thereof.

An IDR picture is an independently encoded picture. In a decoding procedure of the IDR picture, all reconstructed pictures may be marked as “unused for reference”. Pictures following the IDR picture in reconstruction order may be reconstructed without performing inter-prediction by using pictures preceding the IDR picture in reconstruction order. The first picture of each coded video sequence in reconstruction order is the IDR picture.

For example, the B-type pictures of the GOP 515 precede the IDR picture in reproduction order but follow the IDR picture in reconstruction order. In addition, the B-type pictures of the GOP 515 refer to no other pictures preceding the IDR picture in reconstruction order. The B-type pictures of the GOP 525 follow the IDR picture both in reconstruction order and reproduction order, and do not refer to other pictures preceding the IDR picture in reconstruction order.

It is assumed that random access occurs. Pictures preceding a random access point in reconstruction order may not be reconstructed. In FIG. 5A, although the B-type pictures of the GOP 515 precedes the IDR picture in reproduction order, the IDR picture may be reconstructed and then the B-type pictures of the GOP 515 may be reconstructed with reference to the reconstructed IDR picture. In this case, all of the B-type pictures of the GOP 515 may be decoded and output and thus may be RADL pictures. Accordingly, all of the B-type pictures of the GOP 515 may be reproduced, and thus the random access point may equal a start point of random access reproduction.

In FIG. 5B, since the B-type pictures of the GOP 515 do not need to be decoded in reproduction order from the random access point, random access starts from the IDR picture and the B-type pictures of the GOP 525 are reproduced.

When the IDR picture is used, all pictures in reproduction order from the random access point may be appropriately reconstructed without being lost, but encoding/decoding efficiency may be reduced.

FIGS. 5C and 5D show a reproduction order and a reconstruction order of a CRA picture, according to two embodiments.

The CRA picture is a picture including only I-type slices. In a decoding procedure of the CRA picture, all reconstructed pictures stored in a decoded picture buffer (DPB) may be marked as “unused for reference”. Pictures following the CRA picture both in reconstruction order and reproduction order (both in decoding order and output order) may be reconstructed without performing inter-prediction by using pictures preceding an IDR picture either in reconstruction order or reproduction order (either in decoding order or output order). Pictures preceding the CRA picture in reconstruction order also precede the CRA picture in reproduction order.

The pictures following the CRA picture both in reconstruction order and reproduction order may be normal pictures. Accordingly, a normal picture may use only at least one picture among the CRA picture and other normal pictures located in the same GOP.

The CRA picture may be the first picture of a coded video sequence in reconstruction order. However, the CRA picture may be located in the middle of the bitstream for normal reproduction having no random access.

For example, in FIG. 5C, B-type pictures of a GOP 616 precede the CRA picture in reproduction order but follow the CRA picture in reconstruction order. All B-type pictures of a GOP 626 are normal pictures following the CRA picture both in reconstruction order and reproduction order, and do not refer to other pictures preceding the IDR picture in reconstruction order. However, some of the B-type pictures of the GOP 616 may refer to other pictures preceding the CRA picture in reconstruction order.

At a random access point of FIG. 5D, the B-type pictures of the GOP 616 refer to pictures preceding the random access point and thus may not be reconstructed. The B-type pictures of the GOP 616 are RASL pictures which are skipped in the reconstruction procedure. Accordingly, the B-type pictures of the GOP 626 may be reconstructed and reproduced immediately after random access reproduction starts from the CRA picture.

FIGS. 5E and 5F show a reproduction order and a reconstruction order of a BLA picture, according to two embodiments.

Bitstream slicing refers to an operation for connecting a RAP picture of a current bitstream with another bitstream. The connection point of the new bitstream is referred to as a ‘broken link’. A NAL unit type of a RAP picture at a location enabling bitstream slicing is BLA.

For example, in FIG. 5E, the BLA picture is similar to a CRA picture in reproduction order and reconstruction order. The BLA picture follows B-type pictures of a GOP 716, which are leading pictures, and precedes B-type pictures of a GOP 726, which are normal pictures, in reproduction order. The leading pictures and the normal pictures follow the BLA picture in reconstruction order.

B3, B4, B5, and B6 among the leading pictures are RASL pictures which refer to the BLA picture and other pictures of the GOP 716. However, B1, B2, and B2 among the leading pictures are RADL pictures which refer to pictures of a GOP 706, which precede the BLA picture in reconstruction order.

Thus, in FIG. 5F, when random access occurs in the BLA picture, reconstruction of the RASL pictures B1, B2, and B2 may be skipped, and the RADL pictures B3, B4, B5, and B6 may be reconstructed. Accordingly, the RADL pictures may be output from B3 according to the reproduction order thereof.

In the hierarchical prediction structure described above in relation to FIG. 4B, since temporal layer switching or layer switching occurs, a temporal sublayer access (TSA) picture may be used as a layer-switchable location. The TSA picture is similar to a CRA picture. During lower layer pictures are reconstructed, layer switching may be performed to reconstruct higher layer pictures from the TSA picture. For example, a smaller value of a ‘temporal_id’ refers to a lower layer. Pictures of the same layer following the TLA picture in reconstruction order, or pictures of a higher layer compared to the TLA picture may not refer to pictures of the same or higher layer compared to a previous TLA picture preceding the TLA picture in reconstruction order. The TLA picture may not be the lowest layer picture, and thus the ‘temporal_id’ thereof may not have the value 0.

The RAP types for random access are described in detail above in relation to FIGS. 4B, 5A, 5B, 5C, 5D, 5E, and 5F. When a random access request or layer switching occurs during a video stream is reconstructed in a single layer, pictures may be reconstructed from a RAP picture. However, if random access occurs in a predetermined layer among multiple layers and thus pictures of the layer are reconstructed, pictures of other layers corresponding thereto also need to be accurately reconstructed. In addition, when layer switching or a random access request occurs in the predetermined layer, if no reference picture is present in a DPB and thus reconstruction of an RASL picture is skipped, reconstruction of pictures of other layers corresponding thereto also need to be skipped.

Therefore, the multilayer video encoding apparatus 10 according to an embodiment may provide RAP pictures of the same NAL unit type at random access points or layer switching points of layers, and may also provide RASL or RSDL pictures at the same locations of the layers. The multilayer video decoding apparatus 20 may reconstruct the RAP pictures of the same NAL unit type at the random access points or the layer switching points of the layers. In addition, the multilayer video decoding apparatus 20 may reconstruct the RSDL pictures and reconstruct the RASL pictures at the same locations of the layers. If random access occurs in a predetermined layer, the RAP pictures and the RSDL pictures provided at the same locations of the layers may be reconstructed, and reconstruction of the RASL pictures provided at the same locations may be skipped.

For example, an enhancement layer IDR picture may be reconstructed at a location corresponding to a base layer IDR picture. An enhancement layer CRA picture may be reconstructed at a location corresponding to a base layer CRA picture. An enhancement layer BLA picture may be reconstructed at a location corresponding to a base layer BLA picture.

As another example, the multilayer video encoding apparatus 10 may provide a CRA picture, a RSDL/RASL picture, or a normal picture of an enhancement layer corresponding to a normal picture of a base layer. The multilayer video decoding apparatus 20 according to an embodiment may reconstruct the CRA picture, the RSDL/RASL picture, or the normal picture of the enhancement layer corresponding to the normal picture of the base layer.

In addition, a temporal layer identifier ‘temporal_id’ of enhancement layer pictures should be greater than that of base layer pictures.

Based on the multilayer video encoding apparatus 10 and the multilayer video decoding apparatus 20 according to an embodiment, even when random access or layer switching occurs in a multilayer prediction structure, pictures of the same locations of layers may be reconstructed or reconstruction thereof may be skipped. As such, reference pictures for interlayer prediction may be ensured and output pictures of each layer may be arranged in accurate order.

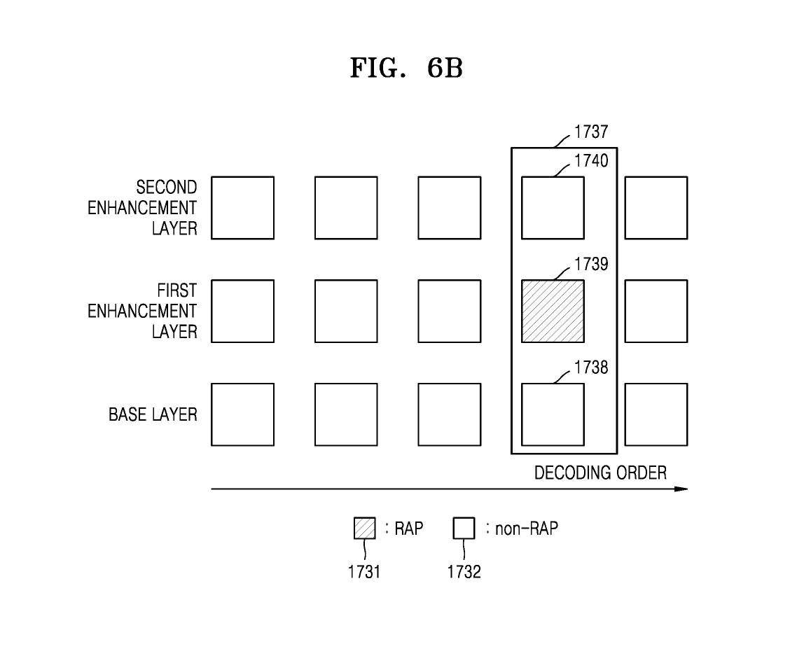

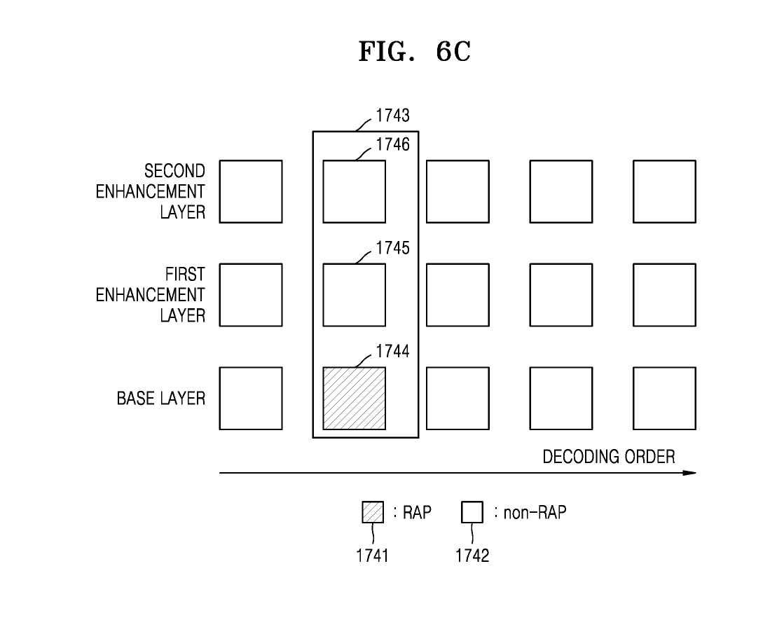

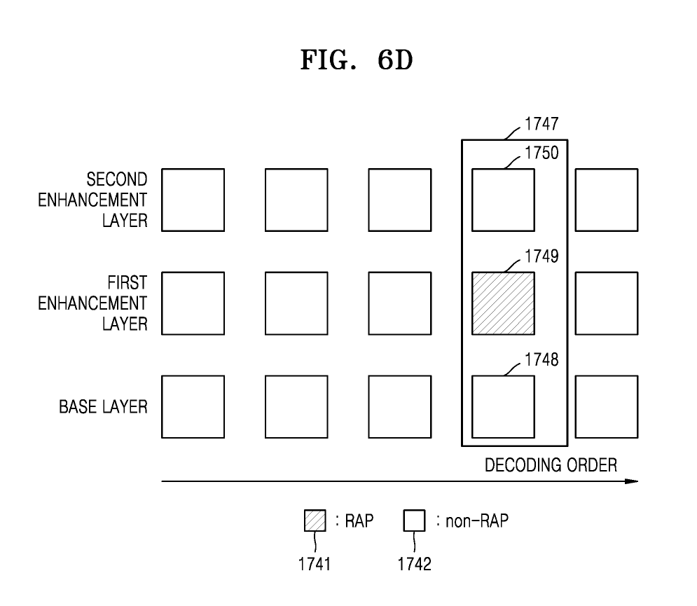

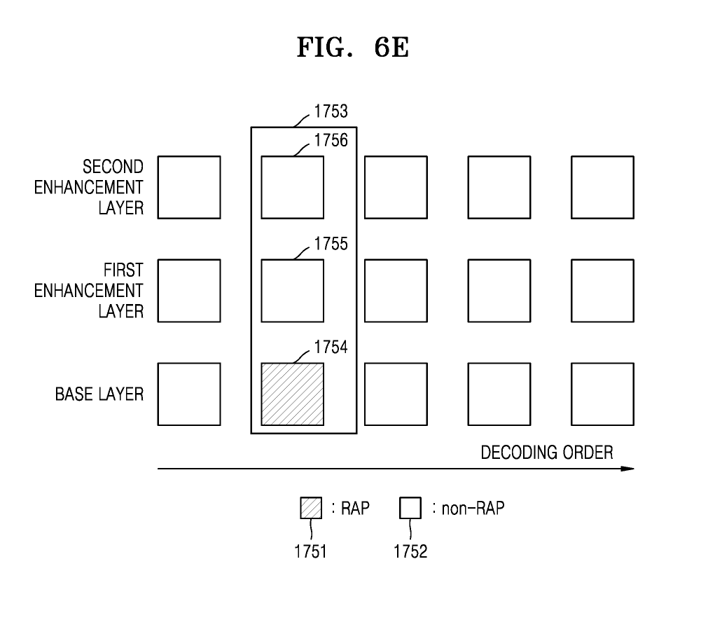

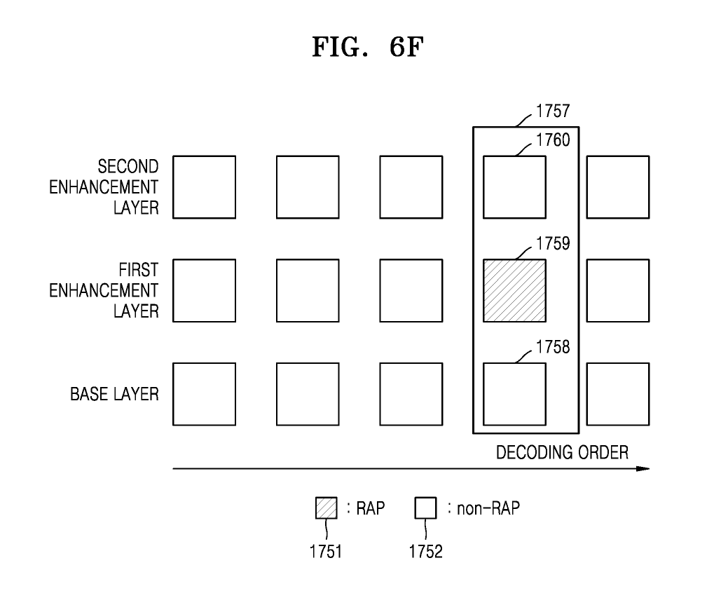

FIGS. 6A to 6F show an interlayer and multilayer prediction structure for describing a method of determining picture order count (POC) values of pictures.

FIG. 6A is a diagram for describing a method of determining POC values of pictures in a case when a base layer includes a RAP picture, according to various embodiments.

The multilayer video encoding apparatus 10 according to an embodiment may check the type of a current picture 1734. The multilayer video encoding apparatus 10 may determine reset information of the current picture 1734 based on the type of the current picture 1734. The reset information according to an embodiment may be provided in the form of a flag. For example, the reset information may be named as poc_reset_flag or full_poc_reset_flag and may have one of the values 0 and 1. The reset information according to another embodiment may have three or more values. For example, the reset information may be named as poc_reset_idc and may have one of the values 0, 1, 2, and 3.

POC values of pictures other than the current picture 1734 included in the base layer may be determined based on the type of the current picture 1734.

For example, when the current picture 1734 included in the base layer is a RAP picture, reset information of a first picture 1735 included in the same access unit as the current picture 1734 may indicate to reset the POC value of the first picture 1735. The reset information according to an embodiment may indicate to reset a higher bit of the POC of the first picture 1735. The reset information according to another embodiment may indicate to reset a lower bit of the POC of the first picture 1735. The reset information according to another embodiment may indicate to reset the higher bit and the lower bit of the POC of the first picture 1735.

As another example, when the current picture 1734 included in the base layer is a RAP picture, reset information of a second picture 1736 included in the same access unit as the current picture 1734 may indicate to reset the POC value of the second picture 1736. The reset information according to an embodiment may indicate to reset a higher bit of the POC of the second picture 1736. The reset information according to another embodiment may indicate to reset a lower bit of the POC of the second picture 1736. The reset information according to another embodiment may indicate to reset the higher bit and the lower bit of the POC of the second picture 1736.

A POC value of the current picture 1734 included in the base layer may be determined based on the type of the current picture 1734.

For example, when the current picture 1734 included in the base layer is a RAP picture, the reset information of the current picture 1734 may indicate to reset the POC value of the current picture 1734. The reset information according to an embodiment may indicate to reset a higher bit of the POC of the current picture 1734. The reset information according to another embodiment may indicate to reset a lower bit of the POC of the current picture 1734. The reset information according to another embodiment may indicate to reset the higher bit and the lower bit of the POC of the current picture 1734.

The POC value of a picture corresponding to the reset information may be determined based on the value of the reset information. According to an embodiment, the POC value of the first picture 1735 may be determined based on the value of the reset information of the first picture 1735. According to another embodiment, the POC value of the current picture 1734 may be determined based on the value of the reset information of the current picture 1734.

For example, when the value of the reset information of the first picture 1735 is 0, both the higher bit and the lower bit of the POC of the first picture 1735 may not be reset. As another example, when the value of the reset information of the first picture 1735 is 1, the higher bit of the POC of the first picture 1735 may be reset and the lower bit thereof may not be reset. As another example, when the value of the reset information of the first picture 1735 is 2, both the higher bit and the lower bit of the POC of the first picture 1735 may be reset. As another example, when the value of the reset information of the first picture 1735 is 3, only the higher bit of the POC of the first picture 1735 may be reset or both the higher bit and the lower bit of the POC of the first picture 1735 may be reset. Herein, when the current picture 1734 included in the base layer is a RAP picture and a current access unit 1733 includes a non-RAP picture, according to an embodiment, the value of the reset information of the first picture 1735 may be 1 or 2. According to another embodiment, when the current picture 1734 included in the base layer among pictures included in the current access unit 1733 is an IDR picture, the value of the reset information of every picture included in the current access unit 1733 may be 1. According to another embodiment, when the current picture 1734 is an IDR picture and the current access unit 1733 includes a non-IDR picture, the value of the reset information of the pictures included in the current access unit 1733 may be 2.

According to another embodiment, when the current picture is a CRA or BLA picture, the value of the reset information of the current picture may be less than 3.

The POC value of the first picture 1735 may be reset to 0 based on the type of the current picture 1734. In this case, POC values of pictures 1767, 1768, and 1769 to be decoded after the first picture 1735 may be updated.

For example, when the POC value of the first picture 1735 before being reset is 3, the POC values of the picture 1-1 1767, the picture 1-2 1768, and the picture 1-3 1769 may be 4, 5, and 6, respectively. When the POC value of the first picture 1735 is reset, the POC value of the first picture 1735 before being reset may be determined as an offset. Accordingly, the offset in this case may be 3. The POC values of the pictures to be decoded temporally after the first picture 1735 may be updated to values obtained by subtracting the offset from original POC values thereof. Accordingly, the POC values of the picture 1-1 1767, the picture 1-2 1768, and the picture 1-3 1769 may be updated to 1, 2, and 3. Herein, the POC value may consist of a higher bit and a lower bit, and the reset information may be applied to at least one of the higher bit and the lower bit. Even when the reset information is applied to the higher bit or the lower bit, the POC value may also be updated in the above-described manner.

FIG. 6B is a diagram for describing a method of determining POC values of pictures in a case when an enhancement layer includes a RAP picture, according to various embodiments.

The multilayer video encoding apparatus 10 according to an embodiment may check the type of a third picture 1738 included in a base layer among pictures of an access unit 1737 including a current picture 1739. The multilayer video encoding apparatus 10 may determine reset information of the current picture 1739 based on the type of the third picture 1738. The reset information according to an embodiment may be provided in the form of a flag. For example, the reset information may be named as poc_reset_flag or full_poc_reset_flag and may have one of the values 0 and 1. The reset information according to another embodiment may have three or more values. For example, the reset information may be named as poc_reset_idc and may have one of the values 0, 1, 2, and 3. In addition, the reset information may have a preset name and have a value within a preset range.

The reset information of the current picture 1739 and reset information of a fourth picture 1740 may be determined based on the type of the third picture 1738. When the third picture 1738 is a non-RAP picture, the reset information of the current picture 1739 and the reset information of the fourth picture 1740 may indicate not to reset POC values thereof.

In this case, the current picture 1739, the third picture 1738, and the fourth picture 1740 may be included in the same access unit 1737.

FIG. 6C is a diagram for describing a method of determining POC values of pictures in a case when a base layer includes an IDR picture, according to various embodiments.

The description given above in relation to FIG. 6A may be included herein by reference except for the type of a current picture.

POC values of pictures 1745 and 1746 other than a current picture 1744 included in the base layer may be determined based on the type of the current picture 1744.

For example, when the current picture 1744 included in the base layer is an IDR picture, reset information of the fifth picture 1745 included in the same access unit 1743 as the current picture 1744 may indicate to reset the POC value of the fifth picture 1745. The reset information according to an embodiment may indicate to reset a higher bit of the POC of the fifth picture 1745. The reset information according to another embodiment may indicate to reset a lower bit of the POC of the fifth picture 1745. The reset information according to another embodiment may indicate to reset the higher bit and the lower bit of the POC of the fifth picture 1745.

A POC value of the current picture 1744 may be determined based on the type of the current picture 1744 included in the base layer.

For example, when the current picture 1744 included in the base layer is an IDR picture, reset information of the current picture 1744 may indicate to reset the POC value of the current picture 1744. The reset information according to an embodiment may indicate to reset a higher bit of the POC of the current picture 1744. The reset information according to another embodiment may indicate to reset a lower bit of the POC of the current picture 1744. The reset information according to another embodiment may indicate to reset the higher bit and the lower bit of the POC of the current picture 1744.

The POC value of a picture corresponding to the reset information may be determined based on the value of the reset information. According to an embodiment, the POC value of the fifth picture 1745 may be determined based on the value of the reset information of the fifth picture 1745. According to another embodiment, the POC value of the current picture 1744 may be determined based on the value of the reset information of the current picture 1744.

FIG. 6D is a diagram for describing a method of determining POC values of pictures in a case when an enhancement layer includes an IDR picture, according to various embodiments.

The description given above in relation to FIG. 6B may be included herein by reference except for the type of a current picture.

Reset information of a current picture 1749 and reset information of a seventh picture 1750 may be determined based on the type of a sixth picture 1748. When the sixth picture 1748 is a non-RAP picture, the reset information of the current picture 1749 and the reset information of the seventh picture 1750 may indicate not to reset POC values thereof.

In this case, the current picture 1749, the sixth picture 1748, and the seventh picture 1750 may be included in the same access unit 1747.

FIG. 6E is a diagram for describing a method of determining POC values of pictures in a case when a base layer includes a BLA picture, according to various embodiments.

The description given above in relation to FIG. 6A may be included herein by reference except for the type of a current picture.

POC values of pictures 1755 and 1756 other than a current picture 1754 included in the base layer may be determined based on the type of the current picture 1754.

For example, when the current picture 1754 included in the base layer is a BLA picture, reset information of the eighth picture 1755 included in the same access unit 1753 as the current picture 1754 may indicate to reset the POC value of the eighth picture 1755. The reset information according to an embodiment may indicate to reset a higher bit of the POC of the eighth picture 1755. The reset information according to another embodiment may indicate to reset a lower bit of the POC of the eighth picture 1755. The reset information according to another embodiment may indicate to reset the higher bit and the lower bit of the POC of the eighth picture 1755.

A POC value of the current picture 1754 may be determined based on the type of the current picture 1754 included in the base layer.

For example, when the current picture 1754 included in the base layer is a BLA picture, reset information of the current picture 1754 may indicate to reset the POC value of the current picture 1754. The reset information according to an embodiment may indicate to reset a higher bit of the POC of the current picture 1754. The reset information according to another embodiment may indicate to reset a lower bit of the POC of the current picture 1754. The reset information according to another embodiment may indicate to reset the higher bit and the lower bit of the POC of the current picture 1754.

The POC value of a picture corresponding to the reset information may be determined based on the value of the reset information. According to an embodiment, the POC value of the eighth picture 1755 may be determined based on the value of the reset information of the eighth picture 1755. According to another embodiment, the POC value of the current picture 1754 may be determined based on the value of the reset information of the current picture 1754.

FIG. 6F is a diagram for describing a method of determining POC values of pictures in a case when an enhancement layer includes a BLA picture, according to various embodiments.

The description given above in relation to FIG. 6B is included herein by reference except for the type of a current picture.

Reset information of a current picture 1759 and reset information of a tenth picture 1760 may be determined based on the type of a ninth picture 1758. When the ninth picture 1758 is a non-RAP picture, the reset information of the current picture 1759 and the reset information of the tenth picture 1760 may indicate not to reset POC values thereof.

In this case, the current picture 1759, the ninth picture 1758, and the tenth picture 1760 may be included in the same access unit 1757.

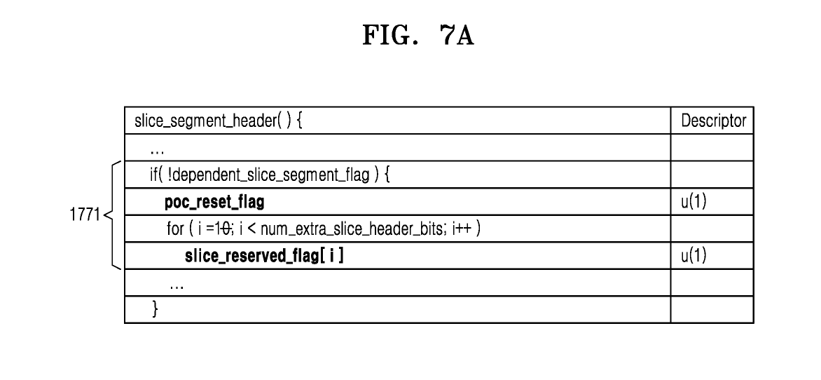

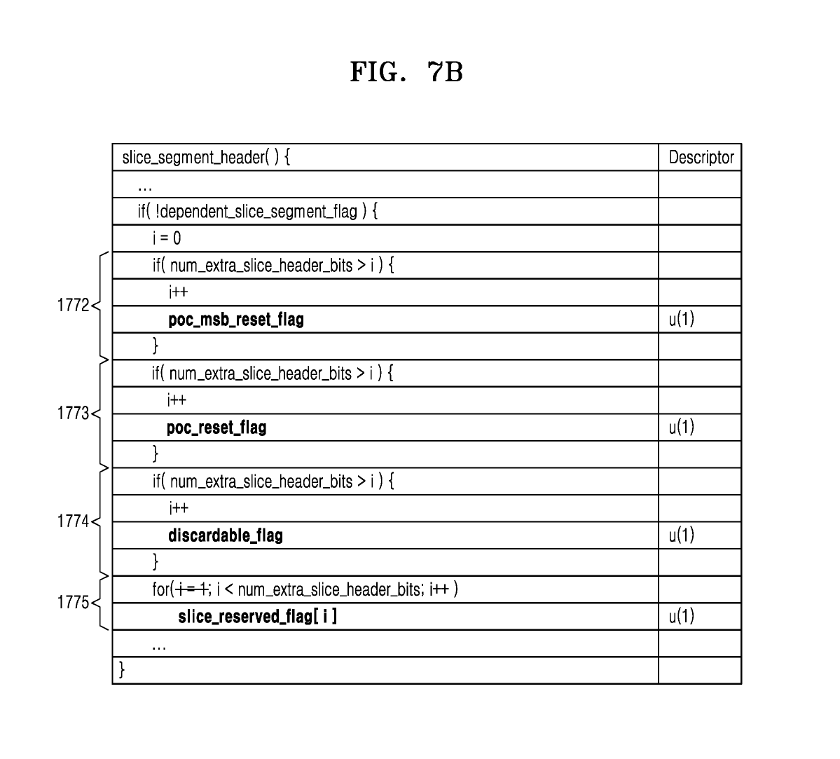

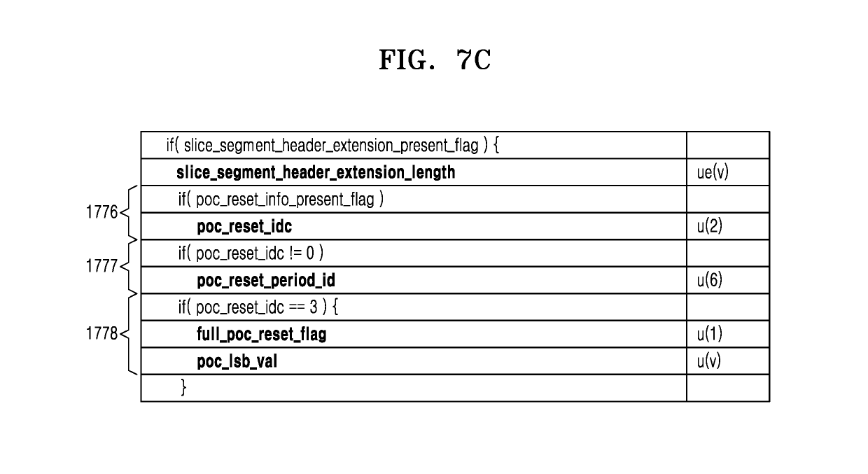

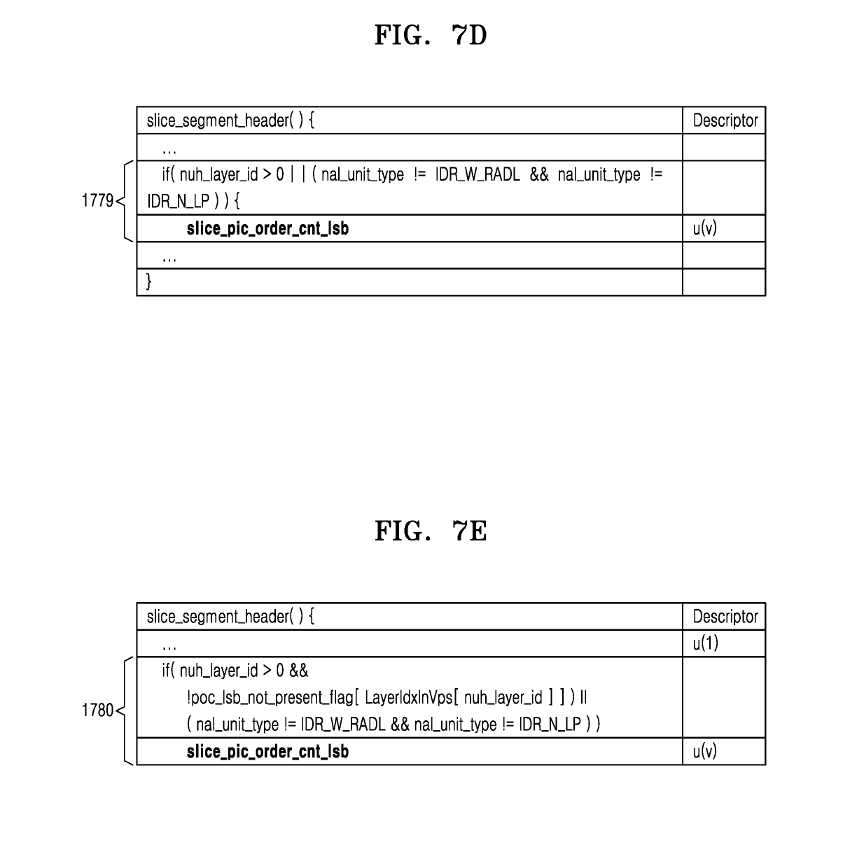

FIGS. 7A to 7E show various examples of syntax for describing a method of determining POC values of pictures, according to embodiments.

FIG. 7A shows an example of syntax for describing reset information, according to an embodiment.

The reset information according to an embodiment may be expressed as a poc_reset_flag. In this case, the reset information may be signaled by using a slice header.

As shown by conditional syntax 1771, one of reserved bits included in a slice header may be used as the poc_reset_flag. For example, as shown in the conditional syntax 1771, by setting the value of i in for syntax to 1 other than 0, the first bit among reserved bits may be used as the poc_reset_flag. For example, a slice_reserved_flag[0] may be used as the poc_reset_flag, and a slice_reserved_flag[1] to a slice_reserved_flag[7] may be used as reserved bits. In this case, an HEVC extension decoder may acquire the poc_reset_flag value signaled by using the reserved bit.

According to an embodiment, the value 1 of the poc_reset_flag may indicate that a POC value of a current picture is 0. The value 0 of the poc_reset_flag may indicate that the POC value of the current picture may be or may not be 0.

FIG. 7B shows an example of syntax for describing reset information for resetting a higher bit, according to an embodiment.

According to an embodiment, a num_extra_slice_header_bit operating in conditional syntax 1772 may be parsed. According to an embodiment, the num_extra_slice_header_bit may be signaled by using a PPS. The num_extra_slice_header_bit may indicate the number of bits used among reserved bits. For example, the value 0 of the num_extra_slice_header_bit may indicate that no reserved bit is used. As another example, when the value of the num_extra_slice_header_bit is 1, the multilayer video encoding apparatus 10 and the multilayer video decoding apparatus 20 may use one reserved bit.

According to an embodiment, when the value of the num_extra_slice_header_bit is 2, since the num_extra_slice_header_bit is greater than the value 0 in the conditional syntax 1772, the multilayer video decoding apparatus 20 may increase the value of i to 1, and parse a poc_msb_reset_flag. In this case, since the num_extra_slice_header_bit is greater than the value 1 in conditional syntax 1773, the multilayer video decoding apparatus 20 may increase the value of i to 2, and parse a poc_reset_flag. In this case, since the num_extra_slice_header_bit is not greater than the value 2 in conditional syntax 1774, the multilayer video decoding apparatus 20 may not parse a discardable_flag.

Conditional syntax 1775 may indicate that a predetermined number of bits are used among reserved bits.

According to an embodiment, the poc_msb_reset_flag may indicate whether to reset a higher bit of a POC of a current picture to 0. For example, when the poc_msb_reset_flag has the value 1, the higher bit of the POC of the current picture may be reset to 0. As another example, when the poc_msb_reset_flag has the value 0, the value of the higher bit of the POC of the current picture may be or may not be 0.

According to an embodiment, a cross_layer_irap_aligned_flag may indicate whether all pictures included in an access unit including the current picture are RAP pictures. For example, the value 1 of the cross_layer_irap_aligned_flag may indicate that all pictures included in the access unit including the current picture are RAP pictures. As another example, the value 1 of the cross_layer_irap_aligned_flag may indicate that all pictures included in the access unit including the current picture are IDR pictures.

According to an embodiment, when the cross_layer_irap_aligned_flag has the value 1, the poc_msb_reset_flag may have the value 0. In addition, when the cross_layer_irap_aligned_flag is not signaled, the value of the poc_msb_reset_flag may be inferred to 0.

The poc_reset_flag may indicate whether to reset the POC value of the current picture to 0. For example, when the poc_reset_flag has the value 1, the POC value of the current picture may be reset to 0. As another example, when the poc_reset_flag has the value 0, the POC value of the current picture may be or may not be 0.

FIG. 7C shows an example of syntax for describing reset information, according to an embodiment.

Values may be signaled by using a bitstream. For example, a poc_reset_idc may be signaled by using a slice header.

In conditional syntax 1776, whether to parse the poc_reset_idc may be determined. According to an embodiment, the reset information may be named as poc_reset_idc and may have one of the values 0, 1, 2, and 3. According to an embodiment, with regard to operation of the reset information of a current picture, when the value of the reset information is 0, the reset information may indicate not to reset both a higher bit and a lower bit of a POC of the current picture. As another example, when the value of the reset information is 1, the reset information may indicate to reset the higher bit of the POC of the current picture and not to reset the lower bit thereof. As another example, when the value of the reset information is 2, the reset information may indicate to reset the higher bit and the lower bit of the POC of the current picture. As another example, when the value of the reset information is 3, the reset information may indicate to reset the higher bit of the POC of the current picture and not to reset the lower bit thereof, or indicate to reset the higher bit and the lower bit of the POC of the current picture.

In conditional syntax 1777, whether to parse a poc_reset_period_id may be determined. For example, when the value of the poc_reset_idc is not 0, the poc_reset_period_id may be parsed. The poc_reset_period_id may indicate a period in which the POC value is reset.

In conditional syntax 1778, when the value of the poc_reset_idc is 3, a full_poc_reset_flag and a poc_lsb_val may be parsed. According to an embodiment, the reset information may be named as full_poc_reset_flag and may have one of the values 0 and 1. According to an embodiment, with regard to operation of the reset information of the current picture, when the value of the full_poc_reset_flag is 0, the reset information may indicate not to reset both the higher bit and the lower bit of the POC of the current picture. As another example, when the value of the full_poc_reset_flag is 1, the reset information may indicate to reset both the higher bit and the lower bit of the POC of the current picture. According to an embodiment, the poc_lsb_val may indicate the lower bit of the POC of the current picture.

FIG. 7D shows an example of syntax for describing signaling of a lower bit of a POC, according to an embodiment.

In conditional syntax 1779, when a current picture is included in an enhancement layer or when the current picture is not an IDR picture, a slice_pic_order_cnt_lsb may be parsed. According to an embodiment, the slice_pic_order_cnt_lsb may be signaled by using a slice header. The slice_pic_order_cnt_lsb may indicate a lower bit of a POC of the current picture.

FIG. 7E shows an example of syntax for describing signaling of a lower bit of a POC, according to an embodiment.

In conditional syntax 1780, when a current picture is included in an enhancement layer or when the current picture is not an IDR picture, a slice_pic_order_cnt_lsb may be parsed. According to an embodiment, the slice_pic_order_cnt_lsb may be signaled by using a slice header. The slice_pic_order_cnt_lsb may indicate a lower bit of a POC of the current picture.

The multilayer video encoding apparatus 10 illustrated in FIG. 1A may perform intra-prediction, inter-prediction, interlayer prediction, transformation, and quantization per image block to generate samples, and may perform entropy encoding on the samples to output the same in the form of a bitstream. To output a video encoding result of the multilayer video encoding apparatus 10 according to an embodiment, i.e., a base layer video stream and an enhancement layer video stream, the multilayer video encoding apparatus 10 may perform video encoding operations including transformation and quantization in association with an internal or external video encoding processor. The internal video encoding processor of the multilayer video encoding apparatus 10 according to an embodiment may be a separate processor. Alternatively, a video encoding unit, a central processing unit, or a graphic processing unit may include a video encoding module to perform basic video encoding operations.

The multilayer video decoding apparatus 20 illustrated in FIG. 2A decodes each of the received base layer video stream and the enhancement layer video stream. That is, the multilayer video decoding apparatus 20 may perform inverse quantization, inverse transformation, intra-prediction, and motion compensation (motion compensation between pictures and interlayer variation compensation) per image block on each of the base layer video stream and the enhancement layer video stream to reconstruct samples of base layer pictures from the base layer video stream and reconstruct samples of enhancement layer pictures from the enhancement layer video stream. To output reconstructed pictures generated as a result of decoding, the multilayer video decoding apparatus 20 according to an embodiment may perform video reconstruction operations including inverse quantization, inverse transformation, and prediction/compensation in association with an internal or external video decoding processor. The internal video decoding processor of the multilayer video decoding apparatus 20 according to an embodiment may be a separate processor. Alternatively, a video decoding unit, a central processing unit, or a graphic processing unit may include a video decoding module to perform basic video reconstruction operations.

In the multilayer video encoding apparatus 10 according to an embodiment and the multilayer video decoding apparatus 20 according to an embodiment, as described above, blocks split from video data may be split into coding units having a tree structure, and coding units, prediction units, and transformation units may be used for interlayer prediction or inter-prediction of the coding units. A video encoding method and apparatus, and a video decoding method and apparatus based on coding units and transformation units having a tree structure according to embodiments are now described with reference to FIGS. 8 to 20.

Basically, in a multilayer video encoding/decoding procedure, a procedure for encoding/decoding base layer pictures and a procedure for encoding/decoding enhancement layer pictures are performed separately. That is, when interlayer prediction of the multilayer video occurs, single layer video encoding/decoding results may refer to each other but an individual encoding/decoding procedure is performed per single layer video.

Thus, for convenience of explanation, a video encoding procedure and a video decoding procedure to be described below with reference to FIGS. 8 to 20 based on coding units having a tree structure are encoding and decoding procedures of a single layer video, and thus inter-prediction and motion compensation are described. However, as described above in relation to FIGS. 1A to 7E, to encode/decode a multilayer video, interlayer prediction and compensation are performed between base layer pictures and enhancement layer pictures.

Accordingly, to encode a multilayer video based on coding units having a tree structure, the multilayer video encoding apparatus 10 according to an embodiment may include a plurality of video encoding apparatuses 100 (see FIG. 8) corresponding to the number of layers of the multilayer video to encode every single layer video, and may control each video encoding apparatus 100 to encode a single layer video corresponding thereto. In addition, the multilayer video encoding apparatus 10 may perform interlayer prediction by using individual single layer encoding results of the video encoding apparatuses 100. As such, the multilayer video encoding apparatus 10 may generate a base layer video stream and an enhancement layer video stream by using the individual layer encoding results.

Similarly, to decode a multilayer video based on coding units having a tree structure, the multilayer video decoding apparatus 20 according to an embodiment may include a plurality of video decoding apparatuses 200 (see FIG. 9) corresponding to the number of layers of the multilayer video to decode every single layer video, and may control each video decoding apparatus 200 to decode a single layer video corresponding thereto. In addition, the multilayer video decoding apparatus 20 may perform interlayer compensation by using individual single layer decoding results of the video decoding apparatuses 200. As such, the multilayer video decoding apparatus 20 may generate reconstructed base layer pictures and reconstructed enhancement layer pictures by using the individual layer decoding results.

FIG. 8 is a block diagram of a video encoding apparatus based on coding units according to a tree structure 100, according to one or more embodiments.

The video encoding apparatus involving video prediction based on coding units according to a tree structure 100 includes a coding unit determiner 120, and an outputter 130. Hereinafter, for convenience of description, the video encoding apparatus involving video prediction based on coding units according to a tree structure 100 is referred to as ‘the video encoding apparatus 100’.

The coding unit determiner 120 may split a current picture based on a largest coding unit that is a coding unit having a maximum size for a current picture of an image. If the current picture is larger than the largest coding unit, image data of the current picture may be split into the at least one largest coding unit. The largest coding unit according to an embodiment may be a data unit having a size of 32×32, 64×64, 128×128, 256×256, etc., wherein a shape of the data unit is a square having a width and length in squares of 2.

A coding unit according to an embodiment may be characterized by a maximum size and a depth. The depth denotes the number of times the coding unit is spatially split from the largest coding unit, and as the depth deepens, deeper coding units according to depths may be split from the largest coding unit to a smallest coding unit. A depth of the largest coding unit may be an uppermost depth and the smallest coding unit may be defined as a lowermost coding unit. Since a size of a coding unit corresponding to each depth decreases as the depth of the largest coding unit deepens, a coding unit corresponding to an upper depth may include a plurality of coding units corresponding to lower depths.

As described above, the image data of the current picture is split into the largest coding units according to a maximum size of the coding unit, and each of the largest coding units may include deeper coding units that are split according to depths. Since the largest coding unit according to an embodiment is split according to depths, the image data of the spatial domain included in the largest coding unit may be hierarchically classified according to depths.

A maximum depth and a maximum size of a coding unit, which limit the total number of times a height and a width of the largest coding unit are hierarchically split, may be predetermined.

The coding unit determiner 120 encodes at least one split region obtained by splitting a region of the largest coding unit according to depths, and determines a depth to output a finally encoded image data according to the at least one split region. In other words, the coding unit determiner 120 determines a depth by encoding the image data in the deeper coding units according to depths, according to the largest coding unit of the current picture, and selecting the depth having the least encoding error. The determined depth and the image data of the largest coding unit are output to the outputter 130.

The image data in the largest coding unit is encoded based on the deeper coding units corresponding to at least one depth equal to or below the maximum depth, and encoding results based on each of the deeper coding units are compared. A depth having the least encoding error may be selected after comparing encoding errors of the deeper coding units. At least one depth may be selected for each largest coding unit.

The size of the largest coding unit is split as a coding unit is hierarchically split according to depths, and as the number of coding units increases. Also, even if coding units correspond to the same depth in one largest coding unit, it is determined whether to split each of the coding units corresponding to the same depth to a lower depth by measuring an encoding error of the image data of the each coding unit, separately. Accordingly, even when image data is included in one largest coding unit, the encoding errors may differ according to regions in the one largest coding unit, and thus the depths may differ according to regions in the image data. Thus, one or more depths may be determined in one largest coding unit, and the image data of the largest coding unit may be divided according to coding units of at least one depth.

Accordingly, the coding unit determiner 120 according to an embodiment may determine coding units having a tree structure included in the largest coding unit. The ‘coding units having a tree structure’ according to an embodiment include coding units corresponding to a depth determined to be the depth, from among all deeper coding units included in the current largest coding unit. A coding unit of a depth may be hierarchically determined according to depths in the same region of the largest coding unit, and may be independently determined in different regions. Similarly, a depth in a current region may be independently determined from a depth in another region.

A maximum depth according to an embodiment is an index related to the number of splitting times from a largest coding unit to a smallest coding unit. A first maximum depth according to an embodiment may denote the total number of splitting times from the largest coding unit to the smallest coding unit. A second maximum depth according to an embodiment may denote the total number of depth levels from the largest coding unit to the smallest coding unit. For example, when a depth of the largest coding unit is 0, a depth of a coding unit, in which the largest coding unit is split once, may be set to 1, and a depth of a coding unit, in which the largest coding unit is split twice, may be set to 2. Here, if the smallest coding unit is a coding unit in which the largest coding unit is split four times, 5 depth levels of depths 0, 1, 2, 3, and 4 exist, and thus the first maximum depth may be set to 4, and the second maximum depth may be set to 5.

Prediction encoding and transformation may be performed according to the largest coding unit. The prediction encoding and the transformation are also performed based on the deeper coding units according to a depth equal to or depths less than the maximum depth, according to the largest coding unit.

Since the number of deeper coding units increases whenever the largest coding unit is split according to depths, encoding, including the prediction encoding and the transformation, has to be performed on all of the deeper coding units generated as the depth deepens. Hereinafter, for convenience of description, the prediction encoding and the transformation will now be described based on a coding unit of a current depth, in at least one largest coding unit.

The video encoding apparatus 100 may variously select a size or shape of a data unit for encoding the image data. In order to encode the image data, operations, such as prediction encoding, transformation, and entropy encoding, are performed, and at this time, the same data unit may be used for all operations or different data units may be used for each operation.

For example, the video encoding apparatus 100 may select not only a coding unit for encoding the image data, but also may select a data unit different from the coding unit so as to perform the prediction encoding on the image data in the coding unit.

In order to perform prediction encoding in the largest coding unit, the prediction encoding may be performed based on a coding unit corresponding to a depth, i.e., based on a coding unit that is no longer split to coding units corresponding to a lower depth. Hereinafter, the coding unit that is no longer split and becomes a basis unit for prediction encoding will now be referred to as a ‘prediction unit’. A partition obtained by splitting the prediction unit may include a prediction unit and a data unit obtained by splitting at least one selected from a height and a width of the prediction unit. A partition is a data unit where a prediction unit of a coding unit is split, and a prediction unit may be a partition having the same size as a coding unit.

For example, when a coding unit of 2N×2N (where N is a positive integer) is no longer split and becomes a prediction unit of 2N×2N, a size of a partition may be 2N×2N, 2N×N, N×2N, or N×N. Examples of a partition mode may selectively include symmetrical partitions that are obtained by symmetrically splitting a height or width of the prediction unit, partitions obtained by asymmetrically splitting the height or width of the prediction unit, such as 1:n or n:1, partitions that are obtained by geometrically splitting the prediction unit, and partitions having arbitrary shapes.

A prediction mode of the prediction unit may be at least one of an intra mode, a inter mode, and a skip mode. For example, the intra mode and the inter mode may be performed on the partition of 2N×2N, 2N×N, N×2N, and N×N. Also, the skip mode may be performed only on the partition of 2N×2N. The encoding is independently performed on one prediction unit in a coding unit, thereby selecting a prediction mode having a least encoding error.

Also, the video encoding apparatus 100 may also perform the transformation on the image data in a coding unit based not only on the coding unit for encoding the image data, but also based on a data unit that is different from the coding unit. In order to perform the transformation in the coding unit, the transformation may be performed based on a data unit having a size smaller than or equal to the coding unit. For example, the data unit for the transformation may include a data unit for an intra mode and a data unit for an inter mode.

The transformation unit in the coding unit may be recursively split into smaller sized regions in the similar manner as the coding unit according to the tree structure. Thus, residual image data in the coding unit may be divided according to the transformation unit having the tree structure according to transformation depths.

A transformation depth indicating the number of splitting times to reach the transformation unit by splitting the height and width of the coding unit may also be set in the transformation unit. For example, in a current coding unit of 2N×2N, a transformation depth may be 0 when the size of a transformation unit is 2N×2N, may be 1 when the size of the transformation unit is N×N, and may be 2 when the size of the transformation unit is N/2×N/2. In other words, the transformation unit having the tree structure may be set according to the transformation depths.

Encoding information according to coding units corresponding to a depth requires not only information about the depth, but also requires information related to prediction encoding and transformation. Accordingly, the coding unit determiner 120 may determine not only a depth having a least encoding error, but may also determine a partition mode in a prediction unit, a prediction mode according to prediction units, and a size of a transformation unit for transformation.

Coding units according to a tree structure in a largest coding unit and methods of determining a prediction unit/partition, and a transformation unit, according to an embodiment, will be described in detail below with reference to FIGS. 9 through 19.

The coding unit determiner 120 may measure an encoding error of deeper coding units according to depths by using Rate-Distortion Optimization based on Lagrangian multipliers.

The outputter 130 outputs the image data of the largest coding unit, which is encoded based on the at least one depth determined by the coding unit determiner 120, and information about the encoding mode according to the depth, in bitstreams.

The encoded image data may be obtained by encoding residual image data of an image.

The information about the encoding mode according to depth may include information about the depth, about the partition mode in the prediction unit, the prediction mode, the size of the transformation unit, or the like.

The information about the depth may be defined by using split information according to depths, which indicates whether encoding is performed on coding units of a lower depth instead of a current depth. If the current depth of the current coding unit is the depth, the current coding unit is encoded to a coding unit of the current depth, thus, the split information of the current depth may be defined not to be split to a lower depth. On the other hand, if the current depth of the current coding unit is not the depth, the encoding using the coding unit of the lower depth has to be performed, thus, the split information of the current depth may be defined to be split to the coding units of the lower depth.

If the current depth is not the depth, encoding is performed on the coding unit that is split into the coding units of the lower depth. Since one or more coding units of the lower depth exist in one coding unit of the current depth, the encoding is repeatedly performed on each of the coding units of the lower depth, and thus the encoding may be recursively performed on the coding units having the same depth.

Since the coding units having a tree structure are determined for one largest coding unit, and at least one piece of split information has to be determined for a coding unit of a depth, at least one piece of split information may be determined for one largest coding unit. Also, data of the largest coding unit may be different according to locations since the data is hierarchically split according to depths, and thus a depth and split information may be set for the data.

Accordingly, the outputter 130 according to an embodiment may assign encoding information about a corresponding depth and encoding mode to at least one of the coding unit, the prediction unit, and a minimum unit included in the largest coding unit.

The minimum unit according to an embodiment is a square data unit obtained by splitting the smallest coding unit constituting the lowermost depth by 4. The minimum unit according to an embodiment may be a maximum square data unit that may be included in all of the coding units, prediction units, partition units, and transformation units included in the largest coding unit.

For example, the encoding information output from the outputter 130 may be classified into encoding information according to deeper coding units, and encoding information according to prediction units. The encoding information according to the deeper coding units may include the information about the prediction mode and about the size of the partitions. The encoding information according to the prediction units may include information about an estimated direction of an inter mode, about a reference image index of the inter mode, about a motion vector, about a chroma component of an intra mode, and about an interpolation method of the intra mode.

Information about a maximum size of the coding unit defined according to pictures, slices, or GOPs, and information about a maximum depth may be inserted into a header of a bitstream, a sequence parameter set, or a picture parameter set.

Also, information about a maximum size of the transformation unit permitted with respect to a current video, and information about a minimum size of the transformation unit may be output through a header of a bitstream, a sequence parameter set, or a picture parameter set. The outputter 130 may encode and output reference information, prediction information, and slice type information that are related to prediction.

According to the simplest embodiment for the video encoding apparatus 100, the deeper coding unit may be a coding unit obtained by dividing a height and width of a coding unit of an upper depth, which is one layer above, by two. In other words, when the size of the coding unit of the current depth is 2N×2N, the size of the coding unit of the lower depth is N×N. Also, a current coding unit having a size of 2N×2N may maximally include four lower-depth coding units having a size of N×N.

Accordingly, the video encoding apparatus 100 may form the coding units having the tree structure by determining coding units having an optimum shape and an optimum size for each largest coding unit, based on the size of the largest coding unit and the maximum depth determined considering characteristics of the current picture. Also, since encoding may be performed on each largest coding unit by using any one of various prediction modes and transformations, an optimum encoding mode may be determined considering characteristics of the coding unit of various image sizes.

Thus, if an image having a high resolution or a large data amount is encoded in a conventional macroblock, the number of macroblocks per picture excessively increases. Accordingly, the number of pieces of compressed information generated for each macroblock increases, and thus it is difficult to transmit the compressed information and data compression efficiency decreases. However, since the video encoding apparatus 100 according to an embodiment may adjust a coding unit while considering characteristics of an image while increasing a maximum size of the coding unit by considering a size of the image, image compression efficiency may be increased.

The multilayer video encoding apparatus 10 described above in relation to FIG. 1A may include a plurality of video encoding apparatuses 100 corresponding to the number of layers of a multilayer video to encode pictures of every single layer.

When the video encoding apparatuses 100 encode first layer images, the coding unit determiner 120 may determine a prediction unit for inter-image prediction for each of coding units of a tree structure according to each largest coding unit, and may perform the inter-image prediction on each prediction unit.

When the video encoding apparatuses 100 encode second layer images, the coding unit determiner 120 may determine prediction units and coding units of a tree structure according to each largest coding unit, and may perform inter-prediction on each of the prediction units.

The video encoding apparatus 100 may encode an illumination difference so as to compensate for the illumination difference between a first layer image and a second layer image. However, whether to perform illumination compensation may be determined according to an encoding mode of a coding unit. For example, illumination compensation may be performed only on a prediction unit having a size of 2N×2N.

FIG. 9 is a block diagram of a video decoding apparatus based on coding units of a tree structure 200, according to various embodiments.

The video decoding apparatus involving video prediction based on coding units of the tree structure 200 includes a receiver 210, an image data and encoding information extractor 220, and an image data decoder 230. Hereinafter, for convenience of description, the video decoding apparatus involving video prediction based on coding units of the tree structure 200 is referred to as the ‘video decoding apparatus 200’.

Definitions of various terms, such as a coding unit, a depth, a prediction unit, a transformation unit, and information about various encoding modes, for decoding operations of the video decoding apparatus 200 are identical to those described with reference to FIG. 8 and the video encoding apparatus 100.

The receiver 210 receives and parses a bitstream of an encoded video. The image data and encoding information extractor 220 extracts encoded image data for each coding unit from the parsed bitstream, wherein the coding units have a tree structure according to each largest coding unit, and outputs the extracted image data to the image data decoder 230. The image data and encoding information extractor 220 may extract information about a maximum size of a coding unit of a current picture, from a header about the current picture, a sequence parameter set, or a picture parameter set.

Also, the image data and encoding information extractor 220 extracts a depth and split information for the coding units having a tree structure according to each largest coding unit, from the parsed bitstream. The extracted depth and the extracted split information are output to the image data decoder 230. In other words, the image data in a bit stream is split into the largest coding unit so that the image data decoder 230 may decode the image data for each largest coding unit.

The depth and the split information according to each largest coding unit may be set for at least one piece of depth information, and split information according to depths may include information about a partition mode and a prediction mode of a corresponding coding unit, and split information of a transformation unit. Also, split information according to depths may be extracted as the depth information.

The depth and the split information according to each largest coding unit extracted by the image data and encoding information extractor 220 are a depth and split information that are determined to generate a minimum encoding error when an encoder, such as the video encoding apparatus 100, repeatedly performs encoding for each deeper coding unit according to depths according to each largest coding unit. Accordingly, the video decoding apparatus 200 may reconstruct an image by decoding the data according to an encoding mode that generates the minimum encoding error.

Since encoding information about the depth and the encoding mode may be assigned to a predetermined data unit from among a corresponding coding unit, a prediction unit, and a minimum unit, the image data and encoding information extractor 220 may extract the depth and the split information according to each largest coding unit according to each of the predetermined data units. If a depth and split information of corresponding largest coding unit are recorded according to predetermined data units, the predetermined data units to which the same depth and split information are assigned may be inferred to be the data units included in the same largest coding unit.

The image data decoder 230 reconstructs the current picture by decoding the image data in each largest coding unit based on the depth and the split information according to largest coding units. In other words, the image data decoder 230 may decode the encoded image data based on the extracted information about the partition mode, the prediction mode, and the transformation unit for each coding unit from among the coding units having the tree structure included in each largest coding unit. A decoding process may include a prediction including intra prediction and motion compensation, and an inverse transformation.

The image data decoder 230 may perform intra prediction or motion compensation according to a partition mode and a prediction mode of each coding unit, based on the information about the partition mode and the prediction mode of the prediction unit of the coding unit according to depths.

In addition, the image data decoder 230 may read information about a transformation unit according to a tree structure for each coding unit so as to perform inverse transformation based on transformation units for each coding unit, for inverse transformation for each largest coding unit. Due to the inverse transformation, a pixel value of a spatial domain of the coding unit may be reconstructed.

The image data decoder 230 may determine a depth of a current largest coding unit by using split information according to depths. If the split information indicates that image data is no longer split in the current depth, the current depth is the depth. Accordingly, the image data decoder 230 may decode encoded data in the current largest coding unit by using the information about the partition mode and the prediction mode of the prediction unit, and the size of the transformation unit for each coding unit corresponding to the current depth.

In other words, data units containing the encoding information including the same split information may be gathered by observing the encoding information set assigned for the predetermined data unit from among the coding unit, the prediction unit, and the minimum unit, and the gathered data units may be considered to be one data unit to be decoded by the image data decoder 230 in the same encoding mode. As such, the current coding unit may be decoded by obtaining the information about the encoding mode for each coding unit.

The multilayer video decoding apparatus 20 described above in relation to FIG. 2A may include a plurality of video encoding apparatuses 100 corresponding to the number of layers of a multilayer video to reconstruct first layer pictures and second layer pictures by decoding a received first layer video stream and a second layer video stream.

When the first layer image stream is received, the image data decoder 230 of the video decoding apparatus 200 may split samples of the first layer images, which are extracted from the first layer image stream by an extractor 220, into coding units according to a tree structure of a largest coding unit. The image data decoder 230 may perform motion compensation, based on prediction units for the inter-image prediction, on each of the coding units according to the tree structure of the samples of the first layer images, and may reconstruct the first layer images.

When the second layer image stream is received, the image data decoder 230 of the video decoding apparatus 200 may split samples of the second layer images, which are extracted from the second layer image stream by the extractor 220, into coding units according to a tree structure of a largest coding unit. The image data decoder 230 may perform motion compensation, based on prediction units for the inter-image prediction, on each of the coding units of the samples of the second layer images, and may reconstruct the second layer images.

The extractor 220 may obtain, from a bitstream, information related to an illumination difference so as to compensate for the illumination difference between the first layer image and the second layer image. However, whether to perform illumination compensation may be determined according to an encoding mode of a coding unit. For example, illumination compensation may be performed only on a prediction unit having a size of 2N×2N.

Thus, the video decoding apparatus 200 may obtain information about at least one coding unit that generates the minimum encoding error when encoding is recursively performed for each largest coding unit, and may use the information to decode the current picture. In other words, the coding units having the tree structure determined to be the optimum coding units in each largest coding unit may be decoded.

Accordingly, even if an image has high resolution or has an excessively large data amount, the image data may be efficiently decoded and reconstructed by using a size of a coding unit and an encoding mode, which are adaptively determined according to characteristics of the image, by using optimum split information received from an encoder.

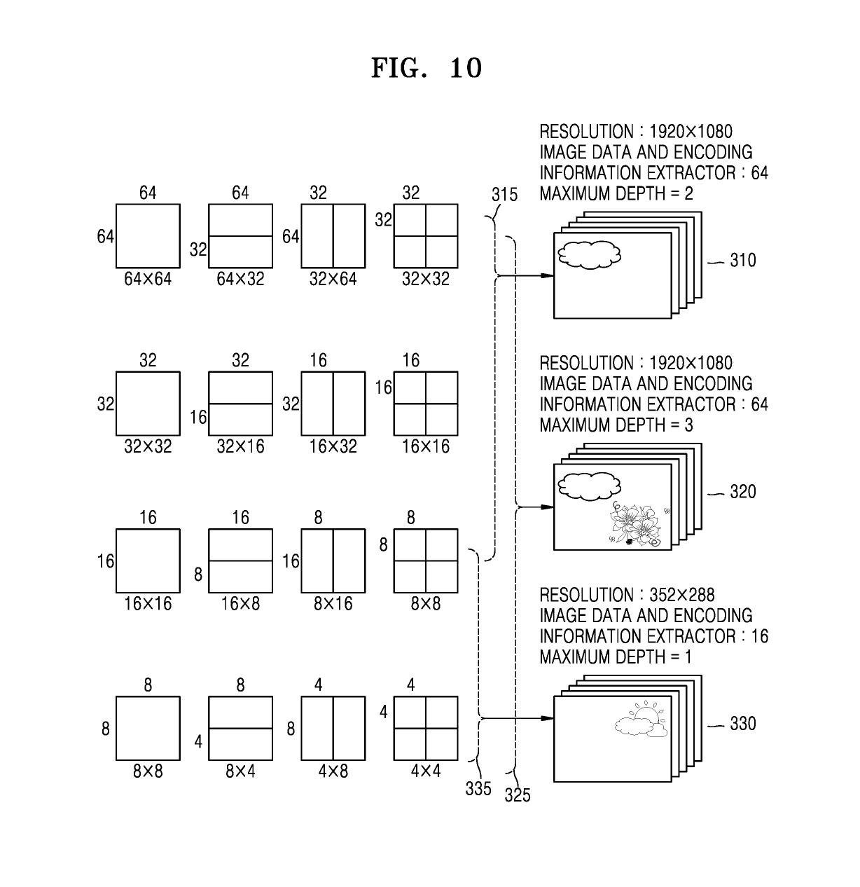

FIG. 10 is a diagram for describing a concept of coding units, according to exemplary embodiments.

A size of a coding unit may be expressed by width×height, and may be 64×64, 32×32, 16×16, and 8×8. A coding unit of 64×64 may be split into partitions of 64×64, 64×32, 32×64, or 32×32, and a coding unit of 32×32 may be split into partitions of 32×32, 32×16, 16×32, or 16×16, a coding unit of 16×16 may be split into partitions of 16×16, 16×8, 8×16, or 8×8, and a coding unit of 8×8 may be split into partitions of 8×8, 8×4, 4×8, or 4×4.

In video data 310, a resolution is 1920×1080, a maximum size of a coding unit is 64, and a maximum depth is 2. In video data 320, a resolution is 1920×1080, a maximum size of a coding unit is 64, and a maximum depth is 3. In video data 330, a resolution is 352×288, a maximum size of a coding unit is 16, and a maximum depth is 1. The maximum depth shown in FIG. 10 denotes a total number of splits from a largest coding unit to a smallest coding unit.

If a resolution is high or a data amount is large, a maximum size of a coding unit may be large so as to not only increase encoding efficiency but also to accurately reflect characteristics of an image. Accordingly, the maximum size of the coding unit of the video data 310 and 320 having a higher resolution than the video data 330 may be 64.

Since the maximum depth of the video data 310 is 2, coding units 315 of the vide data 310 may include a largest coding unit having a long axis size of 64, and coding units having long axis sizes of 32 and 16 since depths are deepened to two layers by splitting the largest coding unit twice. On the other hand, since the maximum depth of the video data 330 is 1, coding units 335 of the video data 330 may include a largest coding unit having a long axis size of 16, and coding units having a long axis size of 8 since depths are deepened to one layer by splitting the largest coding unit once.

Since the maximum depth of the video data 320 is 3, coding units 325 of the video data 320 may include a largest coding unit having a long axis size of 64, and coding units having long axis sizes of 32, 16, and 8 since the depths are deepened to 3 layers by splitting the largest coding unit three times. When a depth deepens, detailed information may be precisely expressed.

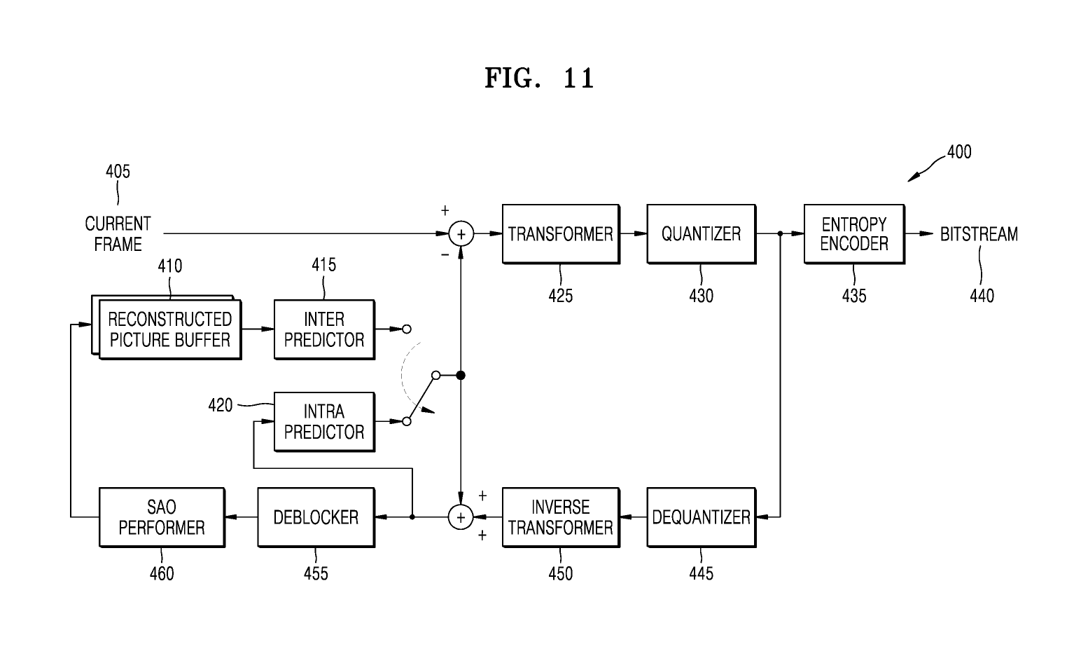

FIG. 11 is a block diagram of an image encoder 400 based on coding units, according to various embodiments.

The image encoder 400 according to an embodiment performs operations of the coding unit determiner 120 of the video encoding apparatus 100 so as to encode image data. In other words, an intra predictor 420 performs intra prediction on coding units in an intra mode, from among a current frame 405, and an inter predictor 415 performs inter prediction on coding units in an inter mode by using a current image 405 and a reference image obtained from a reconstructed picture buffer 410 according to prediction units. The current image 405 may be split into largest coding units and then the largest coding units may be sequentially encoded. In this regard, the largest coding units that are to be split into coding units having a tree structure may be encoded.

Residual image data is generated by subtracting prediction data regarding coding units of each mode that is output from the intra predictor 420 or the inter predictor 415 from data regarding encoded coding units of the current image 405, and is output as a quantized transformation coefficient according to transformation units through a transformer 425 and a quantizer 430. The quantized transformation coefficient is reconstructed as the residual image data in a spatial domain through a dequantizer 445 and an inverse transformer 450. The reconstructed residual image data in the spatial domain is added to prediction data for coding units of each mode that is output from the intra predictor 420 or the inter predictor 415 and thus is reconstructed as data in a spatial domain for coding units of the current image 405. The reconstructed data in the spatial domain is generated as reconstructed images through a de-blocker 455 and an SAO performer 460 and the reconstructed images are stored in the reconstructed picture buffer 410. The reconstructed images stored in the reconstructed picture buffer 410 may be used as reference images for inter prediction of another image. The transformation coefficient quantized by the transformer 425 and the quantizer 430 may be output as a bitstream 440 through an entropy encoder 435.

In order for the image encoder 400 to be applied in the video encoding apparatus 100, all elements of the image encoder 400, i.e., the inter predictor 415, the intra predictor 420, the transformer 425, the quantizer 430, the entropy encoder 435, the dequantizer 445, the inverse transformer 450, the de-blocker 455, and the SAO performer 460, may perform operations based on each coding unit among coding units having a tree structure according to each largest coding unit.

In particular, the intra predictor 420 and the inter predictor 415 may determine a partition mode and a prediction mode of each coding unit from among the coding units having a tree structure by taking into account the maximum size and the maximum depth of a current largest coding unit, and the transformer 425 may determine whether to split a transformation unit according to a quadtree in each coding unit from among the coding units having a tree structure.

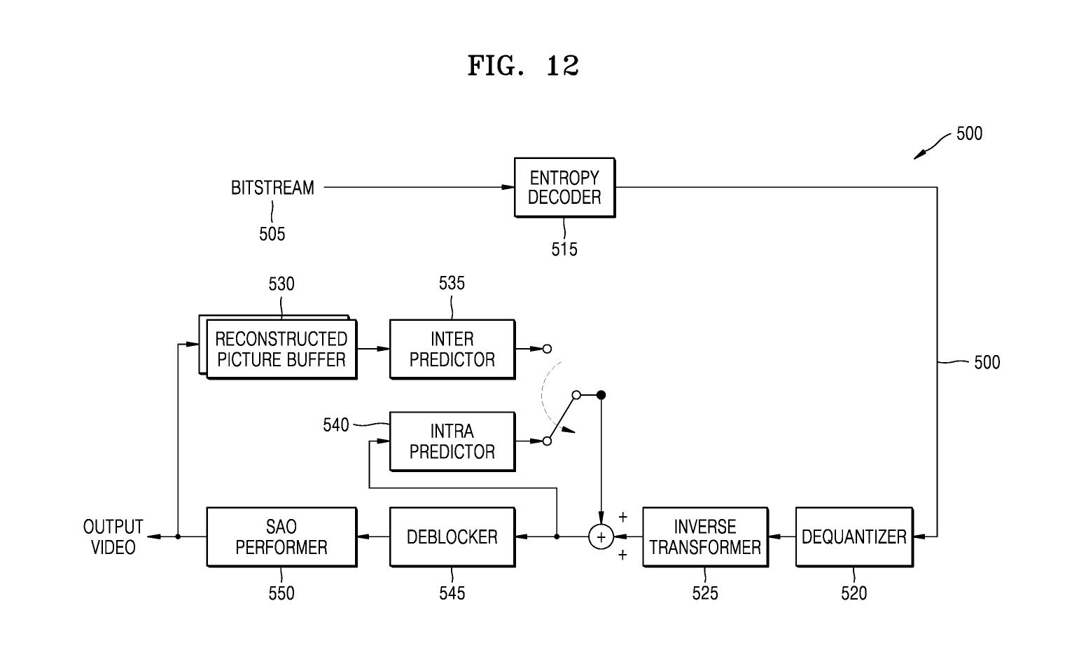

FIG. 12 is a block diagram of an image decoder 500 based on coding units, according to various embodiments.

An entropy decoder 515 parses, from a bitstream 505, encoded image data to be decoded and encoding information required for decoding. The encoded image data is as a quantized transformation unit, and an inverse quantizer 520 and an inverse transformer 525 reconstruct residual image data from the quantized transformation unit.

An intra predictor 540 performs intra prediction on a coding unit in an intra mode according to prediction units. An inter predictor 535 performs inter prediction by using a reference image with respect to a coding unit in an inter mode from among a current image, which is obtained by a reconstructed picture buffer 530 according to prediction units.

Prediction data and residual image data regarding coding units of each mode, which passed through the intra predictor 540 and the inter predictor 535, are summed, so that data in a spatial domain regarding coding units of the current image 405 may be reconstructed, and the reconstructed data in the spatial domain may be output as a reconstructed image 560 through a de-blocker 545 and an SAO performer 550. Reconstructed images stored in the reconstructed picture buffer 530 may be output as reference images.

In order for the image data decoder 230 of the video decoding apparatus 200 to decode the image data, operations after the entropy decoder 515 of the image decoder 500 according to an embodiment may be performed.

In order for the image decoder 500 to be applied in the video decoding apparatus 200 according to an embodiment, all elements of the image decoder 500, i.e., the entropy decoder 515, the dequantizer 520, the inverse transformer 525, the intra predictor 540, the inter predictor 535, the de-blocker 545, and the SAO performer 550 may perform operations based on coding units having a tree structure for each largest coding unit.

In particular, the intra predictor 540 and the inter predictor 535 may determine a partition mode and a prediction mode of each coding unit from among the coding units according to a tree structure, and the inverse transformer 525 may determine whether or not to split a transformation unit according to a quadtree in each coding unit.

The encoding operation of FIG. 10 and the decoding operation of FIG. 11 are described as a videostream encoding operation and a videostream decoding operation, respectively, in a single layer. Accordingly, if the encoder 12 of FIG. 1A encodes video streams of two or more layers, the image encoder 400 may be provided per layer. Similarly, if the decoder 24 of FIG. 2A decodes video streams of two or more layers, the image decoder 500 may be provided per layer.

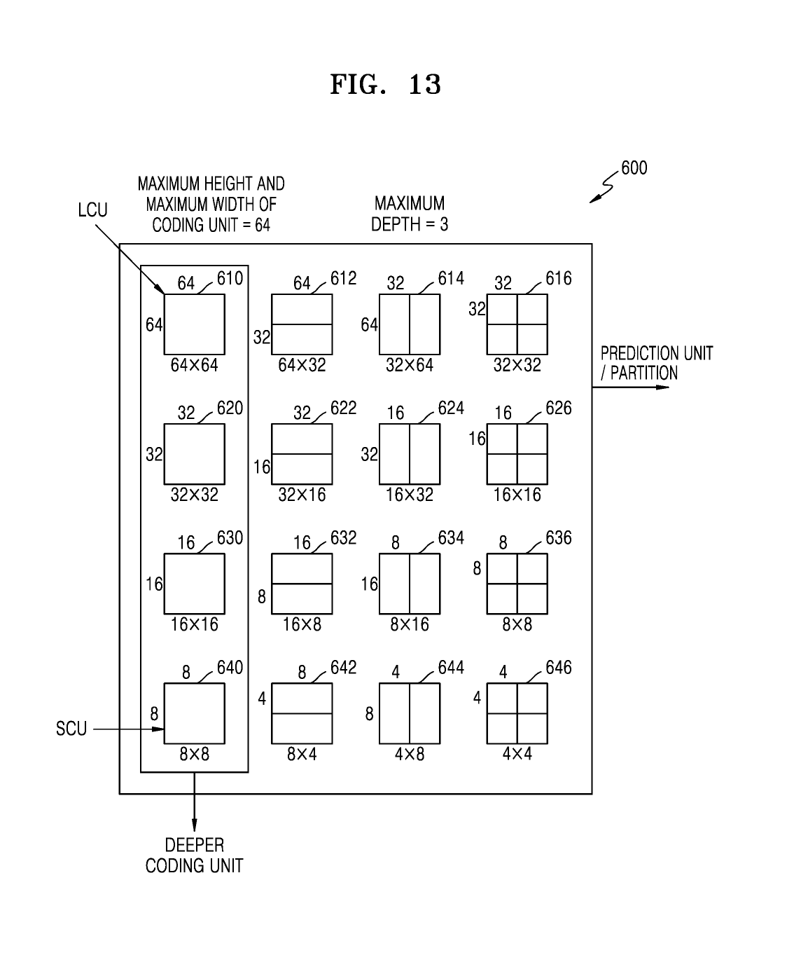

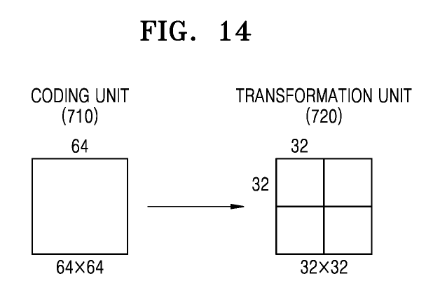

FIG. 13 is a diagram illustrating deeper coding units according to depths, and partitions, according to various embodiments.

The video encoding apparatus 100 according to an embodiment and the video decoding apparatus 200 according to an embodiment use hierarchical coding units so as to consider characteristics of an image. A maximum height, a maximum width, and a maximum depth of coding units may be adaptively determined according to the characteristics of the image, or may be variously set according to user requirements. Sizes of deeper coding units according to depths may be determined according to the predetermined maximum size of the coding unit.

In a hierarchical structure 600 of coding units, according to an embodiment, the maximum height and the maximum width of the coding units are each 64, and the maximum depth is 3. In this case, the maximum depth refers to a total number of times the coding unit is split from the largest coding unit to the smallest coding unit. Since a depth deepens along a vertical axis of the hierarchical structure 600, a height and a width of the deeper coding unit are each split. Also, a prediction unit and partitions, which are bases for prediction encoding of each deeper coding unit, are shown along a horizontal axis of the hierarchical structure 600.

That is, a coding unit 610 is a largest coding unit in the hierarchical structure 600, wherein a depth is 0 and a size, i.e., a height by width, is 64×64. The depth deepens along the vertical axis, and a coding unit 620 having a size of 32×32 and a depth of 1, a coding unit 630 having a size of 16×16 and a depth of 2, and a coding unit 640 having a size of 8×8 and a depth of 3. The coding unit 640 having the size of 8×8 and the depth of 3 is a minimum coding unit.

The prediction unit and the partitions of a coding unit are arranged along the horizontal axis according to each depth. In other words, if the coding unit 610 having a size of 64×64 and a depth of 0 is a prediction unit, the prediction unit may be split into partitions included in the coding unit 610 having the size of 64×64, i.e. a partition 610 having a size of 64×64, partitions 612 having the size of 64×32, partitions 614 having the size of 32×64, or partitions 616 having the size of 32×32.

Similarly, a prediction unit of the coding unit 620 having the size of 32×32 and the depth of 1 may be split into partitions included in the coding unit 620 having the size of 32×32, i.e. a partition 620 having a size of 32×32, partitions 622 having a size of 32×16, partitions 624 having a size of 16×32, and partitions 626 having a size of 16×16.

Similarly, a prediction unit of the coding unit 630 having the size of 16×16 and the depth of 2 may be split into partitions included in the coding unit 630 having the size of 16×16, i.e. a partition having a size of 16×16 included in the coding unit 630, partitions 632 having a size of 16×8, partitions 634 having a size of 8×16, and partitions 636 having a size of 8×8.

Similarly, a prediction unit of the coding unit 640 having the size of 8×8 and the depth of 3 may be split into partitions included in the coding unit 640 having the size of 8×8, i.e. a partition having a size of 8×8 included in the coding unit 640, partitions 642 having a size of 8×4, partitions 644 having a size of 4×8, and partitions 646 having a size of 4×4.

In order to determine the at least one final depth of the coding units constituting the largest coding unit 610, the coding unit determiner 120 of the video encoding apparatus 100 according to an embodiment has to perform encoding for coding units corresponding to each depth included in the largest coding unit 610.

The number of deeper coding units according to depths including data in the same range and the same size increases as the depth deepens. For example, four coding units corresponding to a depth of 2 are required to cover data that is included in one coding unit corresponding to a depth of 1. Accordingly, in order to compare encoding results of the same data according to depths, each of the coding unit corresponding to the depth of 1 and four coding units corresponding to the depth of 2 has to be encoded.

In order to perform encoding for a current depth from among the depths, a least encoding error that is a representative encoding error may be selected for the current depth by performing encoding for each prediction unit in the coding units corresponding to the current depth, along the horizontal axis of the hierarchical structure 600. In addition, the minimum encoding error may be searched for by comparing representative encoding errors according to depths, by performing encoding for each depth as the depth deepens along the vertical axis of the hierarchical structure 600. A depth and a partition having the minimum encoding error in the largest coding unit 610 may be selected as a depth and a partition mode of the largest coding unit 610.

FIG. 14 is a diagram illustrating a relationship between a coding unit 710 and transformation units 720, according to various embodiments.

The video encoding apparatus 100 according to an embodiment or the video decoding apparatus 200 according to an embodiment encodes or decodes an image according to coding units having sizes smaller than or equal to a largest coding unit for each largest coding unit. Sizes of transformation units for transformation during encoding may be selected based on data units that are not larger than a corresponding coding unit.

For example, in the video encoding apparatus 100 according to an embodiment or the video decoding apparatus 200 according to an embodiment, if a size of the current coding unit 710 is 64×64, transformation may be performed by using the transformation units 720 having a size of 32×32.

Also, data of the coding unit 710 having the size of 64×64 may be encoded by performing the transformation on each of the transformation units having the size of 32×32, 16×16, 8×8, and 4×4, which are smaller than 64×64, and then a transformation unit having the least coding error with respect to an original image may be selected.

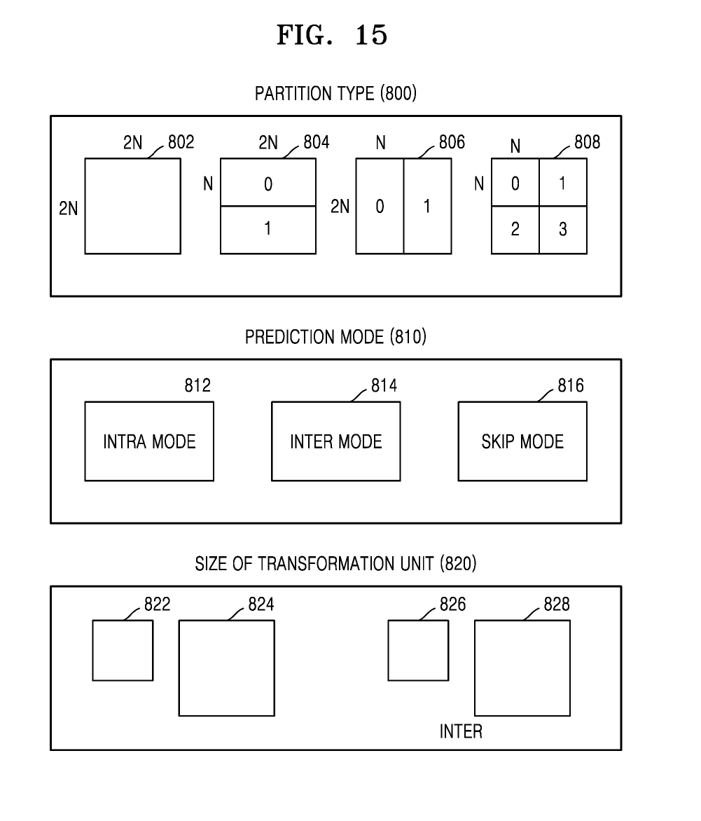

FIG. 15 illustrates a plurality of pieces of encoding information according to depths, according to various embodiments.

The outputter 130 of the video encoding apparatus 100 according to an embodiment may encode and transmit partition mode information 800, prediction mode information 810, and transformation unit size information 820 for each coding unit corresponding to a depth, as split information.

The partition mode information 800 indicates information about a shape of a partition obtained by splitting a prediction unit of a current coding unit, wherein the partition is a data unit for prediction encoding the current coding unit. For example, a current coding unit CU_0 having a size of 2N×2N may be split into any one of a partition 802 having a size of 2N×2N, a partition 804 having a size of 2N×N, a partition 806 having a size of N×2N, and a partition 808 having a size of N×N and may be used. Here, the partition mode information 800 is set to indicate one of the partition 802 having the size of 2N×2N, the partition 804 having a size of 2N×N, the partition 806 having a size of N×2N, and the partition 808 having a size of N×N.

The prediction mode information 810 indicates a prediction mode of each partition. For example, the prediction mode information 810 may indicate a mode of prediction encoding performed on a partition indicated by the partition mode information 800, i.e., an intra mode 812, an inter mode 814, or a skip mode 816.

In addition, the transformation unit size information 820 indicates a transformation unit to be based on when transformation is performed on a current coding unit. For example, the transformation unit may be a first intra transformation unit 822, a second intra transformation unit 824, a first inter transformation unit 826, or a second inter transformation unit 828.

The image data and encoding information extractor 210 of the video decoding apparatus 200 may extract and use the partition mode information 800, the prediction mode information 810, and the transformation unit size information 820 for decoding, according to each deeper coding unit.

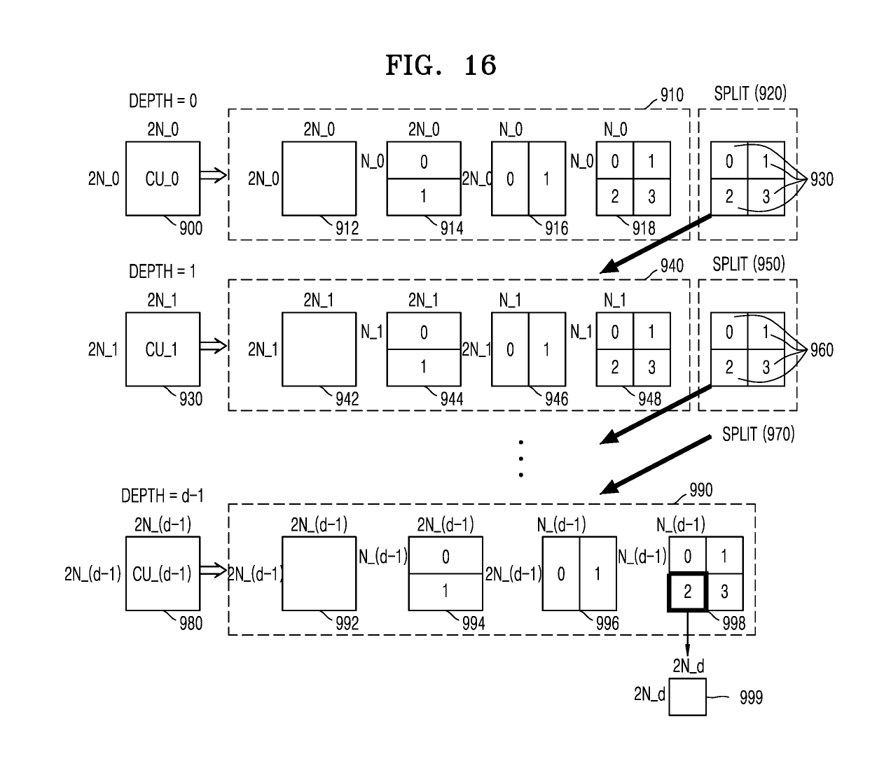

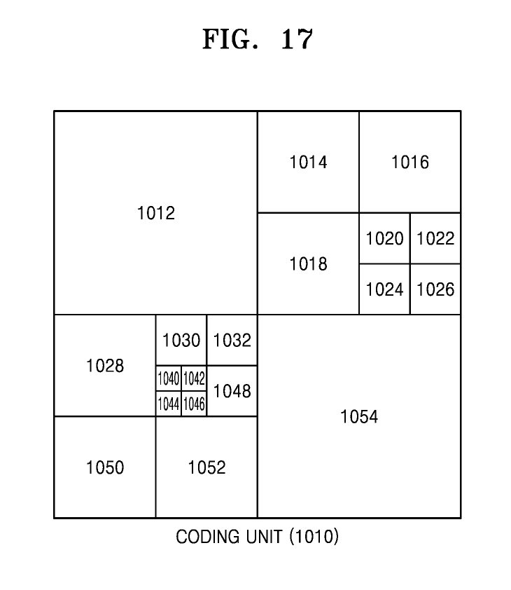

FIG. 16 is a diagram of deeper coding units according to depths, according to various embodiments.

Split information may be used to indicate a change of a depth. The split information indicates whether a coding unit of a current depth is split into coding units of a lower depth.

A prediction unit 910 for prediction encoding a coding unit 900 having a depth of 0 and a size of 2N_0×2N_0 may include partitions of a partition mode 912 having a size of 2N_0×2N_0, a partition mode 914 having a size of 2N_0×N_0, a partition mode 916 having a size of N_0×2N_0, and a partition mode 918 having a size of N_0×N_0. Although only the partition modes 912 through 918 which are obtained by symmetrically splitting the prediction unit 910 are illustrated, a partition mode is not limited thereto and may include asymmetrical partitions, partitions having a predetermined shape, and partitions having a geometrical shape.

Prediction encoding has to be repeatedly performed on one partition having a size of 2N_0×2N_0, two partitions having a size of 2N_0×N_0, two partitions having a size of N_0×2N_0, and four partitions having a size of N_0×N_0, according to each partition mode. The prediction encoding in an intra mode and an inter mode may be performed on the partitions having the sizes of 2N_0×2N_0, N_0×2N_0, 2N_0×N_0, and N_0×N_0. The prediction encoding in a skip mode may be performed only on the partition having the size of 2N_0×2N_0.

If an encoding error is smallest in one of the partition modes 912, 914, and 916 having the sizes of 2N_0×2N_0, 2N_0×N_0 and N_0×2N_0, the prediction unit 910 is not required to be split into a lower depth.

If the encoding error is the smallest in the partition mode 918 having the size of N_0×N_0, a depth is changed from 0 to 1 to split the partition mode 918 in operation 920, and encoding may be repeatedly performed on coding units 930 having a depth of 2 and a size of N_0×N_0 so as to search for a minimum encoding error.

A prediction unit 940 for prediction encoding the coding unit 930 having a depth of 1 and a size of 2N_1×2N_1 (=N_0×N_0) may include partitions of a partition mode 942 having a size of 2N_1×2N_1, a partition mode 944 having a size of 2N_1×N_1, a partition mode 946 having a size of N_1×2N_1, and a partition mode 948 having a size of N_1×N_1.

If an encoding error is the smallest in the partition mode 948 having the size of N_1×N_1, a depth may be changed from 1 to 2 to split the partition mode 948 (in operation 950), and encoding may be repeatedly performed on coding units 960, which have a depth of 2 and a size of N_2×N_2 so as to search for a minimum encoding error.

When a maximum depth is d, deeper coding units according to depths may be set until when a depth corresponds to d−1, and split information may be set until when a depth corresponds to d−2. In other words, when encoding is performed up to when the depth is d−1 after a coding unit corresponding to a depth of d−2 is split in operation 970, a prediction unit 990 for prediction encoding a coding unit 980 having a depth of d−1 and a size of 2N_(d−1)×2N_(d−1) may include partitions of a partition mode 992 having a size of 2N_(d−1)×2N_(d−1), a partition mode 994 having a size of 2N_(d−1)×N (d−1), a partition mode 996 having a size of N_(d−1)×2N_(d−1), and a partition mode 998 having a size of N_(d−1)×N (d−1).

Prediction encoding may be repeatedly performed on one partition having a size of 2N_(d−1)×2N_(d−1), two partitions having a size of 2N_(d−1)×N (d−1), two partitions having a size of N_(d−1)×2N_(d−1), four partitions having a size of N_(d−1)×N (d−1) from among the partition modes 992 through 998 so as to search for a partition mode having a minimum encoding error.

Even when the partition mode 998 having the size of N_(d−1)×N (d−1) has the minimum encoding error, since a maximum depth is d, a coding unit CU_(d−1) having a depth of d−1 is no longer split into a lower depth, and a depth for the coding units constituting a current largest coding unit 900 is determined to be d−1 and a partition mode of the current largest coding unit 900 may be determined to be N_(d−1)×N (d−1). Also, since the maximum depth is d, split information for the coding unit 952 having a depth of d−1 is not set.

A data unit 999 may be a ‘minimum unit’ for the current largest coding unit. A minimum unit according to the embodiment may be a square data unit obtained by splitting a minimum coding unit 980 having a lowermost depth by 4. By performing the encoding repeatedly, the video encoding apparatus 100 according to an embodiment may select a depth having the least encoding error by comparing encoding errors according to depths of the coding unit 900 to determine a depth, and set a corresponding partition mode and a prediction mode as an encoding mode of the depth.

As such, the minimum encoding errors according to depths are compared in all of the depths of 0, 1, . . . , d−1, d, and a depth having the least encoding error may be determined as a depth. The depth, the partition mode of the prediction unit, and the prediction mode may be encoded and transmitted as split information. Also, since a coding unit is split from a depth of 0 to a depth, only split information of the depth is set to ‘0’, and split information of depths excluding the depth is set to ‘1’.

The image data and encoding information extractor 220 of the video decoding apparatus 200 according to an embodiment may extract and use the information about the depth and the prediction unit of the coding unit 900 to decode the partition 912. The video decoding apparatus 200 according to an embodiment may determine a depth, in which split information is ‘0’, as a depth by using split information according to depths, and use split information of the corresponding depth for decoding.

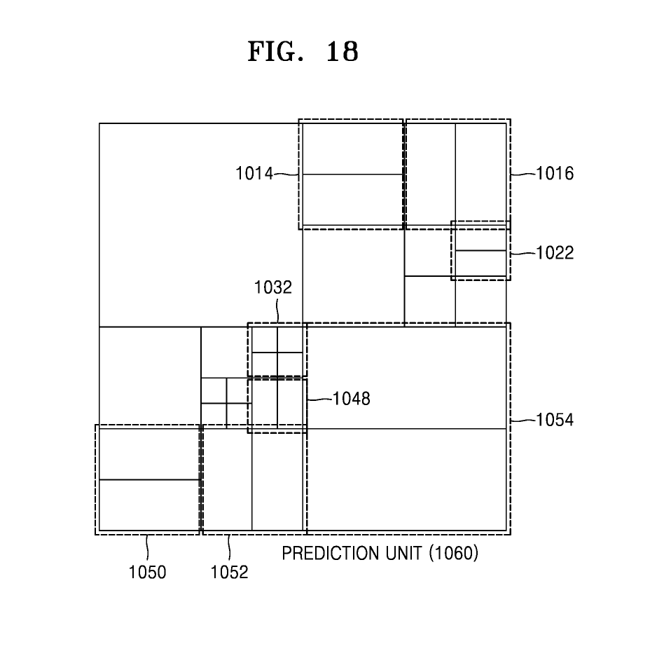

FIGS. 17, 18, and 19 are diagrams illustrating a relationship between coding units, prediction units, and transformation units, according to various embodiments.

Coding units 1010 are deeper coding units according to depths determined by the video encoding apparatus 100, in a largest coding unit. Prediction units 1060 are partitions of prediction units of each of the coding units 1010, and transformation units 1070 are transformation units of each of the coding units 1010.

When a depth of a largest coding unit is 0 in the coding units 1010, depths of coding units 1012 and 1054 are 1, depths of coding units 1014, 1016, 1018, 1028, 1050, and 1052 are 2, depths of coding units 1020, 1022, 1024, 1026, 1030, 1032, and 1048 are 3, and depths of coding units 1040, 1042, 1044, and 1046 are 4.

In the prediction units 1060, some encoders 1014, 1016, 1022, 1032, 1048, 1050, 1052, and 1054 are obtained by splitting the coding units in the encoders 1010. That is, partition modes in the coding units 1014, 1022, 1050, and 1054 have a size of 2N×N, partition modes in the coding units 1016, 1048, and 1052 have a size of N×2N, and a partition mode of the coding unit 1032 has a size of N×N. Prediction units and partitions of the coding units 1010 are smaller than or equal to each coding unit.

Transformation or inverse transformation is performed on image data of the coding unit 1052 in the transformation units 1070 in a data unit that is smaller than the coding unit 1052. Also, the coding units 1014, 1016, 1022, 1032, 1048, 1050, 1052, and 1054 in the transformation units 1070 are data units different from those in the prediction units 1060 in terms of sizes and shapes. That is, the video encoding apparatus 100 according to an embodiment and the video decoding apparatus 200 according to an embodiment may perform intra prediction/motion estimation/motion compensation/and transformation/inverse transformation on an individual data unit in the same coding unit.

Accordingly, encoding is recursively performed on each of coding units having a hierarchical structure in each region of a largest coding unit to determine an optimum coding unit, and thus coding units having a recursive tree structure may be obtained. Encoding information may include split information about a coding unit, information about a partition mode, information about a prediction mode, and information about a size of a transformation unit. Table 1 below shows the encoding information that may be set by the video encoding apparatus 100 according to an embodiment and the video decoding apparatus 200 according to an embodiment.

TABLE 1

| Split Information 0 (Encoding on Coding | | | | | |
|---|---|---|---|---|---|
| Unit having Size of 2Nx2N and Current Depth of d) | | | | | |
| | Partition | | Size of | | |
| | mode | | Transformation Unit | | |
| | Sym- | Asym- | Split | Split | |
| | met- | met- | Information | Information | |
| | rical | rical | 0 of Trans- | 1 of Trans- | Split |
| Prediction | Partition | Partition | formation | formation | Information |
| Mode | mode | mode | Unit | Unit | 1 |
| Intra | 2Nx2N | 2NxnU | 2Nx2N | NxN | Repeatedly |
| Inter | 2NxN | 2NxnD | | (Symmetrical | Encode |
| Skip | Nx2N | nLx2N | | Partition mode) | Coding |
| (Only | NxN | nRx2N | | N/2xN/2 | Units |
| 2Nx2N) | | | | (Asymmetrical | having |
| | | | | Partition mode) | Lower |
| | | | | | Depth |
| | | | | | of d + 1 |

The outputter 130 of the video encoding apparatus 100 according to an embodiment may output the encoding information about the coding units having a tree structure, and the image data and encoding information extractor 220 of the video decoding apparatus 200 according to an embodiment may extract the encoding information about the coding units having a tree structure from a received bitstream.

Split information specifies whether a current coding unit is split into coding units of a lower depth. If split information of a current depth d is 0, a depth, in which a current coding unit is no longer split into a lower depth, is a depth, and thus information about a partition mode, prediction mode, and a size of a transformation unit may be defined for the depth. If the current coding unit has to be further split according to the split information, encoding has to be independently performed on four split coding units of a lower depth.

A prediction mode may be one of an intra mode, an inter mode, and a skip mode. The intra mode and the inter mode may be defined in all partition modes, and the skip mode may be defined only in a partition mode having a size of 2N×2N.

The information about the partition mode may indicate symmetrical partition modes having sizes of 2N×2N, 2N×N, N×2N, and N×N, which are obtained by symmetrically splitting a height or a width of a prediction unit, and asymmetrical partition modes having sizes of 2N×nU, 2N×nD, nL×2N, and nR×2N, which are obtained by asymmetrically splitting the height or width of the prediction unit. The asymmetrical partition modes having the sizes of 2N×nU and 2N×nD may be respectively obtained by splitting the height of the prediction unit in 1:3 and 3:1, and the asymmetrical partition modes having the sizes of nL×2N and nR×2N may be respectively obtained by splitting the width of the prediction unit in 1:3 and 3:1.

The size of the transformation unit may be set to be two types in the intra mode and two types in the inter mode. In other words, if split information of the transformation unit is 0, the size of the transformation unit may be 2N×2N, which is the size of the current coding unit. If split information of the transformation unit is 1, the transformation units may be obtained by splitting the current coding unit. Also, if a partition mode of the current coding unit having the size of 2N×2N is a symmetrical partition mode, a size of a transformation unit may be N×N, and if the partition mode of the current coding unit is an asymmetrical partition mode, the size of the transformation unit may be N/2×N/2.

The encoding information about coding units having a tree structure according to an embodiment may be assigned to at least one of a coding unit corresponding to a depth, a prediction unit, and a minimum unit. The coding unit corresponding to the depth may include at least one of a prediction unit and a minimum unit containing the same encoding information.

Accordingly, it is determined whether adjacent data units are included in the same coding unit corresponding to the final depth by comparing encoding information of the adjacent data units. Also, a coding unit of a corresponding depth may be determined by using encoding information in a data unit, and thus a distribution of depths in a largest coding unit may be inferred.

Accordingly, if a current coding unit is predicted based on encoding information of adjacent data units, encoding information of data units in deeper coding units adjacent to the current coding unit may be directly referred to and used.

In another embodiment, if a current coding unit is predicted based on encoding information of adjacent data units, data units adjacent to the current coding unit may be searched by using encoded information of the data units, and the searched adjacent coding units may be referred for predicting the current coding unit.

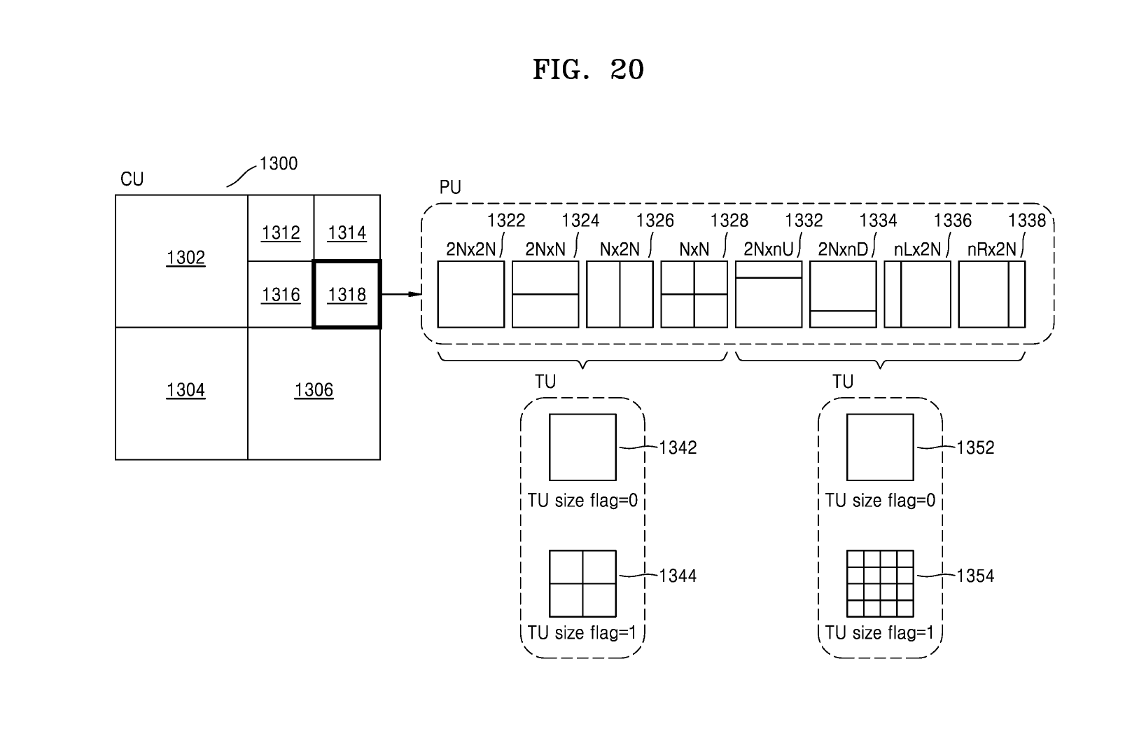

FIG. 20 is a diagram illustrating a relationship between a coding unit, a prediction unit, and a transformation unit, according to the encoding mode information of Table 1.

A largest coding unit 1300 includes coding units 1302, 1304, 1306, 1312, 1314, 1316, and 1318 of depths. Here, since the coding unit 1318 is a coding unit of a depth, split information may be set to 0. Information about a partition mode of the coding unit 1318 having a size of 2N×2N may be set to be one of partition modes including 2N×2N 1322, 2N×N 1324, N×2N 1326, N×N 1328, 2N×nU 1332, 2N×nD 1334, nL×2N 1336, and nR×2N 1338.

Transformation unit split information (TU size flag) is a type of a transformation index. A size of a transformation unit corresponding to the transformation index may be changed according to a prediction unit type or partition mode of the coding unit.

For example, when the information about the partition mode is set to be one of symmetrical partition modes 2N×2N 1322, 2N×N 1324, N×2N 1326, and N×N 1328, if the transformation unit split information is 0, a transformation unit 1342 having a size of 2N×2N is set, and if the transformation unit split information is 1, a transformation unit 1344 having a size of N×N may be set.

When the information about the partition mode is set to be one of asymmetrical partition modes 2N×nU 1332, 2N×nD 1334, nL×2N 1336, and nR×2N 1338, if the transformation unit split information (TU size flag) is 0, a transformation unit 1352 having a size of 2N×2N may be set, and if the transformation unit split information is 1, a transformation unit 1354 having a size of N/2×N/2 may be set.

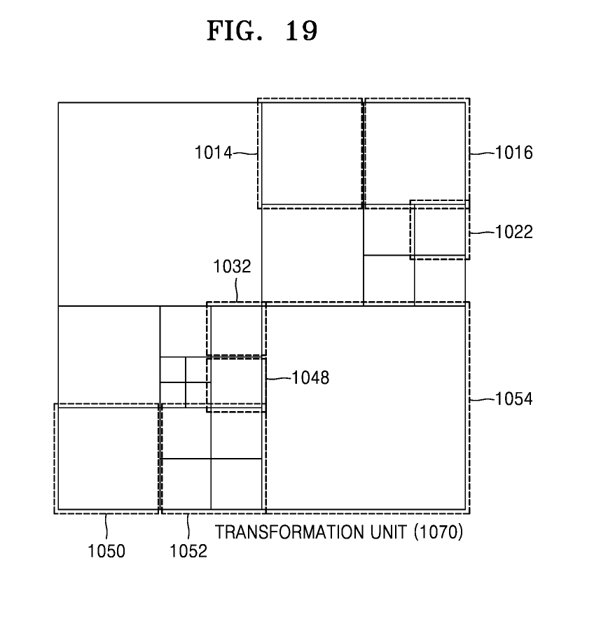

As described above with reference to FIG. 19, the transformation unit split information (TU size flag) is a flag having a value or 0 or 1, but the transformation unit split information is not limited to a flag having 1 bit, and the transformation unit may be hierarchically split while the transformation unit split information increases in a manner of 0, 1, 2, 3 . . . etc., according to setting. The transformation unit split information may be an example of the transformation index.

In this case, the size of a transformation unit that has been actually used may be expressed by using the transformation unit split information according to an embodiment, together with a maximum size of the transformation unit and a minimum size of the transformation unit. The video encoding apparatus 100 according to an embodiment may encode maximum transformation unit size information, minimum transformation unit size information, and maximum transformation unit split information. The result of encoding the maximum transformation unit size information, the minimum transformation unit size information, and the maximum transformation unit split information may be inserted into an SPS. The video decoding apparatus 200 according to an embodiment may decode video by using the maximum transformation unit size information, the minimum transformation unit size information, and the maximum transformation unit split information.

For example, (a) if the size of a current coding unit is 64×64 and a maximum transformation unit size is 32×32, (a−1) then the size of a transformation unit may be 32×32 when a TU size flag is 0, (a−2) may be 16×16 when the TU size flag is 1, and (a−3) may be 8×8 when the TU size flag is 2.

As another example, (b) if the size of the current coding unit is 32×32 and a minimum transformation unit size is 32×32, (b−1) then the size of the transformation unit may be 32×32 when the TU size flag is 0. Here, the TU size flag cannot be set to a value other than 0, since the size of the transformation unit cannot be less than 32×32.

As another example, (c) if the size of the current coding unit is 64×64 and a maximum TU size flag is 1, then the TU size flag may be 0 or 1. Here, the TU size flag cannot be set to a value other than 0 or 1.

Thus, if it is defined that the maximum TU size flag is ‘MaxTransformSizelndex’, a minimum transformation unit size is ‘MinTransformSize’, and a transformation unit size is ‘RootTuSize’ when the TU size flag is 0, then a current minimum transformation unit size ‘CurrMinTuSize’ that can be determined in a current coding unit may be defined by Equation (1):

CurrMinTuSize=max(MinTransformSize,RootTuSize/(2̂MaxTransformSizeIndex)) (1)

Compared to the current minimum transformation unit size ‘CurrMinTuSize’ that can be determined in the current coding unit, a transformation unit size ‘RootTuSize’ when the TU size flag is 0 may denote a maximum transformation unit size that can be selected in the system. That is, in Equation (1), ‘RootTuSize/(2̂MaxTransformSizeIndex)’ denotes a transformation unit size when the transformation unit size ‘RootTuSize’, when the TU size flag is 0, is split by the number of times corresponding to the maximum TU size flag, and ‘MinTransformSize’ denotes a minimum transformation size. Thus, a smaller value from among ‘RootTuSize/(2̂MaxTransformSizeIndex)’ and ‘MinTransformSize’ may be the current minimum transformation unit size ‘CurrMinTuSize’ that can be determined in the current coding unit.

According to an embodiment, the maximum transformation unit size RootTuSize may vary according to the type of a prediction mode.

For example, if a current prediction mode is an inter mode, then ‘RootTuSize’ may be determined by using Equation (2) below. In Equation (2), ‘MaxTransformSize’ denotes a maximum transformation unit size, and ‘PUSize’ denotes a current prediction unit size.

RootTuSize=min(MaxTransformSize,PUSize) (2)

That is, if the current prediction mode is the inter mode, the transformation unit size ‘RootTuSize’, when the TU size flag is 0, may be a smaller value from among the maximum transformation unit size and the current prediction unit size.

If a prediction mode of a current partition unit is an intra mode, ‘RootTuSize’ may be determined by using Equation (3) below. In Equation (3), ‘PartitionSize’ denotes the size of the current partition unit.

RootTuSize=min(MaxTransformSize,PartitionSize) (3)

That is, if the current prediction mode is the intra mode, the transformation unit size ‘RootTuSize’ when the TU size flag is 0 may be a smaller value from among the maximum transformation unit size and the size of the current partition unit.

However, the current maximum transformation unit size ‘RootTuSize’ that varies according to the type of a prediction mode in a partition unit is just an embodiment, and a factor for determining the current maximum transformation unit size is not limited thereto.

According to the video encoding method based on coding units of a tree structure described above with reference to FIGS. 8 through 20, image data of a spatial domain is encoded in each of the coding units of the tree structure, and the image data of the spatial domain is reconstructed in a manner that decoding is performed on each largest coding unit according to the video decoding method based on the coding units of the tree structure, so that a video that is formed of pictures and pictures sequences may be reconstructed. The reconstructed video may be reproduced by a reproducing apparatus, may be stored in a storage medium, or may be transmitted via a network.

The one or more embodiments may be written as computer programs and may be implemented in general-use digital computers that execute the programs by using a computer-readable recording medium. Examples of the computer-readable recording medium include magnetic storage media (e.g., ROM, floppy disks, hard disks, etc.), optical recording media (e.g., CD-ROMs, or DVDs), etc.

For convenience of description, the inter-layer video encoding methods and/or video encoding methods which are described above are collectively referred to as ‘the video encoding method of the present invention’. Also, the inter-layer video decoding methods and/or video decoding methods which are described above are referred to as ‘the video decoding method of the present invention’.

Furthermore, the above-described multilayer video encoding apparatus 10, the video encoding apparatus 100, and a video encoding apparatus including the image encoder 400 are collectively referred to as ‘the video encoding apparatus of the present invention’. In addition, the above-described multilayer video decoding apparatus 20, the video decoding apparatus 200, and a video decoding apparatus including the image decoder 500 are collectively referred to as ‘the video decoding apparatus of the present invention’.

A computer-readable recording medium storing a program, e.g., a disc 26000, according to an embodiment will now be described in detail.

FIG. 21 illustrates a diagram of a physical structure of the disc 26000 in which a program is stored, according to various embodiments. The disc 26000, which is a storage medium, may be a hard drive, a compact disc-read only memory (CD-ROM) disc, a Blu-ray disc, or a digital versatile disc (DVD). The disc 26000 includes a plurality of concentric tracks Tr that are each divided into a specific number of sectors Se in a circumferential direction of the disc 26000. In a specific region of the disc 26000, a program that executes the quantized parameter determining method, the video encoding method, and the video decoding method described above may be assigned and stored.

A computer system embodied using a storage medium that stores a program for executing the video encoding method and the video decoding method as described above will now be described with reference to FIG. 22.

FIG. 22 illustrates a diagram of a disc drive 26800 for recording and reading a program by using the disc 26000. A computer system 26700 may store a program that executes at least one selected from a video encoding method and a video decoding method according to an embodiment, in the disc 26000 via the disc drive 26800. In order to run the program stored in the disc 26000 in the computer system 26700, the program may be read from the disc 26000 and be transmitted to the computer system 26700 by using the disc drive 26800.

The program that executes at least one of a video encoding method and a video decoding method according to an embodiment may be stored not only in the disc 26000 illustrated in FIGS. 21 and 22 but also may be stored in a memory card, a ROM cassette, or a solid state drive (SSD).

A system to which the video encoding method and the video decoding method described above are applied will be described below.

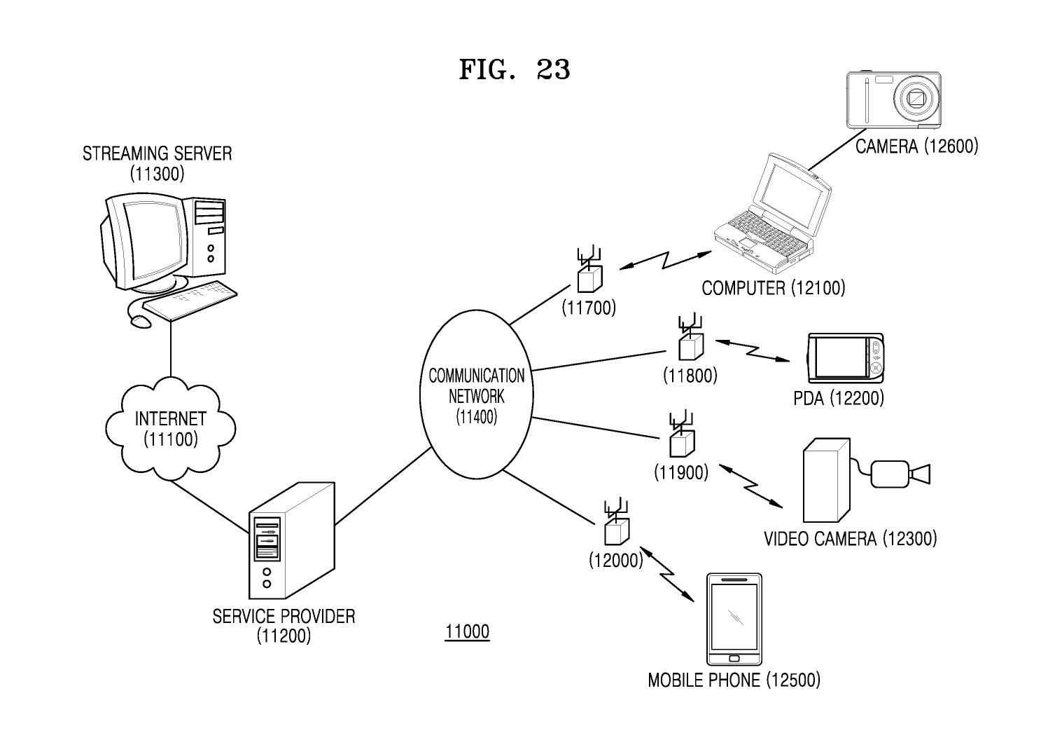

FIG. 23 illustrates a diagram of an overall structure of a content supply system 11000 for providing a content distribution service. A service area of a communication system is divided into predetermined-sized cells, and wireless base stations 11700, 11800, 11900, and 12000 are installed in these cells, respectively.

The content supply system 11000 includes a plurality of independent devices. For example, the plurality of independent devices, such as a computer 12100, a personal digital assistant (PDA) 12200, a video camera 12300, and a mobile phone 12500, are connected to the Internet 11100 via an internet service provider 11200, a communication network 11400, and the wireless base stations 11700, 11800, 11900, and 12000.

However, the content supply system 11000 is not limited to as illustrated in FIG. 23, and devices may be selectively connected thereto. The plurality of independent devices may be directly connected to the communication network 11400, not via the wireless base stations 11700, 11800, 11900, and 12000.

The video camera 12300 is an imaging device, e.g., a digital video camera, which is capable of capturing video images. The mobile phone 12500 may employ at least one communication method from among various protocols, e.g., Personal Digital Communications (PDC), Code Division Multiple Access (CDMA), Wideband-Code Division Multiple Access (W-CDMA), Global System for Mobile Communications (GSM), and Personal Handyphone System (PHS).

The video camera 12300 may be connected to a streaming server 11300 via the wireless base station 11900 and the communication network 11400. The streaming server 11300 allows content received from a user via the video camera 12300 to be streamed via a real-time broadcast. The content received from the video camera 12300 may be encoded by the video camera 12300 or the streaming server 11300. Video data captured by the video camera 12300 may be transmitted to the streaming server 11300 via the computer 12100.

Video data captured by a camera 12600 may also be transmitted to the streaming server 11300 via the computer 12100. The camera 12600 is an imaging device capable of capturing both still images and video images, similar to a digital camera. The video data captured by the camera 12600 may be encoded using the camera 12600 or the computer 12100. Software that performs encoding and decoding video may be stored in a computer-readable recording medium, e.g., a CD-ROM disc, a floppy disc, a hard disc drive, an SSD, or a memory card, which may be accessible by the computer 12100.

If video data is captured by a camera built in the mobile phone 12500, the video data may be received from the mobile phone 12500.

The video data may also be encoded by a large scale integrated circuit (LSI) system installed in the video camera 12300, the mobile phone 12500, or the camera 12600.

The content supply system 11000 may encode content data recorded by a user using the video camera 12300, the camera 12600, the mobile phone 12500, or another imaging device, e.g., content recorded during a concert, and transmit the encoded content data to the streaming server 11300. The streaming server 11300 may transmit the encoded content data in a type of a streaming content to other clients that request the content data.

The clients are devices capable of decoding the encoded content data, e.g., the computer 12100, the PDA 12200, the video camera 12300, or the mobile phone 12500. Thus, the content supply system 11000 allows the clients to receive and reproduce the encoded content data. Also, the content supply system 11000 allows the clients to receive the encoded content data and decode and reproduce the encoded content data in real time, thereby enabling personal broadcasting.

Encoding and decoding operations of the plurality of independent devices included in the content supply system 11000 may be similar to those of a video encoding apparatus and a video decoding apparatus according to embodiments.

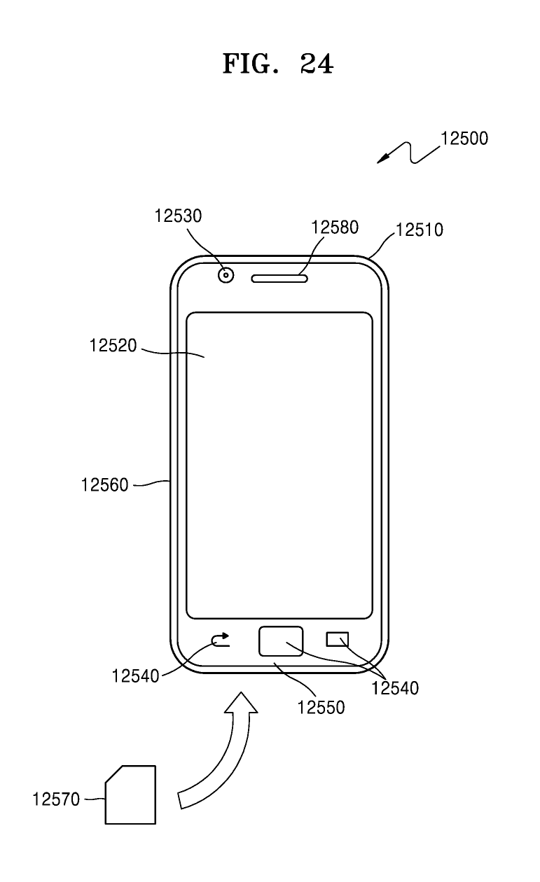

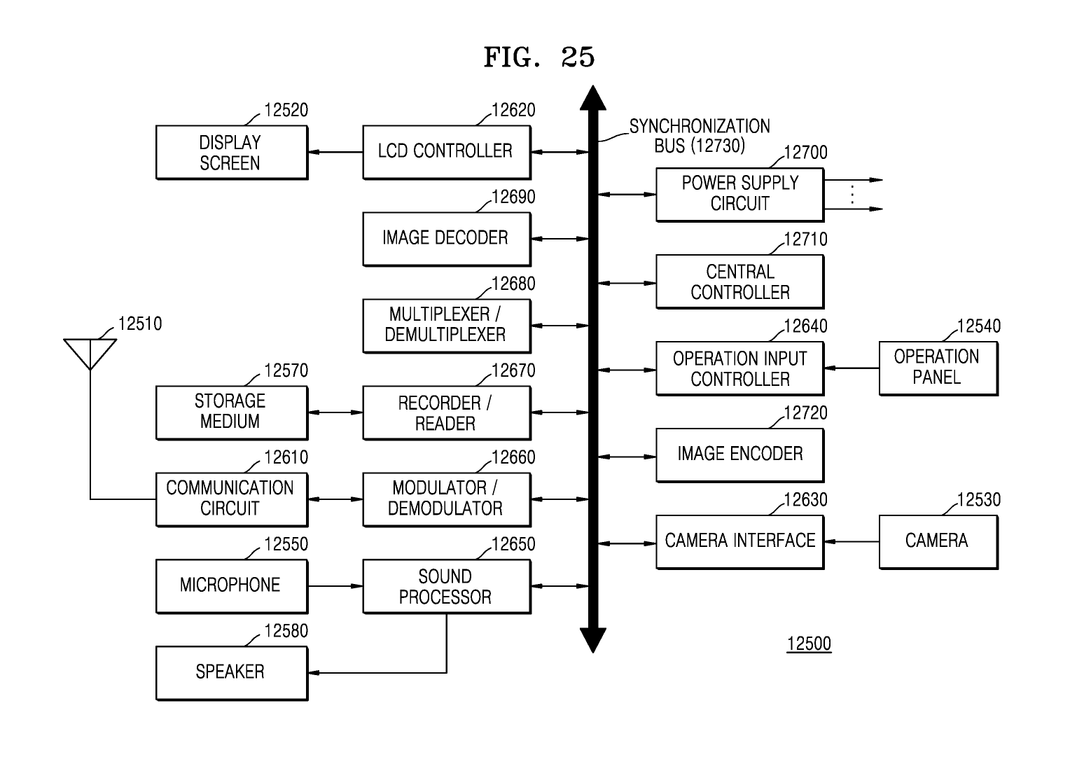

With reference to FIGS. 24 and 25, the mobile phone 12500 included in the content supply system 11000 according to an embodiment will now be described in detail.

FIG. 24 illustrates an external structure of the mobile phone 12500 to which a video encoding method and a video decoding method are applied, according to various embodiments. The mobile phone 12500 may be a smart phone, the functions of which are not limited and a large number of the functions of which may be changed or expanded.

The mobile phone 12500 includes an internal antenna 12510 via which a radio-frequency (RF) signal may be exchanged with the wireless base station 12000, and includes a display screen 12520 for displaying images captured by a camera 12530 or images that are received via the antenna 12510 and decoded, e.g., a liquid crystal display (LCD) or an organic light-emitting diode (OLED) screen. The mobile phone 12500 includes an operation panel 12540 including a control button and a touch panel. If the display screen 12520 is a touch screen, the operation panel 12540 further includes a touch sensing panel of the display screen 12520. The mobile phone 12500 includes a speaker 12580 for outputting voice and sound or another type of a sound output unit, and a microphone 12550 for inputting voice and sound or another type of a sound input unit. The mobile phone 12500 further includes the camera 12530, such as a charge-coupled device (CCD) camera, to capture video and still images. The mobile phone 12500 may further include a storage medium 12570 for storing encoded/decoded data, e.g., video or still images captured by the camera 12530, received via email, or obtained according to various ways; and a slot 12560 via which the storage medium 12570 is loaded into the mobile phone 12500. The storage medium 12570 may be a flash memory, e.g., a secure digital (SD) card or an electrically erasable and programmable read only memory (EEPROM) included in a plastic case.

FIG. 25 illustrates an internal structure of the mobile phone 12500. In order to systemically control parts of the mobile phone 12500 including the display screen 12520 and the operation panel 12540, a power supply circuit 12700, an operation input controller 12640, an image encoder 12720, a camera interface 12630, an LCD controller 12620, an image decoder 12690, a multiplexer/demultiplexer 12680, a recording/reading unit 12670, a modulation/demodulation unit 12660, and a sound processor 12650 are connected to a central controller 12710 via a synchronization bus 12730.

If a user operates a power button and sets from a ‘power off state to a ‘power on’ state, the power supply circuit 12700 supplies power to all the parts of the mobile phone 12500 from a battery pack, thereby setting the mobile phone 12500 to an operation mode.

The central controller 12710 includes a central processing unit (CPU), a ROM, and a RAM.

While the mobile phone 12500 transmits communication data to the outside, a digital signal is generated by the mobile phone 12500 under control of the central controller 12710. For example, the sound processor 12650 may generate a digital sound signal, the image encoder 12720 may generate a digital image signal, and text data of a message may be generated via the operation panel 12540 and the operation input controller 12640. When a digital signal is transmitted to the modulation/demodulation unit 12660 by control of the central controller 12710, the modulation/demodulation unit 12660 modulates a frequency band of the digital signal, and a communication circuit 12610 performs digital-to-analog conversion (DAC) and frequency conversion on the frequency band-modulated digital sound signal. A transmission signal output from the communication circuit 12610 may be transmitted to a voice communication base station or the wireless base station 12000 via the antenna 12510.

For example, when the mobile phone 12500 is in a conversation mode, a sound signal obtained via the microphone 12550 is transformed into a digital sound signal by the sound processor 12650, by control of the central controller 12710. The digital sound signal may be transformed into a transformation signal via the modulation/demodulation unit 12660 and the communication circuit 12610, and may be transmitted via the antenna 12510.

When a text message, e.g., email, is transmitted during a data communication mode, text data of the text message is input via the operation panel 12540 and is transmitted to the central controller 12610 via the operation input controller 12640. By control of the central controller 12610, the text data is transformed into a transmission signal via the modulation/demodulation unit 12660 and the communication circuit 12610 and is transmitted to the wireless base station 12000 via the antenna 12510.

In order to transmit image data during the data communication mode, image data captured by the camera 12530 is provided to the image encoder 12720 via the camera interface 12630. The captured image data may be directly displayed on the display screen 12520 via the camera interface 12630 and the LCD controller 12620.

A structure of the image encoder 12720 may correspond to that of the video encoding apparatus 100 described above. The image encoder 12720 may transform the image data received from the camera 12530 into compressed and encoded image data according to the aforementioned video encoding method, and then output the encoded image data to the multiplexer/demultiplexer 12680. During a recording operation of the camera 12530, a sound signal obtained by the microphone 12550 of the mobile phone 12500 may be transformed into digital sound data via the sound processor 12650, and the digital sound data may be transmitted to the multiplexer/demultiplexer 12680.

The multiplexer/demultiplexer 12680 multiplexes the encoded image data received from the image encoder 12720, together with the sound data received from the sound processor 12650. A result of multiplexing the data may be transformed into a transmission signal via the modulation/demodulation unit 12660 and the communication circuit 12610, and may then be transmitted via the antenna 12510.

While the mobile phone 12500 receives communication data from the outside, frequency recovery and ADC are performed on a signal received via the antenna 12510 to transform the signal into a digital signal. The modulation/demodulation unit 12660 modulates a frequency band of the digital signal. The frequency-band modulated digital signal is transmitted to the video decoder 12690, the sound processor 12650, or the LCD controller 12620, according to the type of the digital signal.

During the conversation mode, the mobile phone 12500 amplifies a signal received via the antenna 12510, and obtains a digital sound signal by performing frequency conversion and ADC on the amplified signal. A received digital sound signal is transformed into an analog sound signal via the modulation/demodulation unit 12660 and the sound processor 12650, and the analog sound signal is output via the speaker 12580, by control of the central controller 12710.

When during the data communication mode, data of a video file accessed at an Internet website is received, a signal received from the wireless base station 12000 via the antenna 12510 is output as multiplexed data via the modulation/demodulation unit 12660, and the multiplexed data is transmitted to the multiplexer/demultiplexer 12680.

In order to decode the multiplexed data received via the antenna 12510, the multiplexer/demultiplexer 12680 demultiplexes the multiplexed data into an encoded video data stream and an encoded audio data stream. Via the synchronization bus 12730, the encoded video data stream and the encoded audio data stream are provided to the video decoder 12690 and the sound processor 12650, respectively.

A structure of the image decoder 12690 may correspond to that of the video decoding apparatus described above. The image decoder 12690 may decode the encoded video data to obtain reconstructed video data and provide the reconstructed video data to the display screen 12520 via the LCD controller 12620, by using the aforementioned video decoding method according to the embodiment.

Thus, the data of the video file accessed at the Internet website may be displayed on the display screen 12520. At the same time, the sound processor 12650 may transform audio data into an analog sound signal, and provide the analog sound signal to the speaker 12580. Thus, audio data contained in the video file accessed at the Internet website may also be reproduced via the speaker 12580.

The mobile phone 12500 or another type of communication terminal may be a transceiving terminal including both a video encoding apparatus and a video decoding apparatus according to an embodiment, may be a transmitting terminal including only the video encoding apparatus, or may be a receiving terminal including only the video decoding apparatus.

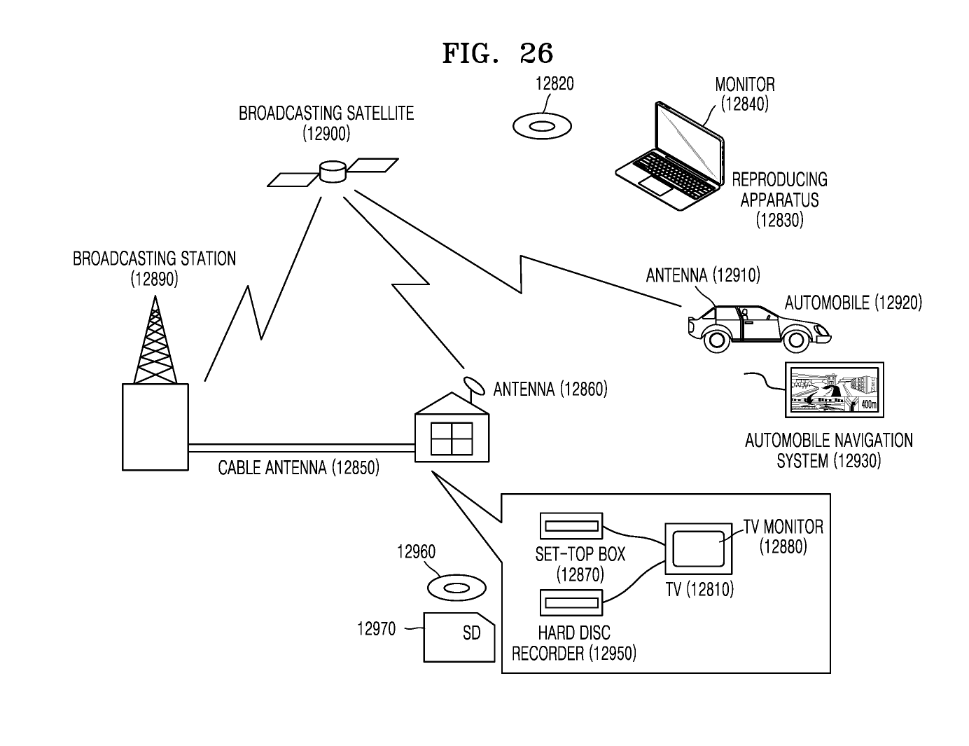

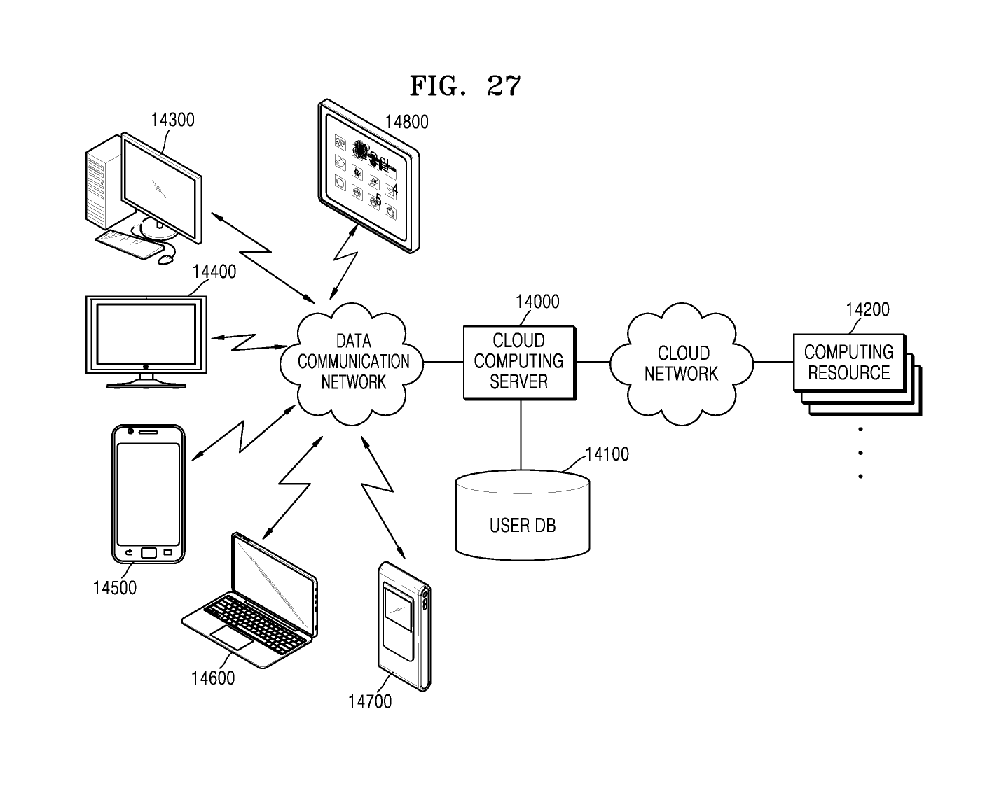

A communication system according to an embodiment is not limited to the communication system described above with reference to FIG. 24. For example, FIG. 26 illustrates a digital broadcasting system employing a communication system, according to various embodiments. The digital broadcasting system of FIG. 26 may receive a digital broadcast transmitted via a satellite or a terrestrial network by using the video encoding apparatus and the video decoding apparatus according to the embodiments.

In more detail, a broadcasting station 12890 transmits a video data stream to a communication satellite or a broadcasting satellite 12900 by using radio waves. The broadcasting satellite 12900 transmits a broadcast signal, and the broadcast signal is transmitted to a satellite broadcast receiver via a household antenna 12860. In every house, an encoded videostream may be decoded and reproduced by a TV receiver 12810, a set-top box 12870, or another device.

When the video decoding apparatus according to the embodiment is implemented in a reproducing apparatus 12830, the reproducing apparatus 12830 may parse and decode an encoded videostream recorded on a storage medium 12820, such as a disc or a memory card to reconstruct digital signals. Thus, the reconstructed video signal may be reproduced, for example, on a monitor 12840.

In the set-top box 12870 connected to the antenna 12860 for a satellite/terrestrial broadcast or a cable antenna 12850 for receiving a cable television (TV) broadcast, the video decoding apparatus according to the embodiment may be installed. Data output from the set-top box 12870 may also be reproduced on a TV monitor 12880.

As another example, the video decoding apparatus according to the embodiment may be installed in the TV receiver 12810 instead of the set-top box 12870.

An automobile 12920 that has an appropriate antenna 12910 may receive a signal transmitted from the satellite 12900 or the wireless base station 11700. A decoded video may be reproduced on a display screen of an automobile navigation system 12930 installed in the automobile 12920.

A video signal may be encoded by the video encoding apparatus according to the embodiment and may then be stored in a storage medium. In more detail, an image signal may be stored in a DVD disc 12960 by a DVD recorder or may be stored in a hard disc by a hard disc recorder 12950. As another example, the video signal may be stored in an SD card 12970. If the hard disc recorder 12950 includes the video decoding apparatus according to the embodiment, a video signal recorded on the DVD disc 12960, the SD card 12970, or another storage medium may be reproduced on the TV monitor 12880.

The automobile navigation system 12930 may not include the camera 12530, the camera interface 12630, and the image encoder 12720 of FIG. 26. For example, the computer 12100 and the TV receiver 12810 may not include the camera 12530, the camera interface 12630, and the image encoder 12720 of FIG. 26.

FIG. 27 is a diagram illustrating a network structure of a cloud computing system using a video encoding apparatus and a video decoding apparatus, according to various embodiments.

The cloud computing system of the present invention may include a cloud computing server 14000, a user database (DB) 14100, a plurality of computing resources 14200, and a user terminal.

The cloud computing system provides an on-demand outsourcing service of the plurality of computing resources 14200 via a data communication network, e.g., the Internet, in response to a request from the user terminal. Under a cloud computing environment, a service provider provides users with desired services by combining computing resources at data centers located at physically different locations by using virtualization technology. A service user does not have to install computing resources, e.g., an application, a storage, an operating system (OS), and security software, into his/her own terminal in order to use them, but may select and use desired services from among services in a virtual space generated through the virtualization technology, at a desired point in time.

A user terminal of a specified service user is connected to the cloud computing server 14000 via a data communication network including the Internet and a mobile telecommunication network. User terminals may be provided cloud computing services, and particularly video reproduction services, from the cloud computing server 14000. The user terminals may be various types of electronic devices capable of being connected to the Internet, e.g., a desktop PC 14300, a smart TV 14400, a smart phone 14500, a notebook computer 14600, a portable multimedia player (PMP) 14700, a tablet PC 14800, and the like.

The cloud computing server 14000 may combine the plurality of computing resources 14200 distributed in a cloud network and provide user terminals with a result of combining. The plurality of computing resources 14200 may include various data services, and may include data uploaded from user terminals. As described above, the cloud computing server 14000 may provide user terminals with desired services by combining video database distributed in different regions according to the virtualization technology.

User information about users who have subscribed for a cloud computing service is stored in the user DB 14100. The user information may include logging information, addresses, names, and personal credit information of the users. The user information may further include indexes of videos. Here, the indexes may include a list of videos that have already been reproduced, a list of videos that are being reproduced, a pausing point of a video that was being reproduced, and the like.

Information about a video stored in the user DB 14100 may be shared between user devices. For example, when a video service is provided to the notebook computer 14600 in response to a request from the notebook computer 14600, a reproduction history of the video service is stored in the user DB 14100. When a request to reproduce the video service is received from the smart phone 14500, the cloud computing server 14000 searches for and reproduces the video service, based on the user DB 14100. When the smart phone 14500 receives a video data stream from the cloud computing server 14000, a process of reproducing video by decoding the video data stream is similar to an operation of the mobile phone 12500 described above with reference to FIG. 24.

The cloud computing server 14000 may refer to a reproduction history of a desired video service, stored in the user DB 14100. For example, the cloud computing server 14000 receives a request to reproduce a video stored in the user DB 14100, from a user terminal. If this video was being reproduced, then a method of streaming this video, performed by the cloud computing server 14000, may vary according to the request from the user terminal, i.e., according to whether the video will be reproduced, starting from a start thereof or a pausing point thereof. For example, if the user terminal requests to reproduce the video, starting from the start thereof, the cloud computing server 14000 transmits streaming data of the video starting from a first frame thereof to the user terminal. If the user terminal requests to reproduce the video, starting from the pausing point thereof, the cloud computing server 14000 transmits streaming data of the video starting from a frame corresponding to the pausing point, to the user terminal.

In this case, the user terminal may include the video decoding apparatus described above. In another example, the user terminal may include the video encoding apparatus described above. Alternatively, the user terminal may include both the video decoding apparatus and the video encoding apparatus which are described above.

Various applications where the video encoding method, the video decoding method, the video encoding apparatus, and the video decoding apparatus are described above with reference to FIGS. 21 through 27. However, methods of storing the video encoding method and the video decoding method in a storage medium or methods of implementing the video encoding apparatus and the video decoding apparatus in a device are not limited to the embodiments described above with reference to FIGS. 21 through 27.

While various embodiments have been particularly shown and described, it will be understood by one of ordinary skill in the art that various changes in form and details may be made therein without departing from the spirit and scope of the following claims. The disclosed embodiments should be considered in a descriptive sense only and not for purposes of limitation. Therefore, the scope of the present specification is defined not by the detailed description but by the appended claims, and all differences within the scope will be construed as being included in the scope of the present specification.

1. A multilayer video decoding method comprising:
acquiring reset information indicating whether to reset a picture order count (POC) of a current picture;
resetting a higher bit of the POC of the current picture when the reset information indicates to reset the POC of the current picture; and
decoding the current picture by using the reset POC.

2. The multilayer video decoding method of claim 1, further comprising resetting a lower bit of the POC of the current picture when the reset information indicates to reset the POC of the current picture.

3. The multilayer video decoding method of claim 2, wherein the reset information is determined based on a type of a picture comprised in a base layer among interlayer reference pictures of the current picture.

4. The multilayer video decoding method of claim 3, wherein the current picture is comprised in an enhancement layer, and
wherein the reset information indicates to reset the POC of the current picture when the picture comprised in the base layer among the interlayer reference pictures of the current picture is a random access point (RAP) picture.

5. The multilayer video decoding method of claim 4, wherein the RAP picture comprises at least one of an instantaneous decoding refresh (IDR) picture and a broken link access (BLA) picture.

6. The multilayer video decoding method of claim 3, wherein the resetting of the higher bit comprises determining a value of the higher bit to be 0, and
wherein the resetting of the lower bit comprises determining a value of the lower bit to be 0.

7. The multilayer video decoding method of claim 1, further comprising:
determining a POC offset by using the POC of the current picture; and
updating a POC of at least one picture to be reconstructed temporally after the current picture, by using the determined POC offset.

8. The multilayer video decoding method of claim 1, further comprising acquiring a lower bit of the POC of the current picture when the current picture is comprised in an enhancement layer or when the current picture is not an IDR picture.

9. The multilayer video decoding method of claim 1, further comprising determining a reference picture used to decode the current picture among one or more pictures comprised in a decoded picture buffer (DPB), by using a lower bit of the POC.

10. The multilayer video decoding method of claim 1, further comprising:
acquiring a lower bit of the POC of the current picture; and
identifying pictures comprised in the same access unit as the current picture among a plurality of pictures acquired from a bitstream, by using the acquired lower bit.

11. A multilayer video encoding method comprising:
checking a type of a picture comprised in a base layer among interlayer reference pictures of a current picture;
determining reset information indicating whether to reset a picture order count (POC) of the current picture, based on the checked type; and
generating a bitstream comprising the determined reset information.

12. The multilayer video encoding method of claim 11, wherein the current picture is comprised in an enhancement layer, and
wherein the reset information indicates to reset a higher bit of the POC of the current picture when the picture comprised in the base layer among the interlayer reference pictures of the current picture is a random access point (RAP) picture.

13. The multilayer video encoding method of claim 11, wherein the current picture is comprised in an enhancement layer, and
wherein the reset information indicates to reset a higher bit and a lower bit of the POC of the current picture when the picture comprised in the base layer among the interlayer reference pictures of the current picture is a RAP picture.

14. A multilayer video decoding apparatus comprising:
a receiver for acquiring reset information indicating whether to reset a picture order count (POC) of a current picture; and
a decoder for resetting a higher bit of the POC of the current picture when the reset information indicates to reset the POC of the current picture, and decoding the current picture by using the reset POC.

15. A multilayer video encoding apparatus comprising:
an encoder for checking a type of a picture corresponding to a current picture among one or more pictures comprised in a base layer, and determining reset information indicating whether to reset a picture order count (POC) of the current picture, based on the checked type; and
a bitstream generator for generating a bitstream comprising the determined reset information.
